(19) United States
(12) Patent Application Publication
(10) Pub. No.: US 2025/0306350 A1
(43) Pub. Date: Oct. 2, 2025

(54) VARIABLE MAGNIFICATION OPTICAL SYSTEM AND IMAGING APPARATUS

(71) Applicant: FUJIFILM Corporation, Tokyo (JP)

(72) Inventors: Masato KONDO, Saitama-shi (JP); Akiko NAGAHARA, Saitama-shi (JP)

(73) Assignee: FUJIFILM Corporation, Tokyo (JP)

(21) Appl. No.: 19/233,867

(22) Filed: Jun. 10, 2025

Related U.S. Application Data
(63) Continuation of application No. PCT/JP2023/040470, filed on Nov. 9, 2023.

(30) Foreign Application Priority Data
Dec. 23, 2022 (JP) 2022-207653

(51) Int. Cl. G02B 15/20; G02B 15/14; G02B 27/64

(52) U.S. Cl. CPC G02B 15/20; G02B 15/1451; G02B 27/646

(57) ABSTRACT

A variable magnification optical system consists of, in order from an object side, a front group, an intermediate group, and a subsequent group. The front group consists of two or fewer lens groups having a positive refractive power. The intermediate group consists of two or fewer lens groups having a negative refractive power. The subsequent group consists of a plurality of lens groups. A lens group of the subsequent group closest to the object side is a first subsequent lens group having a positive refractive power. Two or fewer focusing groups that move along an optical axis during focusing are disposed in the subsequent group. During magnification change, a lens group of the front group closest to the object side is fixed with respect to an image plane.

### CROSS-REFERENCE TO RELATED APPLICATIONS

This application is a continuation application of International Application No. PCT/JP2023/040470, filed on Nov. 9, 2023, which claims priority from Japanese Patent Application No. 2022-207653, filed on Dec. 23, 2022. The entire disclosure of each of the above applications is incorporated herein by reference.

### BACKGROUND

### Technical Field

The technology of the present disclosure relates to a variable magnification optical system and an imaging apparatus.

### Related Art

In the related art, as a variable magnification optical system that can be used in an imaging apparatus such as a digital camera, optical systems disclosed in JP2020-086133A and JP2019-020451A are known.

### SUMMARY

There is a demand for a variable magnification optical system that is configured to be small in size, that suppresses a change in a position of a centroid caused by magnification change, and that maintains favorable optical performance in an entire magnification change range. These requirement levels are increasing year by year.

The present disclosure provides a variable magnification optical system that is configured to be small in size, that suppresses a change in a position of a centroid caused by magnification change, and that maintains favorable optical performance in an entire magnification change range, and an imaging apparatus comprising the variable magnification optical system.

A first aspect of the present disclosure relates to a variable magnification optical system consisting of, in order from an object side to an image side, a front group, an intermediate group, and a subsequent group, in which the front group consists of two or fewer lens groups having a positive refractive power, the intermediate group consists of two or fewer lens groups having a negative refractive power, the subsequent group consists of a plurality of lens groups, a lens group of the subsequent group closest to the object side is a first subsequent lens group having a positive refractive power, two or fewer focusing groups that move along an optical axis during focusing are disposed in the subsequent group, during magnification change, all spacings between adjacent lens groups are changed and a lens group of the front group closest to the object side is fixed with respect to an image plane, and in a case in which a focal length of an entire system in a state in which an infinite distance object is in focus at a telephoto end is denoted by ft, a focal length of the entire system in a state in which the infinite distance object is in focus at a wide angle end is denoted by fw, a maximum half angle of view in a state in which the infinite distance object is in focus at the wide angle end is denoted by ow, and a back focus of the entire system at an air conversion distance in a state in which the infinite distance object is in focus at the wide angle end is denoted by Bfw, Conditional Expressions (1) and (2) are satisfied, which are represented by 5<ft/(fw×tan ωw)<20 (1), and 0.5<Bfw/(fw×tan ωw)<2.5 (2).

A second aspect of the present disclosure relates to the variable magnification optical system according to the first aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3) is satisfied, which is represented by 5<TLw/(fw×tan ωw)<10.5 (3).

A third aspect of the present disclosure relates to the variable magnification optical system according to the first aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the telephoto end, is denoted by TLt, Conditional Expression (4) is satisfied, which is represented by 0.5<TLt/ft<1.3 (4).

A fourth aspect of the present disclosure relates to the variable magnification optical system according to the first aspect, in which in a case in which an open F-number in a state in which the infinite distance object is in focus at the telephoto end is denoted by FNot, Conditional Expression (5) is satisfied, which is represented by 0.9<FNot/(ft/fw)<2.1 (5).

A fifth aspect of the present disclosure relates to the variable magnification optical system according to the first aspect, in which in a case in which a maximum half angle of view in a state in which the infinite distance object is in focus at the telephoto end is denoted by ωt, Conditional Expression (6) is satisfied, which is represented by 5<ft/(fw×tan ωw)<20 (6).

A sixth aspect of the present disclosure relates to the variable magnification optical system according to the first aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (7) is satisfied, which is represented by 0.1<(fw×TLw)/ft²<0.55 (7).

A seventh aspect of the present disclosure relates to the variable magnification optical system according to the first aspect, in which Conditional Expression (8) is satisfied, which is represented by 1.5<ft/fw<4.3 (8).

An eighth aspect of the present disclosure relates to the variable magnification optical system according to the seventh aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3-4) is satisfied, which is represented by 6.2<TLw/(fw×tan ωw)<8.45 (3-4).

A ninth aspect of the present disclosure relates to the variable magnification optical system according to the eighth aspect, in which in a case in which an open F-number in a state in which the infinite distance object is in focus at the telephoto end is denoted by FNot, Conditional Expression (5-1) is satisfied, which is represented by 1.25<FNot/(ft/fw)<1.75 (5-1).

A tenth aspect of the present disclosure relates to the variable magnification optical system according to the seventh aspect, in which during magnification change, three or more lens groups in the subsequent group move by changing spacings with adjacent lens groups.

An eleventh aspect of the present disclosure relates to the variable magnification optical system according to the tenth aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3-3) is satisfied, which is represented by 6<TLw/(fw×tan ωw)<9.1 (3-3).

A twelfth aspect of the present disclosure relates to the variable magnification optical system according to the eleventh aspect, in which in a case in which an open F-number in a state in which the infinite distance object is in focus at the telephoto end is denoted by FNot, Conditional Expression (5-1) is satisfied, which is represented by 1.25<FNot/(ft/fw)<1.75 (5-1).

A thirteenth aspect of the present disclosure relates to the variable magnification optical system according to the tenth aspect, in which at least one lens group of the lens groups that move during magnification change, in the subsequent group, has a negative refractive power.

A fourteenth aspect of the present disclosure relates to the variable magnification optical system according to the thirteenth aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3-2) is satisfied, which is represented by 5.8<TLw/(fw×tan ωw)<9.3 (3-2).

A fifteenth aspect of the present disclosure relates to the variable magnification optical system according to the fourteenth aspect, in which in a case in which an open F-number in a state in which the infinite distance object is in focus at the telephoto end is denoted by FNot, Conditional Expression (5-1) is satisfied, which is represented by 1.25<FNot/(ft/fw)<1.75 (5-1).

A sixteenth aspect of the present disclosure relates to the variable magnification optical system according to the first aspect, in which in a case in which a focal length of the lens group of the front group closest to the object side is denoted by fF1, Conditional Expression (9) is satisfied, which is represented by 0.5<fF1/fw<3.4 (9).

A seventeenth aspect of the present disclosure relates to the variable magnification optical system according to the first aspect, in which in a case in which a focal length of the lens group of the front group closest to the object side is denoted by fF1, and a focal length of the intermediate group at the wide angle end is denoted by fM, Conditional Expression (10) is satisfied, which is represented by 1<fF1/(−fM)<8 (10).

An eighteenth aspect of the present disclosure relates to the variable magnification optical system according to the first aspect, in which in a case in which a focal length of the lens group of the front group closest to the object side is denoted by fF1, Conditional Expression (11) is satisfied, which is represented by 0.4<fF1/(fw×ft)^{1/2}<1.4 (11).

A nineteenth aspect of the present disclosure relates to the variable magnification optical system according to the first aspect, in which in a case in which a focal length of the intermediate group at the wide angle end is denoted by fM, Conditional Expression (12) is satisfied, which is represented by 0.1<(−fM)/(fw×ft)^{1/2}<0.7 (12).

A twentieth aspect of the present disclosure relates to the variable magnification optical system according to the first aspect, in which in a case in which a focal length of the lens group of the front group closest to the object side is denoted by fF1, and an open F-number in a state in which the infinite distance object is in focus at the telephoto end is denoted by FNot, Conditional Expression (13) is satisfied, which is represented by 1<fF1/(ft/FNot)<5 (13).

A twenty-first aspect of the present disclosure relates to the variable magnification optical system according to the first aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (14) is satisfied, which is represented by 1.7<TLw/fw<3.5 (14).

A twenty-second aspect of the present disclosure relates to the variable magnification optical system according to the first aspect, in which in a case in which an open F-number in a state in which the infinite distance object is in focus at the wide angle end is denoted by FNow, Conditional Expression (15) is satisfied, which is represented by 0.06<tan ωw/FNow<0.12 (15).

A twenty-third aspect of the present disclosure relates to the variable magnification optical system according to the first aspect, in which the variable magnification optical system includes an aperture stop closer to the image side than a lens surface of the intermediate group closest to the image side, and in a case in which a distance, on the optical axis, from a lens surface of the front group closest to the object side to the aperture stop in a state in which the infinite distance object is in focus at the wide angle end is denoted by DDL1STw, and a focal length of the lens group of the front group closest to the object side is denoted by fF1, Conditional Expression (16) is satisfied, which is represented by 0.4<DDL1STw/fF1<1.4 (16).

A twenty-fourth aspect of the present disclosure relates to the variable magnification optical system according to the first aspect, in which in a case in which a distance, on the optical axis, from a lens surface of the front group closest to the object side to a paraxial entrance pupil position in a state in which the infinite distance object is in focus at the wide angle end is denoted by Denw, Conditional Expression (17) is satisfied, which is represented by 4<Denw/{(fw×tan ωw)×log(ft/fw)}<9.5 (17).

A twenty-fifth aspect of the present disclosure relates to the variable magnification optical system according to the first aspect, in which in a case in which a distance, on the optical axis, from a lens surface of the front group closest to the object side to a paraxial entrance pupil position in a state in which the infinite distance object is in focus at the wide angle end is denoted by Denw, Conditional Expression (18) is satisfied, which is represented by 0.3<Denw/(fw×ft)^{1/2}<0.8 (18).

A twenty-sixth aspect of the present disclosure relates to the variable magnification optical system according to the first aspect, in which the variable magnification optical system includes an aperture stop, and in a case in which a distance, on the optical axis, from a lens surface of the front group closest to the object side to the aperture stop in a state in which the infinite distance object is in focus at the wide angle end is denoted by DDL1STw, and a sum of a distance, on the optical axis, from the lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (19) is satisfied, which is represented by 0.2<DDL1STw/TLw<0.65 (19).

A twenty-seventh aspect of the present disclosure relates to the variable magnification optical system according to the first aspect, in which in a case in which a distance, on the optical axis, from a paraxial exit pupil position to the image plane in a state in which the infinite distance object is in focus at the wide angle end is denoted by Dexw, a sign of Dexw is defined such that, with the paraxial exit pupil position as a reference, a distance on the image side is positive and a distance on the object side is negative, and Dexw is calculated by using, in a case which an optical member having no refractive power is disposed between the paraxial exit pupil position and the image plane, the air conversion distance for the optical member, Conditional Expression (20) is satisfied, which is represented by 0.6<fw/Dexw<1.7 (20).

A twenty-eighth aspect of the present disclosure relates to the variable magnification optical system according to the first aspect, in which in a case in which a spacing, on the optical axis, between the front group and the intermediate group in a state in which the infinite distance object is in focus at the telephoto end is denoted by DDFMt, a spacing, on the optical axis, between the front group and the intermediate group in a state in which the infinite distance object is in focus at the wide angle end is denoted by DDFMw, and a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (21) is satisfied, which is represented by 0.01<|DDFMt−DDFMw|/TLw<0.35 (21).

A twenty-ninth aspect of the present disclosure relates to the variable magnification optical system according to the first aspect, in which in a case in which a focal length of the subsequent group in a state in which the infinite distance object is in focus at the wide angle end is denoted by fRw, Conditional Expression (22) is satisfied, which is represented by 1<fw/fRw<3 (22).

A thirtieth aspect of the present disclosure relates to the variable magnification optical system according to the first aspect, in which in a case in which focal length of the subsequent group in a state in which the infinite distance object is in focus at the telephoto end is denoted by fRt, Conditional Expression (23) is satisfied, which is represented by 2<ft/fRt<8 (23).

A thirty-first aspect of the present disclosure relates to the variable magnification optical system according to the first aspect, in which in a case in which a sum of central thicknesses of all lenses in the front group is denoted by dFsum, and an open F-number in a state in which the infinite distance object is in focus at the telephoto end is denoted by FNot, Conditional Expression (24) is satisfied, which is represented by 0.2<dFsum/(ft/FNot)<0.6 (24).

A thirty-second aspect of the present disclosure relates to the variable magnification optical system according to the first aspect, in which the variable magnification optical system includes an aperture stop, and in a case in which a focal length of the lens group of the front group closest to the object side is denoted by fF1, and a composite focal length from a lens of the front group closest to the object side to the aperture stop in a state in which the infinite distance object is in focus at the wide angle end is denoted by fL1STw, Conditional Expression (25) is satisfied, which is represented by 0.2<fF1/fL1STw<5 (25).

A thirty-third aspect of the present disclosure relates to the variable magnification optical system according to the first aspect, in which the variable magnification optical system includes an aperture stop, and in a case in which a composite focal length from a lens of the front group closest to the object side to the aperture stop in a state in which the infinite distance object is in focus at the wide angle end is denoted by fL1STw, Conditional Expression (26) is satisfied, which is represented by 0.2<fw/fL1STw<2.8 (26).

A thirty-fourth aspect of the present disclosure relates to the variable magnification optical system according to the first aspect, in which in a case in which a lateral magnification of the intermediate group in a state in which the infinite distance object is in focus at the telephoto end is denoted by βMt, and a lateral magnification of the intermediate group in a state in which the infinite distance object is in focus at the wide angle end is denoted by βMw, Conditional Expression (27) is satisfied, which is represented by 1.4<βMt/βMw<4.5 (27).

A thirty-fifth aspect of the present disclosure relates to the variable magnification optical system according to the first aspect, in which in a case in which a focal length of the first subsequent lens group is denoted by fR1, Conditional Expression (28) is satisfied, which is represented by 0.2<fR1/(fw×ft)^{1/2}<1.4 (28).

A thirty-sixth aspect of the present disclosure relates to the variable magnification optical system according to the first aspect, in which in a case in which an effective diameter of a lens Surface of the front group closest to the object side is denoted by EDf, and an effective diameter of a lens surface of the subsequent group closest to the image side is denoted by EDr, Conditional Expression (29) is satisfied, which is represented by 1.2<EDf/EDr<2.4 (29).

A thirty-seventh aspect of the present disclosure relates to the variable magnification optical system according to the first aspect, in which in a case in which a focal length of the first subsequent lens group is denoted by fR1, Conditional Expression (30) is satisfied, which is represented by 0.4<fw/fR1<4 (30).

A thirty-eighth aspect of the present disclosure relates to the variable magnification optical system according to the first aspect, in which at least one lens group that is fixed with respect to the image plane during magnification change is disposed between the front group and a lens group of the subsequent group closest to the image side.

A thirty-ninth aspect of the present disclosure relates to the variable magnification optical system according to the first aspect, in which an anti-vibration group that moves in a direction intersecting with the optical axis during image shake correction is disposed closer to the image side than the front group, and in a case in which a focal length of the anti-vibration group is denoted by fIS, Conditional Expression (31) is satisfied, which is represented by 0.2<|fIS/ft|<2(31).

A fortieth aspect of the present disclosure relates to the variable magnification optical system according to the thirty-ninth aspect, in which the anti-vibration group is disposed closer to the object side than the focusing group.

A forty-first aspect of the present disclosure relates to the variable magnification optical system according to the fortieth aspect, in which the anti-vibration group is disposed in the intermediate group.

A forty-second aspect of the present disclosure relates to the variable magnification optical system according to the fortieth aspect, in which the anti-vibration group is disposed in the subsequent group.

A forty-third aspect of the present disclosure relates to the variable magnification optical system according to the first aspect, in which the front group includes a cemented lens in which a negative meniscus lens having a convex surface facing the object side and a positive lens having a convex surface facing the object side are cemented in order from the object side, and in a case in which a refractive index of the negative meniscus lens at a d line is denoted by Ndn, an Abbe number of the negative meniscus lens based on the d line is denoted by vdn, Conditional Expression (32) is satisfied, which is represented by 1.6<Ndn+0.01×vdn<3 (32).

A forty-fourth aspect of the present disclosure relates to the variable magnification optical system according to the forty-third aspect, in which in a case in which a refractive index of the positive lens at the d line is denoted by Ndp, and an Abbe number of the positive lens based on the d line is denoted by vdp, Conditional Expression (33) is satisfied, which is represented by 1.8<Ndp+0.01×vdp<2.6 (33).

A forty-fifth aspect of the present disclosure relates to the variable magnification optical system according to the first aspect, in which the subsequent group includes an aspherical lens that has a negative refractive power and that has a concave surface facing the object side, and in a case in which a paraxial curvature radius of a surface of the aspherical lens on the object side is denoted by Rcnf, a paraxial curvature radius of a surface of the aspherical lens on the image side is denoted by Rcnr, a curvature radius of the surface of the aspherical lens on the object side at a position of a maximum effective diameter is denoted by Rynf, and a curvature radius of the surface of the aspherical lens on the image side at the position of the maximum effective diameter is denoted by Rynr, Conditional Expression (34) is satisfied, which is represented by 0.1<(1/Rcnf−1/Rcnr)/(1/Rynf−1/Rynr)<4.5 (34).

A forty-sixth aspect of the present disclosure relates to the variable magnification optical system according to the first aspect, in which in a case in which an average value of Abbe numbers of all positive lenses in the front group based on a d line is denoted by vdFp_ave, Conditional Expression (35) is satisfied, which is represented by 20<vdFp_ave<95 (35).

A forty-seventh aspect of the present disclosure relates to the variable magnification optical system according to the first aspect, in which in a case in which a thickness, on the optical axis, of the lens group of the front group closest to the object side is denoted by dF1, and an effective diameter of a lens surface of the front group closest to the object side is denoted by EDf, Conditional Expression (36) is satisfied, which is represented by 0.1<dF1/EDf<0.6 (36).

A forty-eighth aspect of the present disclosure relates to the variable magnification optical system according to the first aspect, in which in a case in which a thickness, on the optical axis, of the lens group of the front group closest to the object side is denoted by dF1, and a distance, on the optical axis, from a lens surface of the front group closest to the object side to a paraxial entrance pupil position in a state in which the infinite distance object is in focus at the wide angle end is denoted by Denw, Conditional Expression (37) is satisfied, which is represented by 0.3<dF1/(Denw×tan ωw)<1.6 (37).

A forty-ninth aspect of the present disclosure relates to the variable magnification optical system according to the first aspect, in which in a case in which a thickness, on the optical axis, of the lens group of the front group closest to the object side is denoted by dF1, and a focal length of the lens group of the front group closest to the object side is denoted by fF1, Conditional Expression (38) is satisfied, which is represented by 0.03<dF1/fF1<0.4 (38).

A fiftieth aspect of the present disclosure relates to the variable magnification optical system according to the first aspect, in which in a case in which an average value of specific gravities of all lenses in the front group is denoted by GFave, Conditional Expression (39) is satisfied, which is represented by 2<GFave<5 (39).

A fifty-first aspect of the present disclosure relates to the variable magnification optical system according to the first aspect, in which a lens group of the subsequent group closest to the image side is fixed with respect to the image plane during magnification change.

A fifty-second aspect of the present disclosure relates to the variable magnification optical system according to the first aspect, in which the variable magnification optical system includes an Lp lens that is a positive lens, and in a case in which a refractive index of the Lp lens at a d line is denoted by NLp, an Abbe number of the Lp lens based on the d line is denoted by vLp, and a partial dispersion ratio of the Lp lens between a g line and an F line is denoted by θLp, Conditional Expressions (40), (41), (42), and (43) are satisfied, which are represented by 0.005<NLp−(2.015−0.0068×vLp)<0.15 (40), 49.8<vLp<65 (41), 0.543<θLp<0.58 (42), and −0.011<θLp−(0.6418−0.00168×vLp)<0 (43).

A fifty-third aspect of the present disclosure relates to the variable magnification optical system according to the fifty-second aspect, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3-1) is satisfied, which is represented by 5.6<TLw/(fw×tan ωw)<9.5 (3-1).

A fifty-fourth aspect of the present disclosure relates to the variable magnification optical system according to the seventh aspect, in which the subsequent group consists of, in order from the object side to the image side, the first subsequent lens group, a second subsequent lens group having a negative refractive power, and a third subsequent lens group.

A fifty-fifth aspect of the present disclosure relates to the variable magnification optical system according to the fifty-fourth aspect, in which in a case in which a focal length of the first subsequent lens group is denoted by fR1, and a focal length of the third subsequent lens group is denoted by fR3, Conditional Expression (44) is satisfied, which is represented by −1<fR1/fR3<0.7 (44).

A fifty-sixth aspect of the present disclosure relates to the variable magnification optical system according to the fifty-fourth aspect, in which in a case in which a focal length of the first subsequent lens group is denoted by fR1, and a focal length of the second subsequent lens group is denoted by fR2, Conditional Expression (45) is satisfied, which is represented by 0.4<fR1/(−fR2)<1.8 (45).

A fifty-seventh aspect of the present disclosure relates to the variable magnification optical system according to the seventh aspect, in which the subsequent group consists of, in order from the object side to the image side, the first subsequent lens group, a second subsequent lens group having a positive refractive power, and a third subsequent lens group having a negative refractive power.

A fifty-eighth aspect of the present disclosure relates to the variable magnification optical system according to the fifty-seventh aspect, in which in a case in which a focal length of the first subsequent lens group is denoted by fR1, and a focal length of the third subsequent lens group is denoted by fR3, Conditional Expression (46) is satisfied, which is represented by 0.6<fR1/(−fR3)<1.9 (46).

A fifty-ninth aspect of the present disclosure relates to the variable magnification optical system according to the fifty-seventh aspect, in which in a case in which a focal length of the second subsequent lens group is denoted by fR2, and a focal length of the third subsequent lens group is denoted by fR3, Conditional Expression (47) is satisfied, which is represented by 1.6<fR2/(−fR3)<3 (47).

A sixtieth aspect of the present disclosure relates to the variable magnification optical system according to the seventh aspect, in which the subsequent group consists of, in order from the object side to the image side, the first subsequent lens group, a second subsequent lens group having a positive refractive power, a third subsequent lens group having a negative refractive power, and a fourth subsequent lens group.

A sixty-first aspect of the present disclosure relates to the variable magnification optical system according to the sixtieth aspect, in which in a case in which a focal length of the first subsequent lens group is denoted by fR1, and a focal length of the third subsequent lens group is denoted by fR3, Conditional Expression (46A) is satisfied, which is represented by 0.3<fR1/(−fR3)<2 (46A).

A sixty-second aspect of the present disclosure relates to the variable magnification optical system according to the sixtieth aspect, in which in a case in which a focal length of the second subsequent lens group is denoted by fR2, and a focal length of the third subsequent lens group is denoted by fR3, Conditional Expression (47A) is satisfied, which is represented by 0.4<fR2/(−fR3)<1.8 (47A).

A sixty-third aspect of the present disclosure relates to the variable magnification optical system according to the sixtieth aspect, in which in a case in which a focal length of the first subsequent lens group is denoted by fR1, and a focal length of the second subsequent lens group is denoted by fR2, Conditional Expression (48A) is satisfied, which is represented by 0.25<fR1/fR2<2.5 (48A).

A sixty-fourth aspect of the present disclosure relates to the variable magnification optical system according to the seventh aspect, in which the subsequent group consists of, in order from the object side to the image side, the first subsequent lens group, a second subsequent lens group having a positive refractive power, a third subsequent lens group having a negative refractive power, a fourth subsequent lens group, and a fifth subsequent lens group.

A sixty-fifth aspect of the present disclosure relates to the variable magnification optical system according to the sixty-fourth aspect, in which in a case in which a focal length of the first subsequent lens group is denoted by fR1, and a focal length of the second subsequent lens group is denoted by fR2, Conditional Expression (48B) is satisfied, which is represented by 0.4<fR1/fR2<1.3 (48B).

A sixty-sixth aspect of the present disclosure relates to the variable magnification optical system according to the sixty-fourth aspect, in which in a case in which a focal length of the second subsequent lens group is denoted by fR2, and a focal length of the third subsequent lens group is denoted by fR3, Conditional Expression (47B) is satisfied, which is represented by 0.3<fR2/(−fR3)<1.7 (47B).

A sixty-seventh aspect of the present disclosure relates to the variable magnification optical system according to the seventh aspect, in which the subsequent group consists of, in order from the object side to the image side, the first subsequent lens group, a second subsequent lens group having a negative refractive power, a third subsequent lens group having a positive refractive power, and a fourth subsequent lens group.

A sixty-eighth aspect of the present disclosure relates to the variable magnification optical system according to the sixty-seventh aspect, in which in a case in which a focal length of the first subsequent lens group is denoted by fR1, and a focal length of the third subsequent lens group is denoted by fR3, Conditional Expression (44C) is satisfied, which is represented by 0.19<fR1/fR3<1.5 (44C).

A sixty-ninth aspect of the present disclosure relates to the variable magnification optical system according to the sixty-seventh aspect, in which in a case in which a focal length of the first subsequent lens group is denoted by fR1, and a focal length of the second subsequent lens group is denoted by fR2, Conditional Expression (45C) is satisfied, which is represented by 0.2<fR1/(−fR2)<1.6 (45C).

A seventieth aspect of the present disclosure relates to the variable magnification optical system according to the seventh aspect, in which the subsequent group consists of, in order from the object side to the image side, the first subsequent lens group, a second subsequent lens group having a positive refractive power, a third subsequent lens group having a positive refractive power, a fourth subsequent lens group having a negative refractive power, a fifth subsequent lens group, and a sixth subsequent lens group.

A seventy-first aspect of the present disclosure relates to the variable magnification optical system according to the seventieth aspect, in which in a case in which a focal length of the first subsequent lens group is denoted by fR1, and a focal length of the second subsequent lens group is denoted by fR2, Conditional Expression (48D) is satisfied, which is represented by 1.2<fR1/fR2<2.5 (48D).

A seventy-second aspect of the present disclosure relates to the variable magnification optical system according to the seventieth aspect, in which in a case in which a focal length of the second subsequent lens group is denoted by fR2, and a focal length of the third subsequent lens group is denoted by fR3, Conditional Expression (49D) is satisfied, which is represented by 0.3<fR2/fR3<1 (49D).

A seventy-third aspect of the present disclosure relates to the variable magnification optical system according to the seventieth aspect, in which in a case in which a focal length of the third subsequent lens group is denoted by fR3, and a focal length of the fourth subsequent lens group is denoted by fR4, Conditional Expression (50D) is satisfied, which is represented by 1.2<fR3/(−fR4)<2.5 (50D).

A seventy-fourth aspect of the present disclosure relates to an imaging apparatus comprising: the variable magnification optical system according to any one of the first to seventy-third aspects.

It should be noted that, in the present specification, the expressions “consists of” and “consisting of” indicate that a lens substantially not having a refractive power, an optical element other than a lens, such as a stop, a filter, and a cover glass, a mechanism part such as a lens flange, a lens barrel, an imaging element, and a camera shake correction mechanism may be included in addition to the shown constituents.

The term “ . . . group having a positive refractive power” in the present specification means that the entire group has a positive refractive power. The term “ . . . group having a negative refractive power” means that the entire group has a negative refractive power. The term “lens having a positive refractive power” and the term “positive lens” are synonymous with each other. The term “lens having a negative refractive power” and the term “negative lens” are synonymous with each other. The term “ . . . group” in the present specification is not limited to a configuration consisting of a plurality of lenses and may be a configuration consisting of only one lens.

A compound aspherical lens (a lens in which a lens (for example, a spherical lens) and a film of an aspherical shape formed on the lens are integrally formed and that functions as one aspherical lens as a whole) is not regarded as a cemented lens and is regarded as one lens. Unless otherwise noted, a sign of a refractive power and a surface shape related to a lens including an aspherical surface in a paraxial region are used. A sign of a paraxial curvature radius of a surface having a convex shape facing the object side is defined as positive, and a sign of a paraxial curvature radius of a surface having a convex shape facing the image side is defined as negative.

The term “entire system” in the present specification means the variable magnification optical system. The term “focal length” used in the conditional expressions means a paraxial focal length. Unless otherwise noted, the term “distance on the optical axis” used in the conditional expressions means a geometrical distance. Unless otherwise noted, values used in the conditional expressions are values based on the d line in a state in which the infinite distance object is in focus.

The terms “d line”, “C line”, “F line”, and “g line” described in the present specification mean bright lines. A wavelength of the d line is 587.56 nanometers (nm), a wavelength of the C line is 656.27 nanometers (nm), a wavelength of the F line is 486.13 nanometers (nm), and a wavelength of the g line is 435.84 nanometers (nm).

According to the present disclosure, it is possible to provide the variable magnification optical system that is configured to be small in size, that suppresses the change in the position of the centroid caused by magnification change, and that maintains favorable optical performance in the entire magnification change range, and the imaging apparatus comprising the variable magnification optical system.

### BRIEF DESCRIPTION OF THE DRAWINGS

FIG. 1 is a diagram corresponding to a variable magnification optical system according to Example 1 and showing a cross-sectional view of a configuration and a movement trajectory of a variable magnification optical system according to one embodiment.

FIG. 2 is a diagram showing a configuration and a luminous flux of the variable magnification optical system in FIG. 1 in each magnification change state.

FIG. 3 is a diagram showing an effective diameter.

FIG. 4 is each aberration diagram of the variable magnification optical system according to Example 1.

FIG. 5 is a diagram showing a cross-sectional view of a configuration and a movement trajectory of a variable magnification optical system according to Example 2.

FIG. 6 is each aberration diagram of the variable magnification optical system according to Example 2.

FIG. 7 is a diagram showing a cross-sectional view of a configuration and a movement trajectory of a variable magnification optical system according to Example 3.

FIG. 8 is each aberration diagram of the variable magnification optical system according to Example 3.

FIG. 9 is a diagram showing a cross-sectional view of a configuration and a movement trajectory of a variable magnification optical system according to Example 4.

FIG. 10 is each aberration diagram of the variable magnification optical system according to Example 4.

FIG. 11 is a diagram showing a cross-sectional view of a configuration and a movement trajectory of a variable magnification optical system according to Example 5.

FIG. 12 is each aberration diagram of the variable magnification optical system according to Example 5.

FIG. 13 is a diagram showing a cross-sectional view of a configuration and a movement trajectory of a variable magnification optical system according to Example 6.

FIG. 14 is each aberration diagram of the variable magnification optical system according to Example 6.

FIG. 15 is a diagram showing a cross-sectional view of a configuration and a movement trajectory of a variable magnification optical system according to Example 7.

FIG. 16 is each aberration diagram of the variable magnification optical system according to Example 7.

FIG. 17 is a diagram showing a cross-sectional view of a configuration and a movement trajectory of a variable magnification optical system according to Example 8.

FIG. 18 is each aberration diagram of the variable magnification optical system according to Example 8.

FIG. 19 is a diagram showing a cross-sectional view of a configuration and a movement trajectory of a variable magnification optical system according to Example 9.

FIG. 20 is each aberration diagram of the variable magnification optical system according to Example 9.

FIG. 21 is a diagram showing a cross-sectional view of a configuration and a movement trajectory of a variable magnification optical system according to Example 10.

FIG. 22 is each aberration diagram of the variable magnification optical system according to Example 10.

FIG. 23 is a diagram showing a cross-sectional view of a configuration and a movement trajectory of a variable magnification optical system according to Example 11.

FIG. 24 is each aberration diagram of the variable magnification optical system according to Example 11.

FIG. 25 is a diagram showing a cross-sectional view of a configuration and a movement trajectory of a variable magnification optical system according to Example 12.

FIG. 26 is each aberration diagram of the variable magnification optical system according to Example 12.

FIG. 27 is a diagram showing a cross-sectional view of a configuration and a movement trajectory of a variable magnification optical system according to Example 13.

FIG. 28 is each aberration diagram of the variable magnification optical system according to Example 13.

FIG. 29 is a diagram showing a cross-sectional view of a configuration and a movement trajectory of a variable magnification optical system according to Example 14.

FIG. 30 is each aberration diagram of the variable magnification optical system according to Example 14.

FIG. 31 is a diagram showing a cross-sectional view of a configuration and a movement trajectory of a variable magnification optical system according to Example 15.

FIG. 32 is each aberration diagram of the variable magnification optical system according to Example 15.

FIG. 33 is a diagram showing a cross-sectional view of a configuration and a movement trajectory of a variable magnification optical system according to Example 16.

FIG. 34 is each aberration diagram of the variable magnification optical system according to Example 16.

FIG. 35 is a diagram showing a cross-sectional view of a configuration and a movement trajectory of a variable magnification optical system according to Example 17.

FIG. 36 is each aberration diagram of the variable magnification optical system according to Example 17.

FIG. 37 is a perspective view of a front surface side of an imaging apparatus according to one embodiment.

FIG. 38 is a perspective view of a rear surface side of the imaging apparatus according to one embodiment.

### DETAILED DESCRIPTION

Hereinafter, embodiments of the present disclosure will be described with reference to the accompanying drawings.

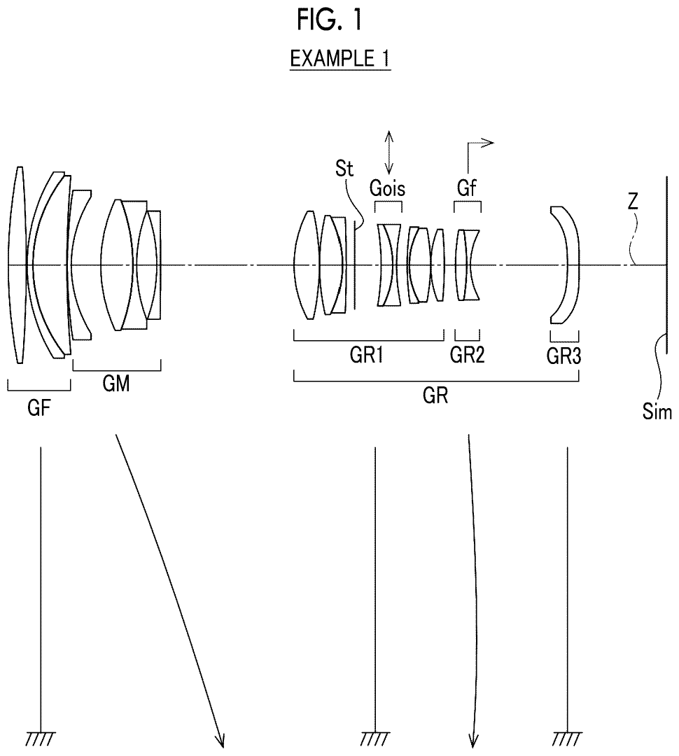

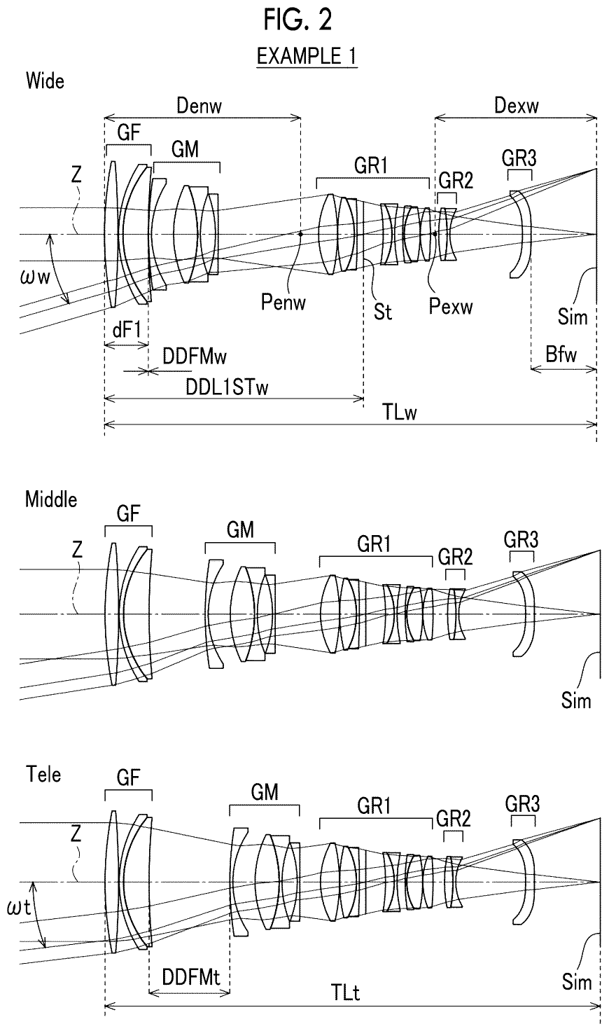

FIG. 1 shows a cross-sectional view of a configuration and a movement trajectory of a variable magnification optical system according to one embodiment of the present disclosure at a wide angle end. FIG. 2 shows a cross-sectional view and a luminous flux of the configuration of the variable magnification optical system in FIG. 1 in each state. In FIG. 2, an upper part labeled “Wide” shows a wide angle end state, a middle part labeled “Middle” shows a middle focal length state, and a lower part labeled “Tele” shows a telephoto end state. FIG. 2 shows, as the luminous flux, an on-axis luminous flux and a luminous flux at a maximum half angle of view in each state. The examples shown in FIGS. 1 and 2 correspond to a variable magnification optical system according to Example 1 which will be described later. FIGS. 1 and 2 show a state in which an infinite distance object is in focus, in which a left side is an object side, and a right side is an image side. Hereinafter, the description will be mainly made with reference to FIG. 1.

The variable magnification optical system according to the present disclosure consists of a front group GF, an intermediate group GM, and a subsequent group GR in order from the object side to the image side along an optical axis Z. The front group GF consists of two or fewer lens groups having a positive refractive power. The intermediate group GM consists of two or fewer lens groups having a negative refractive power. The subsequent group GR consists of a plurality of lens groups. A lens group of the subsequent group GR closest to the object side is a first subsequent lens group GR1 having a positive refractive power. All spacings between adjacent lens groups are changed during magnification change. With the above-described configuration, an advantage in suppressing various aberrations in the entire magnification change range is achieved.

It should be noted that, in the present specification, a group of which a spacing with an adjacent group in an optical axis direction changes during magnification change is defined as one lens group. During magnification change, a spacing between adjacent lenses is not changed in one lens group. That is, the term “lens group” means a portion that constitutes the variable magnification optical system and that includes at least one lens divided by an air spacing that is changed during magnification change. During magnification change, each lens group is moved or fixed in lens group units. The term “lens group” may include a constituent having no refractive power other than a lens, for example, an aperture stop St.

During magnification change, the lens group of the front group GF closest to the object side is fixed with respect to an image plane Sim. With this configuration, since there is no change in the total length of the optical system caused by magnification change, the change in the position of the centroid caused by magnification change can be suppressed. It should be noted that, in a case in which the front group GF consists of one lens group, the lens group of the front group GF closest to the object side is the front group GF.

As an example, each group of the variable magnification optical system shown in FIG. 1 is configured as follows. The front group GF consists of one lens group composed of three lenses. The intermediate group GM consists of one lens group composed of four lenses. The subsequent group GR consists of, in order from the object side to the image side, a first subsequent lens group GR1 composed of eight lenses and an aperture stop St, a second subsequent lens group GR2 composed of two lenses, and a third subsequent lens group GR3 composed of one lens. The aperture stop St shown in FIG. 1 does not indicate a size and a shape, and indicates a position on the optical axis. As in the example in FIG. 1, in a configuration in which the front group GF consists of one lens group, an advantage in the size reduction is achieved. In a configuration in which the intermediate group GM consists of one lens group, an advantage of the size reduction is achieved.

As in the example in FIG. 1, it is preferable that the front group GF includes a cemented lens in which a negative meniscus lens having a convex surface facing the object side and a positive lens having a convex surface facing the object side are cemented in order from the object side. In such a case, the corrections of a lateral chromatic aberration at the wide angle end and an axial chromatic aberration at the telephoto end are facilitated.

In the example of FIG. 1, during magnification change, the intermediate group GM and the second subsequent lens group GR2 move along the optical axis Z by changing the spacings between the adjacent lens groups, and the front group GF, the first subsequent lens group GR1, and the third subsequent lens group GR3 are fixed with respect to the image plane Sim. In FIG. 1, an arrow indicating a schematic movement trajectory of each group during magnification change from the wide angle end to the telephoto end is shown below each group that moves during magnification change, and a ground symbol is shown below each group that is fixed with respect to the image plane Sim.

It is preferable that a lens group of the subsequent group GR closest to the image side is fixed with respect to the image plane Sim during magnification change. In such a case, a drive mechanism during magnification change can be simplified.

It is preferable that at least one lens group that is fixed with respect to the image plane Sim during magnification change is disposed between the front group GF and the lens group of the subsequent group GR closest to the image side. In such a case, since the number of cams for moving the lens group can be reduced, it is possible to achieve simplification of the drive mechanism of the lens.

Two or fewer focusing groups Gf that move along the optical axis Z during focusing are disposed in the subsequent group GR. Focusing is performed by moving the focusing group Gf. During focusing, a group other than the focusing group Gf is fixed with respect to the image plane Sim. By disposing the focusing group Gf closer to the image side than the intermediate group GM, an advantage in suppressing bleeding during focusing is achieved. The variable magnification optical system in the example of FIG. 1 includes only one focusing group Gf, and the focusing group Gf consists of the second subsequent lens group GR2. A rightward arrow above the focusing group Gf in FIG. 1 indicates that the focusing group Gf moves to the image side during focusing on a short distance object from the infinite distance object in the wide angle end state. In a case in which the variable magnification optical system includes only one focusing group Gf, there is an advantage in simplifying the drive mechanism as compared with a case in which the variable magnification optical system includes two focusing groups Gf.

It is preferable that an anti-vibration group Gois that moves in a direction intersecting with the optical axis Z during image shake correction is disposed closer to the image side than the front group GF. The image shake correction is performed by moving the anti-vibration group Gois. In the example of FIG. 1, the anti-vibration group Gois consists of a fourth lens and a fifth lens of the first subsequent lens group GR1 from the object side. In FIG. 1, a double arrow in an up-down direction is written on the lens corresponding to the anti-vibration group Gois.

The anti-vibration group Gois may be configured to be disposed closer to the object side than the focusing group Gf. In such a case, there is an advantage in suppressing fluctuation in aberration during image shake correction caused by a difference in focusing position.

As in the example of FIG. 1, the anti-vibration group Gois may be configured to be disposed in the subsequent group GR. In such a case, a diameter of a mechanism for moving the anti-vibration group Gois can be suppressed, so that the size reduction is facilitated.

It should be noted that, in the variable magnification optical system according to the present disclosure, unlike the example of FIG. 1, the anti-vibration group Gois may be configured to be disposed in the intermediate group GM. In such a case, it is easy to suppress a movement amount of the anti-vibration group Gois for image shake correction.

Next, preferable configurations and available configurations related to the conditional expressions of the variable magnification optical system according to the present disclosure will be described. It should be noted that, in the following description related to the conditional expressions, duplicate descriptions of symbols will be omitted by using the same symbol for the same definition in order to avoid redundant description. Hereinafter, the term “variable magnification optical system according to the present disclosure” will be simply referred to as the “variable magnification optical system” in order to avoid redundant description.

It is preferable that the variable magnification optical system satisfies Conditional Expression (1). Here, a focal length of the entire system in a state in which the infinite distance object is in focus at the telephoto end is denoted by ft. A focal length of the entire system in a state in which the infinite distance object is in focus at the wide angle end is denoted by fw. A maximum half angle of view in a state in which the infinite distance object is in focus at the wide angle end is denoted by ow. As an example, FIG. 2 shows the maximum half angle of view ow. In Conditional Expression (1), tan is a tangent, and the same applies to other conditional expressions. By not allowing the corresponding value of Conditional Expression (1) to be equal to or less than the lower limit, the focal length at the telephoto end is prevented from being excessively shortened, so that the value of the variable magnification optical system can be sufficiently exhibited, and particularly, the added value as a telephoto type variable magnification optical system can be ensured. By not allowing the corresponding value of Conditional Expression (1) to be equal to or more than the upper limit, the magnification change ratio is prevented from being excessively high, so that it is possible to prevent the movement amount of the lens group from becoming excessive, and thus there is an advantage in achieving the size reduction in the entire optical system.

$$5 < ft / ( fw \times tan ω w ) < 20 \qquad ( 1 )$$

In order to obtain more favorable characteristics, it is preferable to set the lower limit of Conditional Expression (1) to any of 6, 6.4, 6.7, 7, or 7.3 instead of 5. In addition, it is preferable to set the upper limit of Conditional Expression (1) to any of 17, 14, 11, 9.8 or 9.2 instead of 20.

In a case in which a back focus of the entire system at the air conversion distance in a state in which the infinite distance object is in focus at the wide angle end is denoted by Bfw, it is preferable that the variable magnification optical system satisfies Conditional Expression (2). The back focus at the air conversion distance is an air conversion distance, on the optical axis, from a lens surface of the variable magnification optical system closest to the image side to the image plane Sim. As an example, FIG. 2 shows the back focus Bfw. By not allowing the corresponding value of Conditional Expression (2) to be equal to or less than the lower limit, the back focus Bfw defined above is prevented from being excessively shortened, so that the attachment of the mount replacement mechanism is facilitated. By not allowing the corresponding value of Conditional Expression (2) to be equal to or more than the upper limit, the back focus Bfw defined above is prevented from being excessively increased, so that the size reduction is facilitated.

$$0.5 < Bfw / ( fw \times tan ω w ) < 2.5 \qquad ( 2 )$$

In order to obtain more favorable characteristics, it is preferable to set the lower limit of Conditional Expression (2) to any of 0.6, 0.7, 0.8, or 0.9 instead of 0.5. Further, it is preferable to set the upper limit of Conditional Expression (2) to any of 2.4, 2.3, 2.2, or 2.1 instead of 2.5.

It is preferable that the variable magnification optical system satisfies Conditional Expression (3). Here, a sum of a distance, on the optical axis, from the lens surface of the front group GF closest to the object side to the lens surface of the subsequent group GR closest to the image side and the back focus of the entire system at the air conversion distance, in a state in which the infinite distance object is in focus at the wide angle end, is denoted by TLw. TLw denotes a total length in a state in which the infinite distance object is in focus at the wide angle end. As an example, FIG. 2 shows the total length TLw. By not allowing the corresponding value of Conditional Expression (3) to be equal to or less than the lower limit, an advantage in suppressing various aberrations in the entire magnification change range is achieved. By not allowing the corresponding value of Conditional Expression (3) to be equal to or more than the upper limit, an advantage in the size reduction in the entire optical system is achieved.

$$5 < TLw / ( fw \times tan ω w ) < 1 0.5 \qquad ( 3 )$$

In order to obtain more favorable characteristics, it is preferable to set the lower limit of Conditional Expression (3) to any of 5.3, 5.6, 5.8, 6, or 6.2 instead of 5. In addition, it is preferable to set the upper limit of Conditional Expression (3) to any of 9.7, 9.5, 9.3, 9.1, or 8.45 instead of 10.5. For example, the variable magnification optical system more preferably satisfies Conditional Expression (3-1), it is yet more preferable that the variable magnification optical system still more preferably satisfies Conditional Expression (3-2), still more preferably satisfies Conditional Expression (3-3), and still more preferably satisfies Conditional Expression (3-4).

$$5.6 < TLw / ( fw \times tan ω w ) < 9.5 \qquad ( 3 - 1 )$$

$$5.8 < TLw / ( fw \times tan ω w ) < 9.3 \qquad ( 3 - 2 )$$

$$6 < TLw / ( fw \times tan ω w ) < 9.1 \qquad ( 3 - 3 )$$

$$6.2 < TLw / ( fw \times tan ω w ) < 8.45 \qquad ( 3 - 4 )$$

It is preferable that the variable magnification optical system satisfies Conditional Expression (4). Here, a sum of a distance, on the optical axis, from the lens surface of the front group GF closest to the object side to the lens surface of the subsequent group GR closest to the image side and the back focus of the entire system at the air conversion distance, in a state in which the infinite distance object is in focus at the telephoto end, is denoted by TLt. TLt denotes a total length in a state in which the infinite distance object is in focus at the telephoto end. As an example, FIG. 2 shows the total length TLt. By not allowing the corresponding value of Conditional Expression (4) to be equal to or less than the lower limit, an advantage in suppressing various aberrations in the entire magnification change range is achieved. By not allowing the corresponding value of Conditional Expression (4) to be equal to or more than the upper limit, an advantage in suppressing various aberrations in the entire magnification change range is achieved.

$$0.5 < TLt / ft < 1.3 \qquad ( 4 )$$

In order to obtain more favorable characteristics, it is preferable to set the lower limit of Conditional Expression (4) to any of 0.6 or 0.7 instead of 0.5. In addition, it is preferable to set the upper limit of Conditional Expression (4) to any of 1.2 or 1.1 instead of 1.3.

In a case in which the open F-number in a state in which the infinite distance object is in focus at the telephoto end is denoted by FNot, it is preferable that the variable magnification optical system satisfies Conditional Expression (5). By not allowing the corresponding value of Conditional Expression (5) to be equal to or less than the lower limit, an advantage in the size reduction in the entire optical system or an advantage in suppressing various aberrations particularly at the telephoto end is achieved. By not allowing the corresponding value of Conditional Expression (5) to be equal to or more than the upper limit, obtaining sufficient brightness at the telephoto end is facilitated.

$$0.9 < FNot / ( ft / fw ) < 2.1 \qquad ( 5 )$$

In order to obtain more favorable characteristics, it is preferable to set the lower limit of Conditional Expression (5) to any of 1.15, 1.25, or 1.35 instead of 0.9. In addition, it is preferable to set the upper limit of Conditional Expression (5) to any of 1.9, 1.75, or 1.7 instead of 2.1. For example, it is more preferable that the variable magnification optical system satisfies Conditional Expression (5-1).

$$1.25 < FNot / ( ft / fw ) < 1.75 \qquad ( 5 - 1 )$$

In a case in which a maximum half angle of view in a state in which the infinite distance object is in focus at the telephoto end is denoted by ωt, it is preferable that the variable magnification optical system satisfies Conditional Expression (6). As an example, FIG. 2 shows the maximum half angle of view ωt. By not allowing the corresponding value of Conditional Expression (6) to be equal to or less than the lower limit, an advantage in suppressing various aberrations is achieved. By not allowing the corresponding value of Conditional Expression (6) to be equal to or more than the upper limit, an advantage in increase in the angle of view at the wide angle end is achieved.

$$5 < ft / ( fw \times tan ω w ) < 20 \qquad ( 6 )$$

In order to obtain more favorable characteristics, it is preferable to set the lower limit of Conditional Expression (6) to any of 6, 6.4, 6.7, 7, or 7.3 instead of 5. In addition, it is preferable to set the upper limit of Conditional Expression (6) to any of 17, 14, 11, 9.8 or 9.2 instead of 20.

It is preferable that the variable magnification optical system satisfies Conditional Expression (7). By not allowing the corresponding value of Conditional Expression (7) to be equal to or less than the lower limit, an advantage in suppressing various aberrations in the entire magnification change range is achieved. By not allowing the corresponding value of Conditional Expression (7) to be equal to or more than the upper limit, an advantage in the size reduction in the entire optical system or an advantage in obtaining a sufficient magnification change ratio as the variable magnification optical system is achieved.

$$0.1 < ( fw \times TLw ) / {ft}^{2} < 0 \text{.55} \qquad ( 7 )$$

In order to obtain more favorable characteristics, it is preferable to set the lower limit of Conditional Expression (7) to any of 0.15 or 0.2 instead of 0.1. In addition, it is preferable to set the upper limit of Conditional Expression (7) to any of 0.5 or 0.45 instead of 0.55.

It is preferable that the variable magnification optical system satisfies Conditional Expression (8). By not allowing the corresponding value of Conditional Expression (8) to be equal to or less than the lower limit, the magnification change ratio is prevented from being excessively decreased, so that the value of the variable magnification optical system can be sufficiently exhibited. By not allowing the corresponding value of Conditional Expression (8) to be equal to or more than the upper limit, the magnification change ratio is prevented from being excessively high, so that it is possible to prevent the movement amount of the lens group from becoming excessive, and thus there is an advantage in achieving the size reduction in the entire optical system.

$$1.5 < ft / fw < 4.3 \qquad ( 8 )$$

In order to obtain more favorable characteristics, it is preferable to set the lower limit of Conditional Expression (8) to any of 1.9, 2, 2.1, or 2.2 instead of 1.5. Further, it is preferable to set the upper limit of Conditional Expression (8) to any of 3.9, 3.4, 3.1, or 2.95 instead of 4.3.

In a case in which a focal length of the lens group of the front group GF closest to the object side is denoted by fF1, it is preferable that the variable magnification optical system satisfies Conditional Expression (9). By not allowing the corresponding value of Conditional Expression (9) to be equal to or less than the lower limit, the refractive power of the front group GF is prevented from being excessively strong, so that an advantage in suppressing fluctuations of aberrations during magnification change is achieved. By not allowing the corresponding value of Conditional Expression (9) to be equal to or more than the upper limit, the refractive power of the front group GF is prevented from being excessively weak, so that an advantage in reducing the size of the front group GF is achieved.

$$0.5 < fF 1 / fw < 3.4 \qquad ( 9 )$$

In order to obtain more favorable characteristics, it is preferable to set the lower limit of Conditional Expression (9) to any of 0.6, 0.7, 0.8, or 0.9 instead of 0.5. Further, it is preferable to set the upper limit of Conditional Expression (9) to any of 3.1, 2.8, 2.5, or 2.2 instead of 3.4.

In a case in which a focal length of the intermediate group GM at the wide angle end is denoted by fM, it is preferable that the variable magnification optical system satisfies Conditional Expression (10). By not allowing the corresponding value of Conditional Expression (10) to be equal to or less than the lower limit, the refractive power of the intermediate group GM is prevented from being excessively weak, so that, in a case in which the intermediate group GM moves during magnification change, an advantage in suppressing the movement amount of the lens group that moves during magnification change in the front group GF is achieved. By not allowing the corresponding value of Conditional Expression (10) to be equal to or more than the upper limit, the refractive power of the front group GF is prevented from being excessively weak, so that an advantage in suppressing size increase of the front group GF is achieved.

$$1 < fF 1 / ( - fM ) < 8 \qquad ( 10 )$$

In order to obtain more favorable characteristics, it is preferable to set the lower limit of Conditional Expression (10) to any of 1.3, 1.6, 1.9, or 2.2 instead of 1. In addition, it is preferable to set the upper limit of Conditional Expression (10) to any of 7, 6, 5, or 4.4 instead of 8.

It is preferable that the variable magnification optical system satisfies Conditional Expression (11). By not allowing the corresponding value of Conditional Expression (11) to be equal to or less than the lower limit, the refractive power of the front group GF is prevented from being excessively strong, so that an advantage in suppressing fluctuations of aberrations during magnification change is achieved. By not allowing the corresponding value of Conditional Expression (11) to be equal to or more than the upper limit, the refractive power of the front group GF is prevented from being excessively weak, so that an advantage in reducing the size of the front group GF is achieved.

$$0.4 < fF 1 / {( fw \times ft )}^{1 / 2} < 1.4 \qquad ( 11 )$$

In order to obtain more favorable characteristics, it is preferable to set the lower limit of Conditional Expression (11) to any of 0.5 Or 0.6 instead of 0.4. In addition, it is preferable to set the upper limit of Conditional Expression (11) to any of 1.3 or 1.2 instead of 1.4.

It is preferable that the variable magnification optical system satisfies Conditional Expression (12). By not allowing the corresponding value of Conditional Expression (12) to be equal to or less than the lower limit, the refractive power of the intermediate group GM is prevented from being excessively strong, so that the field curvature generated in the intermediate group GM can be suppressed, and thus there is an advantage in correcting aberrations during magnification change. By not allowing the corresponding value of Conditional Expression (12) to be equal to or more than the upper limit, the refractive power of the intermediate group GM is prevented from being excessively weak, so that the movement amount of the lens group in the intermediate group GM during magnification change can be suppressed, and thus there is an advantage in achieving reduction in total length of the optical system.

$$0.1 < ( - fM ) / {( fw \times ft )}^{1 / 2} < 0.7 \qquad ( 12 )$$

In order to obtain more favorable characteristics, it is preferable to set the lower limit of Conditional Expression (12) to any of 0.14 or 0.17 instead of 0.1. In addition, it is preferable to set the upper limit of Conditional Expression (12) to any of 0.6 or 0.5 instead of 0.7.

It is preferable that the variable magnification optical system satisfies Conditional Expression (13). By not allowing the corresponding value of Conditional Expression (13) to be equal to or less than the lower limit, an advantage in high performance is achieved. By not allowing the corresponding value of Conditional Expression (13) to be equal to or more than the upper limit, the refractive power of the front group GF is prevented from being excessively weak, so that an advantage in reducing the size of the front group GF is achieved.

$$1 < fF 1 / ( ft / FNot ) < 5 \qquad ( 13 )$$

In order to obtain more favorable characteristics, it is preferable to set the lower limit of Conditional Expression (13) to any of 1.3 or 1.6 instead of 1. In addition, it is preferable to set the upper limit of Conditional Expression (13) to any of 4 or 3.5 instead of 5.

It is preferable that the variable magnification optical system satisfies Conditional Expression (14). By not allowing the corresponding value of Conditional Expression (14) to be equal to or less than the lower limit, an advantage in suppressing various aberrations at the wide angle end is achieved. By not allowing the corresponding value of Conditional Expression (14) to be equal to or more than the upper limit, the reduction in the total length at the wide angle end is facilitated.

$$1.7 < TLw / fw < 3.5 \qquad ( 14 )$$

In order to obtain more favorable characteristics, it is preferable to set the lower limit of Conditional Expression (14) to any of 1.8 or 1.9 instead of 1.7. In addition, it is preferable to set the upper limit of Conditional Expression (14) to any of 3.3 or 3.1 instead of 3.5.

In a case in which the open F-number in a state in which the infinite distance object is in focus at the wide angle end is denoted by FNow, it is preferable that the variable magnification optical system satisfies Conditional Expression (15). By not allowing the corresponding value of Conditional Expression (15) to be equal to or less than the lower limit, decreasing the open F-number at the wide angle end while increasing an angle of view at the wide angle end is facilitated. By not allowing the corresponding value of Conditional Expression (15) to be equal to or more than the upper limit, an advantage in suppressing an increase in the number of lenses and suppressing size increase of the optical system while obtaining favorable optical performance is achieved.

$$0.06 < tan ω w / FNow < 0.12 \qquad ( 15 )$$

In order to obtain more favorable characteristics, it is preferable to set the lower limit of Conditional Expression (15) to any of 0.065 or 0.07 instead of 0.06. In addition, it is preferable to set the upper limit of Conditional Expression (15) to any of 0.11 or 0.1 instead of 0.12.

In the configuration in which the variable magnification optical system includes the aperture stop St disposed closer to the image side than the lens surface of the intermediate group GM closest to the image side, it is preferable that the variable magnification optical system satisfies Conditional Expression (16). Here, a distance, on the optical axis, from the lens surface of the front group GF closest to the object side to the aperture stop St in a state in which the infinite distance object is in focus at the wide angle end is denoted by DDL1STw. As an example, FIG. 2 shows the distance DDL1STw. By not allowing the corresponding value of Conditional Expression (16) to be equal to or less than the lower limit, a movable range of the intermediate group GM is prevented from being excessively reduced, so that an advantage in a high magnification change ratio is achieved. Alternatively, since the refractive power of the front group GF is prevented from being excessively weak, an advantage of achieving both of the size reduction and the high magnification change ratio is achieved. By not allowing the corresponding value of Conditional Expression (16) to be equal to or more than the upper limit, a distance from the lens surface of the front group GF closest to the object side to the entrance pupil position on the wide angle side is prevented from being excessively increased, so that the size increase in the front group GF can be suppressed, and thus an advantage in the size reduction is achieved. Alternatively, by not allowing the corresponding value of Conditional Expression (16) to be equal to or more than the upper limit, the refractive power of the front group GF is prevented from being excessively strong, so that an advantage in high performance is achieved.

$$0.4 < DDL 1 STw / fF 1 < 1.4 \qquad ( 16 )$$

In order to obtain more favorable characteristics, it is preferable to set the lower limit of Conditional Expression (16) to any of 0.5 or 0.55 instead of 0.4. In addition, it is preferable to set the upper limit of Conditional Expression (16) to any of 1.3 or 1.2 instead of 1.4.

It is preferable that the variable magnification optical system satisfies Conditional Expression (17). Here, a distance, on the optical axis, from the lens surface of the front group GF closest to the object side to the paraxial entrance pupil position Penw, in a state in which the infinite distance object is in focus at the wide angle end, is denoted by Denw. As an example, FIG. 2 shows the distance Denw and the paraxial entrance pupil position Penw. The sign of Denw defined such that, with the lens surface of the front group GF closest to the object side, a distance on the image side is positive and a distance on the object side is negative. By not allowing the corresponding value of Conditional Expression (17) to be equal to or less than the lower limit, the distance from the lens surface of the front group GF closest to the object side to the paraxial entrance pupil position Penw on the wide angle side is prevented from being excessively shortened, so that the suppression of fluctuation in aberrations during magnification change is facilitated. By not allowing the corresponding value of Conditional Expression (17) to be equal to or more than the upper limit, a distance from the lens surface of the front group GF closest to the object side to the paraxial entrance pupil position Penw on the wide angle side is prevented from being excessively increased, so that the size increase in the front group GF can be suppressed, and thus an advantage in the size reduction is achieved.

$$4 < Denw / \{ ( fw \times tan ω w ) \times log ( ft / fw ) \} < 9.5 \qquad ( 17 )$$

In order to obtain more favorable characteristics, it is preferable to set the lower limit of Conditional Expression (17) to any of 4.5 or 5 instead of 4. In addition, it is preferable to set the upper limit of Conditional Expression (17) to any of 9 or 8.7 instead of 9.5.

It is preferable that the variable magnification optical system satisfies Conditional Expression (18). By not allowing the corresponding value of Conditional Expression (18) to be equal to or less than the lower limit, the distance from the lens surface of the front group GF closest to the object side to the paraxial entrance pupil position Penw on the wide angle side is prevented from being excessively shortened, so that the suppression of fluctuation in aberrations during magnification change is facilitated. By not allowing the corresponding value of Conditional Expression (18) to be equal to or more than the upper limit, a distance from the lens surface of the front group GF closest to the object side to the paraxial entrance pupil position Penw on the wide angle side is prevented from being excessively increased, so that the size increase in the front group GF can be suppressed, and thus an advantage in the size reduction is achieved.

$$0.3 < Denw / {( fw \times ft )}^{1 / 2} < 0.8 \qquad ( 18 )$$

In order to obtain more favorable characteristics, it is preferable to set the lower limit of Conditional Expression (18) to any of 0.35 or 0.4 instead of 0.3. In addition, it is preferable to set the upper limit of Conditional Expression (18) to any of 0.75 or 0.7 instead of 0.8.

In the configuration in which the variable magnification optical system includes the aperture stop St, it is preferable that the variable magnification optical system satisfies Conditional Expression (19). By not allowing the corresponding value of Conditional Expression (19) to be equal to or less than the lower limit, the distance between the aperture stop St and the front group GF on the wide angle side is prevented from being excessively shortened, so that the distance from the lens surface of the front group GF closest to the object side to the entrance pupil position is prevented from being excessively decreased, and thus the suppression of fluctuations of aberrations during magnification change is facilitated. By not allowing the corresponding value of Conditional Expression (19) to be equal to or more than the upper limit, the distance between the aperture stop St and the front group GF on the wide angle side is prevented from being excessively increased, so that the distance from the lens surface of the front group GF closest to the object side to the entrance pupil position is prevented from being excessively increased. Accordingly, since the size increase in the front group GF can be suppressed, an advantage of the size reduction is achieved.

$$0.2 < DDL 1 STw / TLw < 0.65 \qquad ( 19 )$$

In order to obtain more favorable characteristics, it is preferable to set the lower limit of Conditional Expression (19) to any of 0.25 or 0.3 instead of 0.2. In addition, it is preferable to set the upper limit of Conditional Expression (19) to any of 0.6 or 0.55 instead of 0.65.

It is preferable that the variable magnification optical system satisfies Conditional Expression (20). Here, a distance, on the optical axis, from the paraxial exit pupil position Pexw to the image plane Sim in a state in which the infinite distance object at the wide angle end is in focus is denoted by Dexw. As an example, FIG. 2 shows the distance Dexw and the paraxial exit pupil position Pexw. The sign of Dexw is defined such that, with the paraxial exit pupil position Pexw as a reference, a distance on the image side is positive and a distance on the object side is negative. In addition, in a case in which an optical member having no refractive power is disposed between the paraxial exit pupil position Pexw and the image plane Sim, Dexw is calculated for the optical member using the air conversion distance. By not allowing the corresponding value of Conditional Expression (20) to be equal to or less than the lower limit, the reduction in the total length of the optical system is facilitated, and thus an advantage in the size reduction is achieved. By not allowing the corresponding value of Conditional Expression (20) to be equal to or more than the upper limit, the reduction in the incidence angle of the off-axis principal ray on the image plane Sim is facilitated, and thus an advantage in ensuring the edge part light quantity is achieved.

$$0.6 < fw / Dexw < 1.7 \qquad ( 20 )$$

In order to obtain more favorable characteristics, it is preferable to set the lower limit of Conditional Expression (20) to any of 0.65 or 0.68 instead of 0.6. In addition, it is preferable to set the upper limit of Conditional Expression (20) to any of 1.6 or 1.5 instead of 1.7.

It is preferable that the variable magnification optical system satisfies Conditional Expression (21). Here, a spacing, on the optical axis, between the front group GF and the intermediate group GM in a state in which the infinite distance object is in focus at the telephoto end is denoted by DDFMt. A spacing, on the optical axis, between the front group GF and the intermediate group GM in a state in which the infinite distance object is in focus at the wide angle end is denoted by DDFMw. As an example, FIG. 2 shows the spacing DDFMt and the spacing DDFMw. By not allowing the corresponding value of Conditional Expression (21) to be equal to or less than the lower limit, there is an advantage in maintaining a high magnification change ratio. By not allowing the corresponding value of Conditional Expression (21) to be equal to or more than the upper limit, an advantage in suppressing the distortion during magnification change is achieved.

$$0.01 < \vert DDFMt - DDFMw \vert / TLw < 0 \text{.35} \qquad ( 21 )$$

In order to obtain more favorable characteristics, it is preferable to set the lower limit of Conditional Expression (21) to any of 0.08 or 0.1 instead of 0.01. In addition, it is preferable to set the upper limit of Conditional Expression (21) to any of 0.32 or 0.3 instead of 0.35.

In a case in which a focal length of the subsequent group GR in a state in which the infinite distance object is in focus at the wide angle end is denoted by fRw, it is preferable that the variable magnification optical system satisfies Conditional Expression (22). By not allowing the corresponding value of Conditional Expression (22) to be equal to or less than the lower limit, the reduction in the total length of the optical system at the wide angle end is facilitated, and thus an advantage in the size reduction is achieved. By not allowing the corresponding value of Conditional Expression (22) to be equal to or more than the upper limit, an advantage in suppressing a spherical aberration at the wide angle end is achieved.

$$1 < fw / fRw < 3 \qquad ( 22 )$$

In order to obtain more favorable characteristics, it is preferable to set the lower limit of Conditional Expression (22) to any of 1.1 or 1.2 instead of 1. In addition, it is preferable to set the upper limit of Conditional Expression (22) to any of 2.7 or 2.5 instead of 3.

In a case in which a focal length of the subsequent group GR in a state in which the infinite distance object is in focus at the telephoto end is denoted by fRt, it is preferable that the variable magnification optical system satisfies Conditional Expression (23).

By not allowing the corresponding value of Conditional Expression (23) to be equal to or less than the lower limit, the reduction in the total length of the optical system at the telephoto end is facilitated, and thus an advantage in the size reduction is achieved. By not allowing the corresponding value of Conditional Expression (23) to be equal to or more than the upper limit, an advantage in suppressing the spherical aberration at the telephoto end is achieved.

$$2 < ft / fRt < 8 \qquad ( 23 )$$

In order to obtain more favorable characteristics, it is preferable to set the lower limit of Conditional Expression (23) to any of 2.3 or 2.5 instead of 2. In addition, it is preferable to set the upper limit of Conditional Expression (23) to any of 7 or 6.5 instead of 8.

In a case in which a sum of central thicknesses of all lenses in the front group GF is denoted by dFsum, it is preferable that the variable magnification optical system satisfies Conditional Expression (24). By not allowing the corresponding value of Conditional Expression (24) to be equal to or less than the lower limit, ensuring of the mechanical strength of the front group GF is facilitated. By not allowing the corresponding value of Conditional Expression (24) to be equal to or more than the upper limit, an advantage in weight reduction in the front group GF is achieved.

$$0.2 < dFsum / ( ft / FNot ) < 0.6 \qquad ( 24 )$$

In order to obtain more favorable characteristics, it is preferable to set the lower limit of Conditional Expression (24) to any of 0.23 or 0.25 instead of 0.2. In addition, it is preferable to set the upper limit of Conditional Expression (24) to any of 0.55 or 0.5 instead of 0.6.

In the configuration in which the variable magnification optical system includes the aperture stop St, it is preferable that the variable magnification optical system satisfies Conditional Expression (25). Here, a composite focal length from a lens of the front group GF closest to the object side to the aperture stop St in a state in which the infinite distance object is in focus at the wide angle end is denoted by fL1STw. By not allowing the corresponding value of Conditional Expression (25) to be equal to or less than the lower limit, the refractive power of the front group GF is prevented from being excessively strong, so that an advantage in suppressing fluctuations of aberrations during magnification change is achieved. By not allowing the corresponding value of Conditional Expression (25) to be equal to or more than the upper limit, the refractive power of the front group GF is prevented from being excessively weak, so that an advantage in reducing the size of the front group GF is achieved.

$$0.2 < fF 1 / fL 1 < 5 \qquad ( 25 )$$

In order to obtain more favorable characteristics, it is preferable to set the lower limit of Conditional Expression (25) to any of 0.33 or 0.45 instead of 0.2. In addition, it is preferable to set the upper limit of Conditional Expression (25) to any of 4.5 or 4 instead of 5.

In the configuration in which the variable magnification optical system includes the aperture stop St, it is preferable that the variable magnification optical system satisfies Conditional Expression (26). By not allowing the corresponding value of Conditional Expression (26) to be equal to or less than the lower limit, an advantage in suppressing various aberrations is achieved. By not allowing the corresponding value of Conditional Expression (26) to be equal to or more than the upper limit, an advantage in ensuring the wide angle of view at the wide angle end is achieved.

$$0.2 < fw / fL 1 STw < 2.8 \qquad ( 26 )$$

In order to obtain more favorable characteristics, it is preferable to set the lower limit of Conditional Expression (26) to any of 0.25 or 0.3 instead of 0.2. In addition, it is preferable to set the upper limit of Conditional Expression (26) to any of 2.5 or 2.3 instead of 2.8.

It is preferable that the variable magnification optical system satisfies Conditional Expression (27). Here, a lateral magnification of the intermediate group GM in a state in which the infinite distance object is in focus at the telephoto end is denoted by βMt. A lateral magnification of the intermediate group GM in a state in which the infinite distance object is in focus at the wide angle end is denoted by βMw. By not allowing the corresponding value of Conditional Expression (27) to be equal to or less than the lower limit, an advantage in achieving a high magnification change ratio is achieved. By not allowing the corresponding value of Conditional Expression (27) to be equal to or more than the upper limit, an advantage in suppressing fluctuation of the aberrations during magnification change is achieved.

$$1.4 < β Mt / β Mw < 4.5 \qquad ( 27 )$$

In order to obtain more favorable characteristics, it is preferable to set the lower limit of Conditional Expression (27) to any of 1.6 or 1.8 instead of 1.4. In addition, it is preferable to set the upper limit of Conditional Expression (27) to any of 4 or 3.7 instead of 4.5.

In a case in which a focal length of the first subsequent lens group GR1 is denoted by fR1, it is preferable that the variable magnification optical system satisfies Conditional Expression (28). By not allowing the corresponding value of Conditional Expression (28) to be equal to or less than the lower limit, the refractive power of the first subsequent lens group GR1 is prevented from being excessively strong, so that an advantage in suppressing fluctuations of aberrations during magnification change is achieved. By not allowing the corresponding value of Conditional Expression (28) to be equal to or more than the upper limit, the refractive power of the first subsequent lens group GR1 is prevented from being excessively weak, and thus an advantage in the size reduction is achieved.

$$0.2 < fR 1 / {( fw \times f t )}^{1 / 2} < 1.4 \qquad ( 28 )$$

In order to obtain more favorable characteristics, it is preferable to set the lower limit of Conditional Expression (28) to any of 0.23 or 0.25 instead of 0.2. In addition, it is preferable to set the upper limit of Conditional Expression (28) to any of 1.2 or 1 instead of 1.4.

It is preferable that the variable magnification optical system satisfies Conditional Expression (29). Here, an effective diameter of a lens surface of the front group GF closest to the object side is denoted by EDf. An effective diameter of a lens surface of the subsequent group GR closest to the image side is denoted by EDr. In general, in order to reduce the diameter of the lens closest to the object side, the refractive power of the front group GF is increased, and in a case in which the refractive power of the front group GF is increased, fluctuation in aberrations during magnification change tends to be large. From such circumstances, by not allowing the corresponding value of Conditional Expression (29) to be equal to or less than the lower limit, the diameter of the lens closest to the object side is prevented from being excessively reduced, so that the refractive power of the front group GF is prevented from being excessively strong, and thus an advantage in suppressing fluctuation of the aberrations during magnification change is achieved. Alternatively, by not allowing the corresponding value of Conditional Expression (29) to be equal to or less than the lower limit, the diameter of the lens closest to the object side is prevented from being excessively reduced, so that an advantage in ensuring a ratio of the edge part light quantity at a maximum image height is achieved. By not allowing the corresponding value of Conditional Expression (29) to be equal to or more than the upper limit, the size increase in the lens closest to the object side can be suppressed, and thus the size reduction is facilitated.

$$1.2 < EDf / EDr < 2.4 \qquad ( 29 )$$

In order to obtain more favorable characteristics, it is preferable to set the lower limit of Conditional Expression (29) to any of 1.3 or 1.4 instead of 1.2. In addition, it is preferable to set the upper limit of Conditional Expression (29) to any of 2.2 or 2.1 instead of 2.4.

It should be noted that, in the present specification, the “effective diameter” of the lens surface is twice a distance from an intersection between the lens surface and a ray passing through the outermost side of the lens surface, among rays that are incident on a lens surface from the object side and that are emitted to the image side, to the optical axis Z. The term “outer side” means an outer side in a radial direction centered on the optical axis Z, that is, a side away from the optical axis Z. The “ray passing through the outermost side” is determined by considering the entire magnification change range.

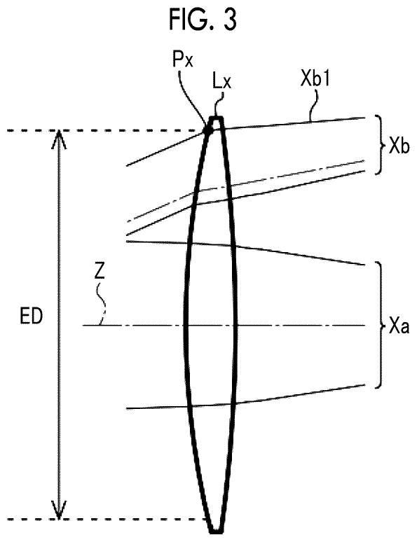

FIG. 3 shows an example of an effective diameter ED as a diagram for description. In FIG. 3, a left side is the object side, and a right side is the image side. FIG. 3 shows an on-axis luminous flux Xa and an off-axis luminous flux Xb that pass through a lens Lx. In the example in FIG. 3, a ray Xb1 that is an upper ray of the off-axis luminous flux Xb is the ray passing through the outermost side. Thus, in the example in FIG. 3, the effective diameter ED of the surface of the lens Lx on the object side is twice a distance from an intersection between a surface of the lens Lx on the object side and the ray Xb1 to the optical axis Z. In addition, a position of the intersection between the ray passing through the outermost side and the lens surface is a position Px of the maximum effective diameter. It should be noted that the upper ray of the off-axis luminous flux Xb is the ray passing through the outermost side in the example in FIG. 3, but which ray is the ray passing through the outermost side varies depending on the optical system.

It is preferable that the variable magnification optical system satisfies Conditional Expression (30). By not allowing the corresponding value of Conditional Expression (30) to be equal to or less than the lower limit, the positive refractive power of the first subsequent lens group GR1 is prevented from being excessively weak, so that an advantage in suppressing fluctuations of spherical aberration during magnification change is achieved. By not allowing the corresponding value of Conditional Expression (30) to be equal to or more than the upper limit, the positive refractive power of the first subsequent lens group GR1 is prevented from being excessively strong, so that it is possible to suppress the spherical aberration from being excessively corrected, particularly at the wide angle end.

$$0.4 < fw / fR 1 < 4 \qquad ( 30 )$$

In order to obtain more favorable characteristics, it is preferable to set the lower limit of Conditional Expression (30) to any of 0.5 or 0.6 instead of 0.4. In addition, it is preferable to set the upper limit of Conditional Expression (30) to any of 3 or 2.5 instead of 4.

In the configuration in which the anti-vibration group Gois that moves in a direction intersecting with the optical axis Z during image shake correction is disposed closer to the image side than the front group GF, it is preferable that the variable magnification optical system satisfies Conditional Expression (31). Here, a focal length of the anti-vibration group Gois is denoted by fIS. By not allowing the corresponding value of Conditional Expression (31) to be equal to or less than the lower limit, an advantage in reduction in the total length of the optical system is achieved. By not allowing the corresponding value of Conditional Expression (31) to be equal to or more than the upper limit, the refractive power of the anti-vibration group Gois can be ensured, so that it is easy to suppress the movement amount of the anti-vibration group Gois during image shake correction, and thus there is an advantage in achieving reduction in size.

$$0.2 < \vert fIS / ft \vert < 2 \qquad ( 31 )$$

In order to obtain more favorable characteristics, it is preferable to set the lower limit of Conditional Expression (31) to any of 0.3 or 0.4 instead of 0.2. In addition, it is preferable to set the upper limit of Conditional Expression (31) to any of 1.7 or 1.5 instead of 2.

In the configuration in which the front group GF includes the cemented lens in which the negative meniscus lens having the convex surface facing the object side and the positive lens having the convex surface facing the object side are cemented in order from the object side, it is preferable that the variable magnification optical system satisfies Conditional Expression (32). Here, a refractive index of the negative meniscus lens included in the front group GF at the d line is denoted by Ndn. An abbe number of the negative meniscus lens included in the front group GF based on the d line is denoted by vdn. By not allowing the corresponding value of Conditional Expression (32) to be equal to or less than the lower limit, a material other than a material having a low refractive index and a small Abbe number can be selected, so that the correction of the lateral chromatic aberration at the wide angle end is facilitated. By not allowing the corresponding value of Conditional Expression (32) to be equal to or more than the upper limit, a material other than a material having a high refractive index and a large Abbe number can be selected, so that a material not having a high specific gravity can be selected, and weight reduction is facilitated. Alternatively, since a difference between Abbe numbers of the positive lens and the negative lens constituting the front group GF is not excessively decreased, the refractive power of each lens constituting the front group GF is not increased. As a result, the correction of the high-order aberrations of the spherical aberration at the telephoto end is facilitated. It should be noted that, in the present specification, the term “high-order” related to aberrations means a fifth order or higher.

$$1.6 < Ndn + 0.01 \times ν dn < 3 \qquad ( 32 )$$

In order to obtain more favorable characteristics, it is preferable to set the lower limit of Conditional Expression (32) to any of 1.8 or 2 instead of 1.6. In addition, it is preferable to set the upper limit of Conditional Expression (32) to any of 2.5 or 2.3 instead of 3.

In the configuration in which the front group GF includes the cemented lens in which the negative meniscus lens having the convex surface facing the object side and the positive lens having the convex surface facing the object side are cemented in order from the object side, it is preferable that the variable magnification optical system satisfies Conditional Expression (33). Here, a refractive index of the positive lens included in the front group GF at the d line is denoted by Ndp. An abbe number of the positive lens included in the front group GF based on the d line is denoted by vdp. By not allowing the corresponding value of Conditional Expression (33) to be equal to or less than the lower limit, a material other than a material having a low refractive index and a low Abbe number can be selected, so that an increase in high-order aberrations of the spherical aberration at the telephoto end can be suppressed, and thus it is easy to achieve high performance. Alternatively, insufficient correction of the axial chromatic aberration at the telephoto end can be suppressed. By not allowing the corresponding value of Conditional Expression (33) to be equal to or more than the upper limit, a material other than a material having a high refractive index and a large Abbe number can be selected, so that a material not having a high specific gravity can be selected, and weight reduction is facilitated. Alternatively, excessive correction of the axial chromatic aberration at the telephoto end can be suppressed.

$$1.8 < Ndp + 0.01 \times ν dp < 2.6 \qquad ( 33 )$$

In order to obtain more favorable characteristics, it is preferable to set the lower limit of Conditional Expression (33) to any of 2 or 2.2 instead of 1.8. In addition, it is preferable to set the upper limit of Conditional Expression (33) to any of 2.5 or 2.4 instead of 2.6.

In the configuration in which the subsequent group GR includes the aspherical lens having a negative refractive power and having the concave surface facing the object side, it is preferable that the variable magnification optical system satisfies Conditional Expression (34) for the aspherical lens. Here, a paraxial curvature radius of a surface of the aspherical lens on the object side is denoted by Rcnf. A paraxial curvature radius of a surface of the aspherical lens on the image side is denoted by Rcnr. A curvature radius of the surface of the aspherical lens on the object side at a position of the maximum effective diameter is denoted by Rynf A curvature radius of the surface of the aspherical lens on the image side at a position of the maximum effective diameter is denoted by Rynr. By not allowing the corresponding value of Conditional Expression (34) to be equal to or less than the lower limit, the negative refractive power on the peripheral side of the lens is prevented from being excessively strong, so that it is possible to suppress excessive correction of the field curvature. By not allowing the corresponding value of Conditional Expression (34) to be equal to or more than the upper limit, the negative refractive power on the peripheral side of the lens is prevented from being excessively weak, so that there is an advantage in correcting field curvature.

$$0.1 < ( 1 / Rcnf - 1 / Rcnr ) / ( 1 / Rynf - 1 / Rynr ) < 4.5 \qquad ( 34 )$$

In order to obtain more favorable characteristics, it is preferable to set the lower limit of Conditional Expression (34) to any of 0.3 or 0.5 instead of 0.1. In addition, it is preferable to set the upper limit of Conditional Expression (34) to any of 3.5 or 2.8 instead of 4.5.

In a case in which an average value of Abbe numbers of all positive lenses in the front group GF based on the d line is denoted by vdFp_ave, it is preferable that the variable magnification optical system satisfies Conditional Expression (35). By not allowing the corresponding value of Conditional Expression (35) to be equal to or less than the lower limit, an advantage in correcting the axial chromatic aberration particularly at the telephoto end is achieved. By not allowing the corresponding value of Conditional Expression (35) to be equal to or more than the upper limit, an advantage in correcting various aberrations other than a chromatic aberration is achieved.

$$20 < ν dFp\_ave < 95 \qquad ( 35 )$$

In order to obtain more favorable characteristics, it is preferable to set the lower limit of Conditional Expression (35) to any of 40 or 60 instead of 20. In addition, it is preferable to set the upper limit of Conditional Expression (35) to any of 90 or 88.5 instead of 95.

It is preferable that the variable magnification optical system satisfies Conditional Expression (36). Here, a thickness, on the optical axis, of the lens group of the front group GF closest to the object side is denoted by dF1. An effective diameter of a lens surface of the front group GF closest to the object side is denoted by EDf. As an example, FIG. 2 shows the thickness dF1. By not allowing the corresponding value of Conditional Expression (36) to be equal to or less than the lower limit, an advantage in ensuring strength of the lens group of the front group GF closest to the object side is achieved. By not allowing the corresponding value of Conditional Expression (36) to be equal to or more than the upper limit, an advantage in weight reduction in the front group GF is achieved.

$$0.1 < dF 1 / EDf < 0.6 \qquad ( 36 )$$

In order to obtain more favorable characteristics, it is preferable to set the lower limit of Conditional Expression (36) to any of 0.2 or 0.25 instead of 0.1. In addition, it is preferable to set the upper limit of Conditional Expression (36) to any of 0.5 or 0.45 instead of 0.6.

It is preferable that the variable magnification optical system satisfies Conditional Expression (37). By not allowing the corresponding value of Conditional Expression (37) to be equal to or less than the lower limit, an advantage in ensuring strength of the lens group of the front group GF closest to the object side is achieved. By not allowing the corresponding value of Conditional Expression (37) to be equal to or more than the upper limit, an advantage in weight reduction in the front group GF is achieved.

$$0.3 < dF 1 / ( Denw \times tan ω w ) < 1.6 \qquad ( 37 )$$

In order to obtain more favorable characteristics, it is preferable to set the lower limit of Conditional Expression (37) to any of 0.4 or 0.5 instead of 0.3. In addition, it is preferable to set the upper limit of Conditional Expression (37) to any of 1.4 or 1.2 instead of 1.6.

In a case in which the focal length of the lens group of the front group GF closest to the object side is denoted by fF1, it is preferable that the variable magnification optical system satisfies Conditional Expression (38). By not allowing the corresponding value of Conditional Expression (38) to be equal to or less than the lower limit, an advantage in ensuring strength of the lens group of the front group GF closest to the object side is achieved. By not allowing the corresponding value of Conditional Expression (38) to be equal to or more than the upper limit, an advantage in weight reduction in the front group GF is achieved.

$$0.03 < dF 1 / fF 1 < 0.4 \qquad ( 38 )$$

In order to obtain more favorable characteristics, it is preferable to set the lower limit of Conditional Expression (38) to any of 0.04 or 0.05 instead of 0.03. In addition, it is preferable to set the upper limit of Conditional Expression (38) to any of 0.3 or 0.25 instead of 0.4.

In a case in which an average value of specific gravities of all lenses in the front group GF is denoted by GFave, it is preferable that the variable magnification optical system satisfies Conditional Expression (39). By not allowing the corresponding value of Conditional Expression (39) to be equal to or less than the lower limit, it is possible to use a material having high availability, so that there is an advantage in realizing a variable magnification optical system in which spherical aberration and axial chromatic aberration are suppressed. By not allowing the corresponding value of Conditional Expression (39) to be equal to or more than the upper limit, an advantage in weight reduction in the front group GF is achieved.

$$2 < GFave < 5 \qquad ( 39 )$$

In order to obtain more favorable characteristics, it is preferable to set the lower limit of Conditional Expression (39) to any of 2.5 or 3 instead of 2. In addition, it is preferable to set the upper limit of Conditional Expression (39) to any of 4.5 or 4 instead of 5.

It is preferable that the variable magnification optical system includes an Lp lens that is a positive lens satisfying Conditional Expressions (40), (41), (42), and (43). Here, a refractive index of the Lp lens at the d line is denoted by NLp. An Abbe number of the Lp lens based on the d line is denoted by vLp. A partial dispersion ratio of the Lp lens between the g line and the F line is denoted by θLp.

$$0.005 < NLp - ( 2.015 - 0.0068 \times ν Lp ) < 0.15 \qquad ( 40 )$$

$$49.8 < ν Lp < 65 \qquad ( 41 )$$

$$0.543 < θ Lp < 0.58 \qquad ( 42 )$$

$$- 0. 11 < θ Lp - ( 0.6 \; 418 - 0.00168 \times ν Lp ) < 0 \qquad ( 43 )$$

By not allowing the corresponding value of Conditional Expression (40) to be equal to or less than the lower limit, the correction of the chromatic aberration is facilitated. By not allowing the corresponding value of Conditional Expression (40) to be equal to or more than the upper limit, it is easy to satisfactorily perform correction of spherical aberration and correction of chromatic aberration at the same time.

In order to obtain more favorable characteristics, it is preferable to set the lower limit of Conditional Expression (40) to any of 0.02, 0.03, 0.04, or 0.05 instead of 0.005. In addition, it is preferable to set the upper limit of Conditional Expression (40) to any of 0.14, 0.13, 0.12, or 0.116 instead of 0.15.

By not allowing the corresponding value of Conditional Expression (41) to be equal to or less than the lower limit, the correction of the chromatic aberration is facilitated. By not allowing the corresponding value of Conditional Expression (41) to be equal to or more than the upper limit, a material having high availability can be used, and thus it is possible to achieve favorable correction of various aberrations other than the chromatic aberration.

In order to obtain more favorable characteristics, it is preferable to set the lower limit of Conditional Expression (41) to any of 50.1 or 50.2 instead of 49.8. In addition, it is preferable to set the upper limit of Conditional Expression (41) to any of 63 or 59 instead of 65.

By not allowing the corresponding value of Conditional Expression (42) to be equal to or less than the lower limit, the correction of the chromatic aberration is facilitated. By not allowing the corresponding value of Conditional Expression (42) to be equal to or more than the upper limit, a material having high availability can be used, and thus it is possible to achieve favorable correction of various aberrations other than the chromatic aberration.

In order to obtain more favorable characteristics, it is preferable to set the lower limit of Conditional Expression (42) to any of 0.544 or 0.5445 instead of 0.543. In addition, it is preferable to set the upper limit of Conditional Expression (42) to any of 0.57 or 0.563 instead of 0.58.

By not allowing the corresponding value of Conditional Expression (43) to be equal to or less than the lower limit, the correction of the chromatic aberration is facilitated. By not allowing the corresponding value of Conditional Expression (43) to be equal to or more than the upper limit, a material having high availability can be used, and thus it is possible to achieve favorable correction of various aberrations other than the chromatic aberration.

In order to obtain more favorable characteristics, it is preferable to set the lower limit of Conditional Expression (43) to any of −0.01, −0.009, or −0.008 instead of −0.011. In addition, it is preferable to set the upper limit of Conditional Expression (43) to any of −0.001, −0.002, or −0.003 instead of 0.

It should be noted that the example shown in FIG. 1 is merely an example, and various modifications can be made without departing from the gist of the technology of the present disclosure. For example, the number of lens groups included in each group of the front group GF, the intermediate group GM, and the subsequent group GR, the number of lenses included in each lens group, the number of lenses included in the focusing group Gf, and the number of lenses included in the anti-vibration group Gois may be different from the numbers in the example of FIG. 1.

The front group GF may be configured to consist of two lens groups. In such a case, an advantage of suppressing fluctuations of aberrations during magnification change is achieved.

The intermediate group GM may be configured to consist of two lens groups. In such a case, an advantage of suppressing fluctuations of aberrations during magnification change is achieved.

During magnification change, three or more lens groups in the subsequent group GR may be configured to move by changing the spacings between the adjacent lens groups. In such a case, an advantage of suppressing fluctuations of aberrations during magnification change is achieved.

It is preferable that at least one lens group among the lens groups that move during magnification change in the subsequent group GR has a negative refractive power. In such a case, an advantage of suppressing fluctuations of aberrations during magnification change is achieved.

The subsequent group GR may be configured to consist of, in order from the object side to the image side, the first subsequent lens group GR1 having a positive refractive power, the second subsequent lens group GR2 having a negative refractive power, and the third subsequent lens group GR3. By limiting the number of lens groups included in the subsequent group GR to three in this way, it is easy to reduce the total length.

In the configuration in which the subsequent group GR consists of, in order from the object side to the image side, the first subsequent lens group GR1 having a positive refractive power, the second subsequent lens group GR2 having a negative refractive power, and the third subsequent lens group GR3, the variable magnification optical system preferably satisfies at least one of Conditional Expression (44) or (45). Here, the focal length of the first subsequent lens group GR1 is denoted by fR1. A focal length of the second subsequent lens group GR2 is denoted by fR2. A focal length of the third subsequent lens group GR3 is denoted by fR3.

$$- 1 < fR 1 / fR 3 < 0.7 \qquad ( 44 )$$

$$0.4 < fR 1 / ( - fR 2 ) < 1.8 \qquad ( 45 )$$

By not allowing the corresponding value of Conditional Expression (44) to be equal to or less than the lower limit, the refractive power of the first subsequent lens group GR1 is prevented from being excessively weak, so that an advantage in correcting the spherical aberration at the telephoto end is achieved. By not allowing the corresponding value of Conditional Expression (44) to be equal to or more than the upper limit, the positive refractive power of the third subsequent lens group GR3 is prevented from being excessively strong, so that there is an advantage in ensuring the back focus having an appropriate length.

In order to obtain more favorable characteristics, it is preferable to set the lower limit of Conditional Expression (44) to any of −0.9, −0.8, −0.6, or −0.5 instead of −1. In addition, it is preferable to set the upper limit of Conditional Expression (44) to any of 0.6, 0.5, 0.4, or 0.3 instead of 0.7.

By not allowing the corresponding value of Conditional Expression (45) to be equal to or less than the lower limit, the refractive power of the second subsequent lens group GR2 is prevented from being excessively weak, so that an advantage in suppressing fluctuations of aberrations during magnification change is achieved. By not allowing the corresponding value of Conditional Expression (45) to be equal to or more than the upper limit, the refractive power of the first subsequent lens group GR1 is prevented from being excessively weak, so that an advantage in suppressing the spherical aberration at the telephoto end is achieved.

In order to obtain more favorable characteristics, it is preferable to set the lower limit of Conditional Expression (45) to any of 0.45, 0.5, 0.55, or 0.6 instead of 0.4. In addition, it is preferable to set the upper limit of Conditional Expression (45) to any of 1.7, 1.6, 1.5, or 1.4 instead of 1.8.

The subsequent group GR may be configured to consist of, in order from the object side to the image side, the first subsequent lens group GR1 having a positive refractive power, the second subsequent lens group GR2 having a positive refractive power, and the third subsequent lens group GR3 having a negative refractive power. By limiting the number of lens groups included in the subsequent group GR to three in this way, it is easy to reduce the total length.

In the configuration in which the subsequent group GR consists of, in order from the object side to the image side, the first subsequent lens group GR1 having a positive refractive power, the second subsequent lens group GR2 having a positive refractive power, and the third subsequent lens group GR3 having a negative refractive power, the variable magnification optical system preferably satisfies at least one of Conditional Expression (46) or (47). Here, the focal length of the first subsequent lens group GR1 is denoted by fR1. The focal length of the second subsequent lens group GR2 is denoted by fR2. The focal length of the third subsequent lens group GR3 is denoted by fR3.

$$0.6 < fR 1 / ( - fR 3 ) < 1.9 \qquad ( 46 )$$

$$1.6 < fR 2 / ( - fR 3 ) < 3 \qquad ( 47 )$$

By not allowing the corresponding value of Conditional Expression (46) to be equal to or less than the lower limit, the refractive power of the third subsequent lens group GR3 is prevented from being excessively weak, so that an advantage in suppressing fluctuations of aberrations during magnification change is achieved. By not allowing the corresponding value of Conditional Expression (46) to be equal to or more than the upper limit, the refractive power of the first subsequent lens group GR1 is prevented from being excessively weak, so that an advantage in suppressing the spherical aberration at the telephoto end is achieved.

In order to obtain more favorable characteristics, it is preferable to set the lower limit of Conditional Expression (46) to any of 0.7, 0.8, 0.9, or 1 instead of 0.6. In addition, it is preferable to set the upper limit of Conditional Expression (46) to any of 1.8, 1.7, 1.6, or 1.5 instead of 1.9.

By not allowing the corresponding value of Conditional Expression (47) to be equal to or less than the lower limit, the refractive power of the third subsequent lens group GR3 is prevented from being excessively weak, so that an advantage in suppressing fluctuations of aberrations during magnification change is achieved. By not allowing the corresponding value of Conditional Expression (47) to be equal to or more than the upper limit, the refractive power of the second subsequent lens group GR2 is prevented from being excessively weak, so that an advantage in suppressing the spherical aberration at the telephoto end is achieved.

In order to obtain more favorable characteristics, it is preferable to set the lower limit of Conditional Expression (47) to any of 1.7, 1.8, 1.9, or 2 instead of 1.6. In addition, it is preferable to set the upper limit of Conditional Expression (47) to any of 2.9, 2.8, 2.7, or 2.6 instead of 3.

The subsequent group GR may be configured to consist of, in order from the object side to the image side, the first subsequent lens group GR1 having a positive refractive power, the second subsequent lens group GR2 having a positive refractive power, the third subsequent lens group GR3 having a negative refractive power, and a fourth subsequent lens group GR4. By limiting the number of lens groups included in the subsequent group GR to four in this way, it is easy to reduce the total length.

In the configuration in which the subsequent group GR consists of, in order from the object side to the image side, the first subsequent lens group GR1 having a positive refractive power, the second subsequent lens group GR2 having a positive refractive power, the third subsequent lens group GR3 having a negative refractive power, and the fourth subsequent lens group GR4, it is preferable that the variable magnification optical system satisfies at least one of Conditional Expression (46A), (47A), or (48A). Here, the focal length of the first subsequent lens group GR1 is denoted by fR1. The focal length of the second subsequent lens group GR2 is denoted by fR2. The focal length of the third subsequent lens group GR3 is denoted by fR3.

$$0.3 < fR 1 / ( - fR 3 ) < 2 \qquad ( 46 A )$$

$$0.4 < fR 2 / ( - fR 3 ) < 1.8 \qquad ( 47 A )$$

$$0.25 < fR 1 / fR 2 < 2.5 \qquad ( 48 A )$$

By not allowing the corresponding value of Conditional Expression (46A) to be equal to or less than the lower limit, the refractive power of the third subsequent lens group GR3 is prevented from being excessively weak, so that an advantage in suppressing fluctuations of aberrations during magnification change is achieved. By not allowing the corresponding value of Conditional Expression (46A) to be equal to or more than the upper limit, the refractive power of the first subsequent lens group GR1 is prevented from being excessively weak, so that an advantage in suppressing the spherical aberration at the telephoto end is achieved.

In order to obtain more favorable characteristics, it is preferable to set the lower limit of Conditional Expression (46A) to any of 0.35, 0.4, 0.45, or 0.5 instead of 0.3. In addition, it is preferable to set the upper limit of Conditional Expression (46A) to any of 1.65, 1.3, 1, or 0.8 instead of 2.

By not allowing the corresponding value of Conditional Expression (47A) to be equal to or less than the lower limit, the refractive power of the third subsequent lens group GR3 is prevented from being excessively weak, so that an advantage in suppressing fluctuations of aberrations during magnification change is achieved. By not allowing the corresponding value of Conditional Expression (47A) to be equal to or more than the upper limit, the refractive power of the second subsequent lens group GR2 is prevented from being excessively weak, so that an advantage in suppressing the spherical aberration at the telephoto end is achieved.

In order to obtain more favorable characteristics, it is preferable to set the lower limit of Conditional Expression (47A) to any of 0.5, 0.6, 0.7, or 0.8 instead of 0.4. In addition, it is preferable to set the upper limit of Conditional Expression (47A) to any of 1.7, 1.6, 1.5, or 1.4 instead of 1.8.

By not allowing the corresponding value of Conditional Expression (48A) to be equal to or less than the lower limit, the refractive power of the second subsequent lens group GR2 is prevented from being excessively weak, so that an advantage in correcting the spherical aberration at the telephoto end is achieved. By not allowing the corresponding value of Conditional Expression (48A) to be equal to or more than the upper limit, the refractive power of the first subsequent lens group GR1 is prevented from being excessively weak, so that an advantage in suppressing fluctuations of aberrations during magnification change is achieved.

In order to obtain more favorable characteristics, it is preferable to set the lower limit of Conditional Expression (48A) to any of 0.3, 0.35, 0.38, or 0.4 instead of 0.25. In addition, it is preferable to set the upper limit of Conditional Expression (48A) to any of 2, 1.5, 1, or 0.8 instead of 2.5.

The subsequent group GR may be configured to consist of, in order from the object side to the image side, the first subsequent lens group GR1 having a positive refractive power, the second subsequent lens group GR2 having a positive refractive power, the third subsequent lens group GR3 having a negative refractive power, the fourth subsequent lens group GR4, and a fifth subsequent lens group GR5. By setting the number of lens groups included in the subsequent group GR to five in this way, it is easy to suppress fluctuation in aberrations during magnification change.

In the configuration in which the subsequent group GR consists of, in order from the object side to the image side, the first subsequent lens group GR1 having a positive refractive power, the second subsequent lens group GR2 having a positive refractive power, the third subsequent lens group GR3 having a negative refractive power, the fourth subsequent lens group GR4, and the fifth subsequent lens group GR5, it is preferable that the variable magnification optical system satisfies at least one of Conditional Expression (47B) or (48B). Here, the focal length of the first subsequent lens group GR1 is denoted by fR1. The focal length of the second subsequent lens group GR2 is denoted by fR2. The focal length of the third subsequent lens group GR3 is denoted by fR3.

$$0.3 < fR 2 / ( - fR 3 ) < 1.7 \qquad ( 47 B )$$

$$0.4 < fR 1 / fR 2 < 1.3 \qquad ( 48 B )$$

By not allowing the corresponding value of Conditional Expression (47B) to be equal to or less than the lower limit, the refractive power of the third subsequent lens group GR3 is prevented from being excessively weak, so that an advantage in suppressing fluctuations of aberrations during magnification change is achieved. By not allowing the corresponding value of Conditional Expression (47B) to be equal to or more than the upper limit, the refractive power of the second subsequent lens group GR2 is prevented from being excessively weak, so that an advantage in suppressing the spherical aberration at the telephoto end is achieved.

In order to obtain more favorable characteristics, it is preferable to set the lower limit of Conditional Expression (47B) to any of 0.35, 0.4, 0.45, or 0.5 instead of 0.3. In addition, it is preferable to set the upper limit of Conditional Expression (47B) to any of 1.5, 1.3, 1.1, or 1 instead of 1.7.

By not allowing the corresponding value of Conditional Expression (48B) to be equal to or less than the lower limit, the refractive power of the second subsequent lens group GR2 is prevented from being excessively weak, so that an advantage in correcting the spherical aberration at the telephoto end is achieved. By not allowing the corresponding value of Conditional Expression (48B) to be equal to or more than the upper limit, the refractive power of the first subsequent lens group GR1 is prevented from being excessively weak, so that an advantage in suppressing fluctuations of aberrations during magnification change is achieved.

In order to obtain more favorable characteristics, it is preferable to set the lower limit of Conditional Expression (48B) to any of 0.45, 0.5, 0.55, or 0.6 instead of 0.4. In addition, it is preferable to set the upper limit of Conditional Expression (48B) to any of 1.2, 1.1, 1, or 0.9 instead of 1.3.

The subsequent group GR may be configured to consist of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4. By limiting the number of lens groups included in the subsequent group GR to four in this way, it is easy to reduce the total length.

In the configuration in which the subsequent group GR consists of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4, it is preferable that the variable magnification optical system satisfies at least one of Conditional Expression (44C) or (45C). Here, the focal length of the first subsequent lens group GR1 is denoted by fR1. The focal length of the second subsequent lens group GR2 is denoted by fR2. The focal length of the third subsequent lens group GR3 is denoted by fR3.

$$0.19 < fR 1 / fR 3 < 1.5 \qquad ( 44 C )$$

$$0.2 < fR 1 / ( - fR 2 ) < 1.6 \qquad ( 45 C )$$

By not allowing the corresponding value of Conditional Expression (44C) to be equal to or less than the lower limit, the refractive power of the first subsequent lens group GR1 is prevented from being excessively strong, so that it is possible to suppress the spherical aberration from being excessively corrected, at the telephoto end. By not allowing the corresponding value of Conditional Expression (44C) to be equal to or more than the upper limit, the refractive power of the first subsequent lens group GR1 is prevented from being excessively weak, so that an advantage in suppressing the spherical aberration at the telephoto end is achieved.

In order to obtain more favorable characteristics, it is preferable to set the lower limit of Conditional Expression (44C) to any of 0.22, 0.25, 0.28, or 0.3 instead of 0.19. In addition, it is preferable to set the upper limit of Conditional Expression (44C) to any of 1.2, 0.9, 0.8, or 0.7 instead of 1.5.

By not allowing the corresponding value of Conditional Expression (45C) to be equal to or less than the lower limit, the refractive power of the second subsequent lens group GR2 is prevented from being excessively weak, so that an advantage in suppressing fluctuations of aberrations during magnification change is achieved. By not allowing the corresponding value of Conditional Expression (45C) to be equal to or more than the upper limit, the refractive power of the first subsequent lens group GR1 is prevented from being excessively weak, so that an advantage in suppressing the spherical aberration at the telephoto end is achieved.

In order to obtain more favorable characteristics, it is preferable to set the lower limit of Conditional Expression (45C) to any of 0.3, 0.4, 0.45, or 0.5 instead of 0.2. In addition, it is preferable to set the upper limit of Conditional Expression (45C) to any of 1.4, 1.2, 1, or 0.9 instead of 1.6.

The subsequent group GR may be configured to consist of, in order from the object side to the image side, the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, the fifth subsequent lens group GR5, and a sixth subsequent lens group GR6. By setting the number of lens groups included in the subsequent group GR to six in this way, it is easy to suppress fluctuation in aberrations during magnification change.

In the configuration in which the subsequent group GR consists of, in order from the object side to the image side, the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, the fifth subsequent lens group GR5, and the sixth subsequent lens group GR6, it is preferable that the variable magnification optical system satisfies at least one of Conditional Expression (48D), (49D), or (50D).

Here, the focal length of the first subsequent lens group GR1 is denoted by fR1. The focal length of the second subsequent lens group GR2 is denoted by fR2. The focal length of the third subsequent lens group GR3 is denoted by fR3. A focal length of the fourth subsequent lens group GR4 is denoted by fR4.

$$1.2 < fR 1 / fR 2 < 2.5 \qquad ( 48 D )$$

$$0.3 < fR 2 / fR 3 < 1 \qquad ( 49 D )$$

$$1.2 < fR 3 / ( - fR 4 ) < 2.5 . \qquad ( 50 D )$$

By not allowing the corresponding value of Conditional Expression (48D) to be equal to or less than the lower limit, the refractive power of the second subsequent lens group GR2 is prevented from being excessively weak, so that an advantage in correcting the spherical aberration at the telephoto end is achieved. By not allowing the corresponding value of Conditional Expression (48D) to be equal to or more than the upper limit, the refractive power of the first subsequent lens group GR1 is prevented from being excessively weak, so that an advantage in suppressing fluctuations of aberrations during magnification change is achieved.

In order to obtain more favorable characteristics, it is preferable to set the lower limit of Conditional Expression (48D) to any of 1.4, 1.6, 1.7, or 1.75 instead of 1.2. In addition, it is preferable to set the upper limit of Conditional Expression (48D) to any of 2.3, 2.1, 2, or 1.95 instead of 2.5.

By not allowing the corresponding value of Conditional Expression (49D) to be equal to or less than the lower limit, the refractive power of the third subsequent lens group GR3 is prevented from being excessively weak, so that an advantage in correcting the spherical aberration at the telephoto end is achieved. By not allowing the corresponding value of Conditional Expression (49D) to be equal to or more than the upper limit, the refractive power of the second subsequent lens group GR2 is prevented from being excessively weak, so that an advantage in suppressing fluctuations of aberrations during magnification change is achieved.

In order to obtain more favorable characteristics, it is preferable to set the lower limit of Conditional Expression (49D) to any of 0.4, 0.5, 0.55, or 0.6 instead of 0.3. In addition, it is preferable to set the upper limit of Conditional Expression (49D) to any of 0.9, 0.8, 0.75, and 0.7 instead of 1.

By not allowing the corresponding value of Conditional Expression (50D) to be equal to or less than the lower limit, the refractive power of the fourth subsequent lens group GR4 is prevented from being excessively weak, so that an advantage in suppressing fluctuations of aberrations during magnification change is achieved. By not allowing the corresponding value of Conditional Expression (50D) to be equal to or more than the upper limit, the refractive power of the third subsequent lens group GR3 is prevented from being excessively weak, so that an advantage in suppressing the spherical aberration at the telephoto end is achieved.

In order to obtain more favorable characteristics, it is preferable to set the lower limit of Conditional Expression (50D) to any of 1.4, 1.6, 1.7, or 1.75 instead of 1.2. In addition, it is preferable to set the upper limit of Conditional Expression (50D) to any of 2.3, 2.1, 2, or 1.95 instead of 2.5.

The variable magnification optical system may be configured to include two focusing groups. In such a case, the movement amount of each focusing group can be suppressed, which is advantageous for high-speed focusing. In a case in which the variable magnification optical system includes two focusing groups, the two focusing groups may be configured to have refractive powers with different signs. In such a case, an advantage of suppressing fluctuations of aberrations during focusing is achieved.

One focusing group may be configured to consist of one or two lenses. In such a case, it is easy to reduce the size and weight of the focusing group, and thus there is an advantage in achieving high-speed focusing.

The variable magnification optical system according to the present disclosure may be a zoom lens or may be a varifocal lens.

The above-described preferable configurations and available configurations can be combined with each other in any manner, and are preferably employed as appropriate selectively in accordance with required specifications.

As an example, in a preferred aspect of the variable magnification optical system according to the present disclosure, the variable magnification optical system consists of, in order from the object side to the image side, the front group GF, the intermediate group GM, and the subsequent group GR, in which the front group GF consists of a lens group having a positive refractive power of two or less, the intermediate group GM consists of a lens group having a negative refractive power of two or less, the subsequent group GR consists of a plurality of lens groups, the lens group of the subsequent group GR closest to the object side is the first subsequent lens group GR1 having a positive refractive power, the two or fewer focusing groups Gf that move along the optical axis Z during focusing are disposed in the subsequent group GR, during magnification change, all the spacings between the adjacent lens groups are changed and the lens group of the front group GF closest to the object side is fixed with respect to the image plane Sim, and Conditional Expressions (1) and (2) are satisfied.

Next, examples of the variable magnification optical system according to the present disclosure will be described with reference to the accompanying drawings. It should be noted that reference numerals provided to the lenses in the cross-sectional view of each example are independently used for each example in order to avoid complication of description and the drawings caused by an increasing number of digits of the reference numerals. Therefore, even in a case in which a common reference numeral is provided in the drawings of different examples, the common reference numeral does not always indicate a common configuration.

### Example 1

A configuration and a movement trajectory of the variable magnification optical system according to Example 1 are shown in FIG. 1, and its showing method and its configuration are described above, and thus the duplicate description will be partially omitted here. The variable magnification optical system according to Example 1 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, and the third subsequent lens group GR3 having a negative refractive power.

During magnification change from the wide angle end to the telephoto end, the front group GF, the first subsequent lens group GR1, and the third subsequent lens group GR3 are fixed with respect to the image plane Sim, and the intermediate group GM and the second subsequent lens group GR2 move by changing the spacings between the adjacent lens groups. The variable magnification optical system according to Example 1 includes only one focusing group Gf. The focusing group Gf consists of the second subsequent lens group GR2. The anti-vibration group Gois consists of a fourth lens and a fifth lens of the first subsequent lens group GR1 from the object side.

For the variable magnification optical system according to Example 1, basic lens data is shown in Table 1, specifications and variable surface spacings are shown in Table 2, and aspherical coefficients are shown in Table 3.

The table of the basic lens data is described as below. The column of Sn shows surface numbers in a case in which the number is increased by one at a time toward the image side from a surface closest to the object side as a first surface. The column of R shows the curvature radius of each surface. The column of D shows the surface spacing, on the optical axis, between each surface and its adjacent surface on the image side. A column of Nd shows a refractive index at the d line for each constituent. The column of vd shows the Abbe number based on the d line for each constituent. A column of θgF shows a partial dispersion ratio between the g line and the F line for each constituent. The column of p shows the specific gravity of each constituent of the front group GF. In the left column of the row of the lenses corresponding to the front group GF, the intermediate group GM, the first subsequent lens group GR1, the second subsequent lens group GR2, the third subsequent lens group GR3, the focusing group Gf, and the anti-vibration group Gois, reference numerals of the respective groups are shown. For example, “GR1” in the left column of the thirteenth to twenty-sixth surfaces of Table 1 indicates that these surfaces correspond to the first subsequent lens group GR1, and “Gois” in the left column of the nineteenth to twenty-first surfaces indicates that these surfaces correspond to the anti-vibration group Gois.

In the table of the basic lens data, a sign of a curvature radius of a surface having a convex shape facing the object side is positive, and a sign of a curvature radius of a surface having a convex shape facing the image side is negative. In Table 1, the field of a surface number of the surface corresponding to the aperture stop St has the term of the surface number (St). A value in the lowermost field of the column D in the table indicates a spacing between a surface closest to the image side in the table and the image plane Sim. The symbol DD[ ] is used for the variable surface spacings during magnification change, and the surface number on the object side of the spacing is provided inside [ ] and is described in the column of the surface spacings.

Table 2 shows a magnification change ratio Zr, a focal length f, a back focus Bf, an open F-number FNo., a maximum full angle of view 2ω, and variable surface spacings, based on the d line. In a case in which the variable magnification optical system is a zoom lens, the magnification change ratio is synonymous with a zoom magnification. In the field of 2ω, [° ] indicates a degree unit. Table 2 shows each value of the wide angle end state, the middle focal length state, and the telephoto end state in the columns labeled “Wide”, “Middle”, and “Tele”, respectively.

In the basic lens data, a surface number of an aspherical surface is marked with *, and a value of a paraxial curvature radius is shown in the field of the curvature radius of the aspherical surface. In Table 3, the column of Sn shows the surface numbers of the aspherical surfaces, and the columns of KA and Am show numerical values of the aspherical coefficients for each aspherical surface. It should be noted that m of Am is an integer equal to or more than 3, and varies depending on the surface. For example, for the thirteenth surface according to Example 1, m=4, 6, 8, 10, and 12. In Table 3, “E±n” (n: integer) of the numerical value of the aspherical coefficient means “×10^{±n}”. KA and Am are aspherical coefficients in an aspheric equation represented by the following equation.

$$Zd = C \times {h}^{2} / \{ 1 + {( 1 - KA \times {C}^{2} \times {h}^{2} )}^{1 / 2} \} + \sum Am \times {h}^{m}$$

Here,
Zd: aspherical surface depth (a length of a perpendicular line drawn from a point on the aspherical surface at height h to a plane perpendicular to the optical axis Z where the apex of the aspherical surface is in contact),
h: height (distance from optical axis Z to lens surface),
C: reciprocal of paraxial curvature radius, and
KA, Am: aspherical coefficients,
and Σ means the sum with respect to m in aspherical surface equation.

Although, in the data of each table, a degree unit is used for angles, and a millimeter unit is used for lengths, since the optical system can also be proportionally enlarged or proportionally reduced to be used, other appropriate units can also be used. Further, numerical values rounded to predetermined digits are described in each table shown below.

TABLE 1
Example 1

| | | Sn | R | D | Nd | νd | θgF | ρ |
|---|---|---|---|---|---|---|---|---|
| | GF | 1 | 130.9951 | 4.2498 | 1.45518 | 87.98 | 0.53328 | 3.17 |
| | | 2 | −317.9591 | 0.2000 | | | | |
| | | 3 | 44.7303 | 1.3751 | 1.98166 | 30.47 | 0.59556 | 5.37 |
| | | 4 | 35.9984 | 8.0201 | 1.45196 | 88.47 | 0.53295 | 3.13 |
| | | 5 | 254.3651 | DD[5] | | | | |
| | GM | 6 | 128.2343 | 0.9402 | 2.00000 | 28.60 | 0.60122 | |
| | | 7 | 32.3996 | 6.9481 | | | | |
| | | 8 | 38.9830 | 7.5867 | 1.86346 | 23.37 | 0.62391 | |
| | | 9 | −46.1488 | 0.8850 | 1.57020 | 70.46 | 0.54149 | |
| | | 10 | 38.5283 | 4.7646 | | | | |
| | | 11 | −40.4188 | 0.8750 | 2.00000 | 28.60 | 0.60122 | |
| | | 12 | −1026.7922 | DD[12] | | | | |
| | GR1 | *13 | 28.5790 | 5.9828 | 1.62807 | 61.45 | 0.54347 | |
| | | *14 | −58.1107 | 0.0470 | | | | |
| | | 15 | 56.2407 | 5.2766 | 1.53488 | 75.84 | 0.53963 | |
| | | 16 | −27.7161 | 0.8751 | 1.96563 | 32.11 | 0.59049 | |
| | | 17 | −297.4599 | 2.0001 | | | | |
| | | 18(St) | ∞ | 6.2500 | | | | |
| Gois | | 19 | −59.3818 | 2.7500 | 1.97467 | 26.09 | 0.61194 | |
| | | 20 | −22.7978 | 0.8850 | 1.73005 | 56.21 | 0.54276 | |
| | | 21 | 48.6015 | 2.5000 | | | | |
| | | 22 | 66.4080 | 0.4993 | 1.99999 | 21.42 | 0.63874 | |
| | | 23 | 18.6574 | 5.0101 | 1.55653 | 44.40 | 0.57115 | |
| | | 24 | −46.8416 | 0.0469 | | | | |
| | | 25 | 24.5099 | 3.2090 | 1.57326 | 48.59 | 0.56203 | |
| | | 26 | −100.7999 | DD[26] | | | | |
| Gf | GR2 | 27 | 49.2288 | 2.6053 | 1.87876 | 21.06 | 0.63603 | |
| | | 28 | −54.6157 | 0.0454 | | | | |
| | | 29 | −55.0127 | 0.8752 | 1.88330 | 40.54 | 0.56905 | |
| | | 30 | 17.6086 | DD[30] | | | | |
| | GR3 | *31 | −78.8084 | 2.7500 | 1.68913 | 58.25 | 0.54210 | |
| | | *32 | 1291.4350 | 20.6900 | | | | |

TABLE 2
Example 1

| | Wide | Middle | Tele |
|---|---|---|---|
| Zr | 1.0 | 1.7 | 2.3 |
| f | 72.06 | 124.89 | 165.73 |
| Bf | 20.69 | 20.69 | 20.69 |
| FNo. | 4.11 | 4.13 | 4.13 |
| 2ω[°] | 33.6 | 19.2 | 14.4 |
| DD[5] | 0.10 | 17.60 | 25.36 |
| DD[12] | 31.52 | 14.01 | 6.26 |
| DD[26] | 2.64 | 4.55 | 3.61 |
| DD[30] | 22.91 | 20.99 | 21.93 |

TABLE 3
Example 1

| Sn | 13 | 14 | 31 | 32 |
|---|---|---|---|---|
| KA | 1.0000000E+00 | 1.0000000E+00 | 1.0000000E+00 | 1.0000000E+00 |
| A4 | −2.7721686E−06 | 1.4084982E−06 | −1.4295747E−04 | −1.4896803E−04 |
| A6 | 2.6219844E−08 | 2.6143178E−08 | 4.1525934E−07 | 5.7785944E−07 |
| A8 | −2.6679756E−10 | −3.4136534E−10 | −6.2222826E−10 | −2.2487736E−09 |
| A10 | 1.2620594E−12 | 1.7881198E−12 | −5.2705686E−12 | 4.3103595E−12 |
| A12 | −1.7192858E−15 | −3.0674590E−15 | 7.9378435E−15 | −6.2471836E−15 |

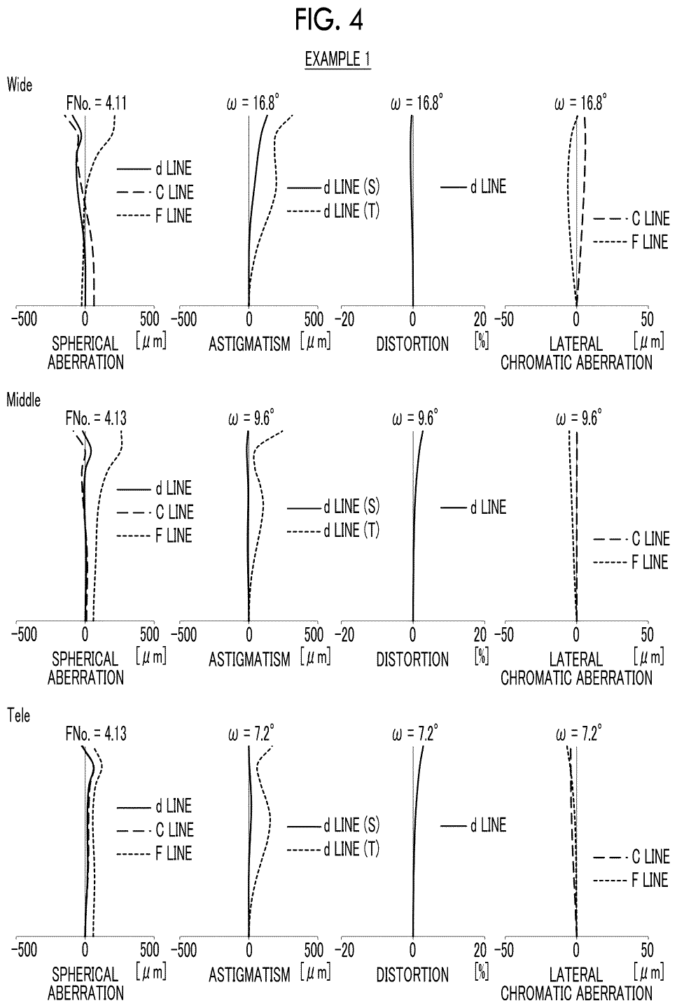

FIG. 4 shows each aberration diagram of the variable magnification optical system according to Example 1 in a state in which the infinite distance object is in focus. In FIG. 4, the spherical aberration, the astigmatism, the distortion, and the lateral chromatic aberration are shown in order from the left. In FIG. 4, aberrations in the wide angle end state are shown in an upper part labeled “Wide”, aberrations in the middle focal length state are shown in a middle part labeled “Middle”, and aberrations in the telephoto end state are shown in a lower part labeled “Tele”. In the spherical aberration diagram, the aberrations on the d line, the C line, and the F line are shown by a solid line, a long broken line, and a short broken line, respectively. In the astigmatism diagram, the aberration on the d line in a sagittal direction is shown by a solid line, and the aberration on the d line in a tangential direction is shown by a short broken line. In the distortion diagram, the aberration on the d line is shown by a solid line. In the lateral chromatic aberration diagram, the aberrations on the C line and the F line are shown by a long broken line and a short broken line, respectively. In the spherical aberration diagram, a value of the open F-number is shown after FNo. =. In other aberration diagrams, a value of the maximum half angle of view is shown after ω=.

Symbols, meanings, description methods, and showing methods of each data related to Example 1 are basically the same in the following examples unless otherwise noted, and thus the duplicate description will be omitted below. It should be noted that, among the following examples, in examples in which the variable magnification optical system includes two focusing groups, the two focusing groups are respectively referred to as a first focusing group Gf1 and a second focusing group Gf2. In addition, in the cross-sectional view of each of the following examples, arrows attached to the focusing group Gf, the first focusing group Gf1, and the second focusing group Gf2 indicate directions in which the focusing group Gf, the first focusing group Gf1, and the second focusing group Gf2 move during focusing on the short distance object from the infinite distance object in the wide angle end state, and a rightward arrow indicates an image side direction and a leftward arrow indicates an object side direction.

### Example 2

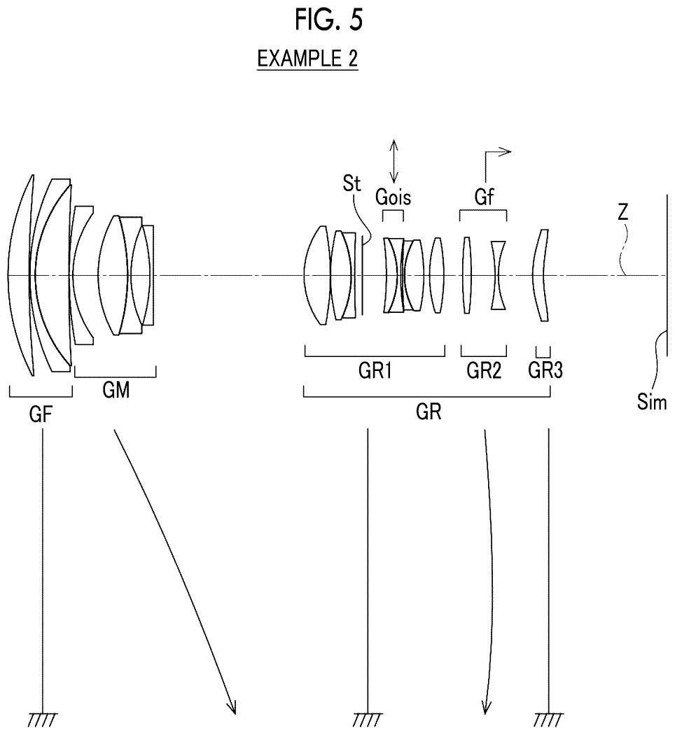

A configuration and a movement trajectory of a variable magnification optical system according to Example 2 are shown in FIG. 5. The variable magnification optical system according to Example 2 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, and the third subsequent lens group GR3 having a positive refractive power.

During magnification change from the wide angle end to the telephoto end, the front group GF, the first subsequent lens group GR1, and the third subsequent lens group GR3 are fixed with respect to the image plane Sim, and the intermediate group GM and the second subsequent lens group GR2 move by changing the spacings between the adjacent lens groups. The variable magnification optical system according to Example 2 includes only one focusing group Gf. The focusing group Gf consists of the second subsequent lens group GR2. The anti-vibration group Gois consists of a fourth lens and a fifth lens of the first subsequent lens group GR1 from the object side.

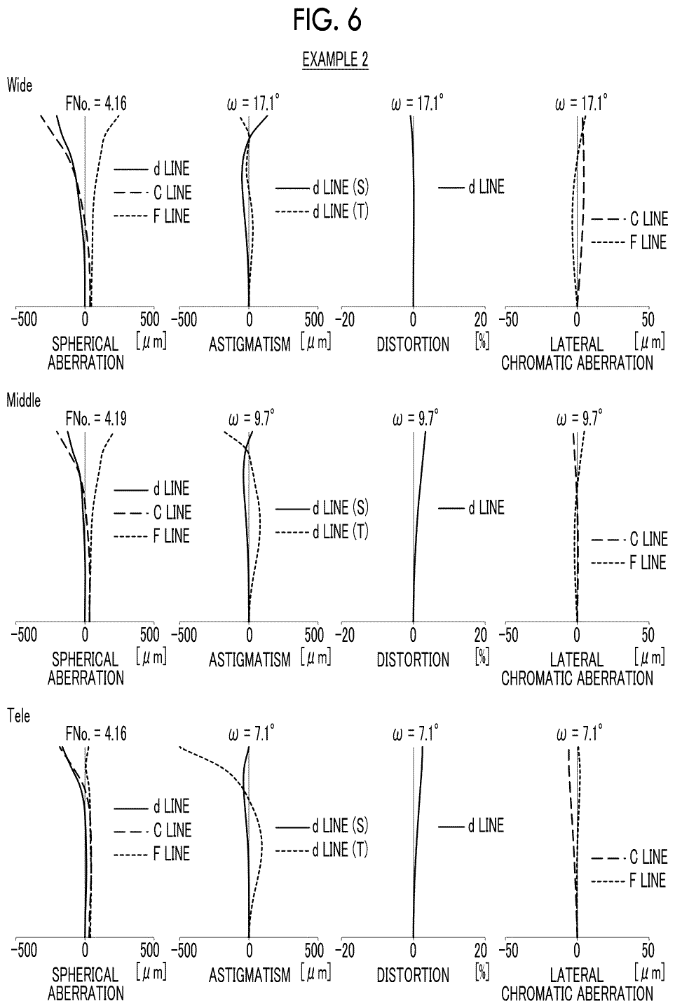

For the variable magnification optical system according to Example 2, basic lens data is shown in Table 4, specifications and variable surface spacings are shown in Table 5, aspherical coefficients are shown in Table 6, and each aberration diagram is shown in FIG. 6.

TABLE 4
Example 2

| | | Sn | R | D | Nd | νd | θgF | ρ |
|---|---|---|---|---|---|---|---|---|
| | GF | 1 | 61.1227 | 5.4759 | 1.48749 | 70.32 | 0.52917 | 2.45 |
| | | 2 | 293.7305 | 0.2000 | | | | |
| | | 3 | 61.5159 | 1.3751 | 1.89683 | 39.15 | 0.57238 | 5.06 |
| | | 4 | 37.1531 | 8.6934 | 1.49125 | 82.48 | 0.53693 | 3.51 |
| | | 5 | 453.5676 | DD[5] | | | | |
| | GM | 6 | 108.6537 | 0.9563 | 1.85680 | 43.25 | 0.56325 | |
| | | 7 | 29.4349 | 6.5446 | | | | |
| | | 8 | 33.6732 | 7.6229 | 1.81136 | 28.81 | 0.60497 | |
| | | 9 | −57.6785 | 0.8852 | 1.51893 | 78.27 | 0.53876 | |
| | | 10 | 33.4782 | 4.8980 | | | | |
| | | 11 | −47.5015 | 0.8748 | 2.00001 | 28.60 | 0.60122 | |
| | | 12 | 11777.5997 | DD[12] | | | | |
| | GR1 | *13 | 22.6609 | 6.8151 | 1.50683 | 80.11 | 0.53809 | |
| | | *14 | −68.2814 | 0.0483 | | | | |
| | | 15 | 50.9958 | 5.1988 | 1.46907 | 84.18 | 0.53384 | |
| | | 16 | −28.1742 | 0.8748 | 1.91480 | 37.31 | 0.57696 | |
| | | 17 | 260.3039 | 2.0000 | | | | |
| | | 18(St) | ∞ | 6.2501 | | | | |
| Gois | | 19 | −73.4353 | 2.8088 | 1.69726 | 30.20 | 0.60348 | |
| | | 20 | −22.6436 | 0.8850 | 1.61467 | 63.55 | 0.54391 | |
| | | 21 | 62.0249 | 0.4744 | | | | |
| | | 22 | 139.4405 | 0.4998 | 1.97696 | 30.95 | 0.59408 | |
| | | 23 | 20.0304 | 5.0099 | 1.45129 | 64.13 | 0.52957 | |
| | | 24 | −46.5159 | 1.4966 | | | | |
| | | 25 | 34.8088 | 3.6864 | 1.73674 | 46.88 | 0.55957 | |
| | | 26 | −53.2312 | DD[26] | | | | |
| Gf | GR2 | 27 | 92.1242 | 2.2498 | 1.82629 | 23.69 | 0.62071 | |
| | | 28 | −92.8722 | 6.1435 | | | | |
| | | 29 | −42.6349 | 0.8749 | 1.88426 | 40.44 | 0.56927 | |
| | | 30 | 23.8829 | DD[30] | | | | |
| | GR3 | *31 | 26.1301 | 2.8120 | 1.43600 | 67.00 | 0.52556 | |
| | | *32 | 35.4190 | 32.0000 | | | | |

TABLE 5
Example 2

| | Wide | Middle | Tele |
|---|---|---|---|
| Zr | 1.0 | 1.7 | 2.4 |
| f | 70.78 | 122.68 | 168.46 |
| Bf | 32.00 | 32.00 | 32.00 |
| FNo. | 4.16 | 4.19 | 4.16 |
| 2ω[°] | 34.2 | 19.4 | 14.2 |
| DD[5] | 0.10 | 20.86 | 31.03 |
| DD[12] | 39.07 | 18.31 | 8.14 |
| DD[26] | 4.86 | 6.85 | 5.07 |
| DD[30] | 8.88 | 6.89 | 8.67 |

TABLE 6
Example 2

| Sn | 13 | 14 | 31 | 32 |
|---|---|---|---|---|
| KA | 1.0000000E+00 | 1.0000000E+00 | 1.0000000E+00 | 1.0000000E+00 |
| A4 | −2.4235639E−06 | 2.7784422E−06 | −4.1821062E−05 | −5.2918729E−05 |
| A6 | 9.6959872E−09 | 5.8820336E−09 | 8.9269931E−08 | 8.5067453E−08 |
| A8 | −6.0940983E−11 | −6.8432892E−11 | −1.9303655E−10 | −2.0118256E−10 |
| A10 | 3.8844959E−13 | 2.9522168E−13 | 4.2879517E−13 | 1.0366504E−12 |
| A12 | −8.3790486E−16 | −6.9232911E−16 | −7.2178402E−15 | −8.9471602E−15 |

### Example 3

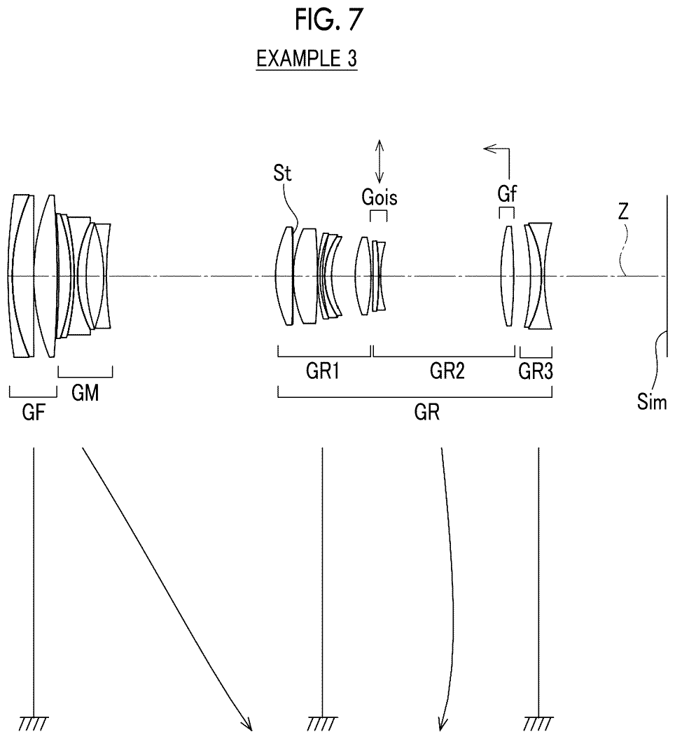

A configuration and a movement trajectory of a variable magnification optical system according to Example 3 are shown in FIG. 7. The variable magnification optical system according to Example 3 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, and the third subsequent lens group GR3 having a negative refractive power.

During magnification change from the wide angle end to the telephoto end, the front group GF, the first subsequent lens group GR1, and the third subsequent lens group GR3 are fixed with respect to the image plane Sim, and the intermediate group GM and the second subsequent lens group GR2 move by changing the spacings between the adjacent lens groups. The variable magnification optical system according to Example 3 includes only one focusing group Gf. The focusing group Gf consists of one lens of the second subsequent lens group GR2 closest to the image side. The anti-vibration group Gois consists of a first lens and a second lens of the second subsequent lens group GR2 from the object side.

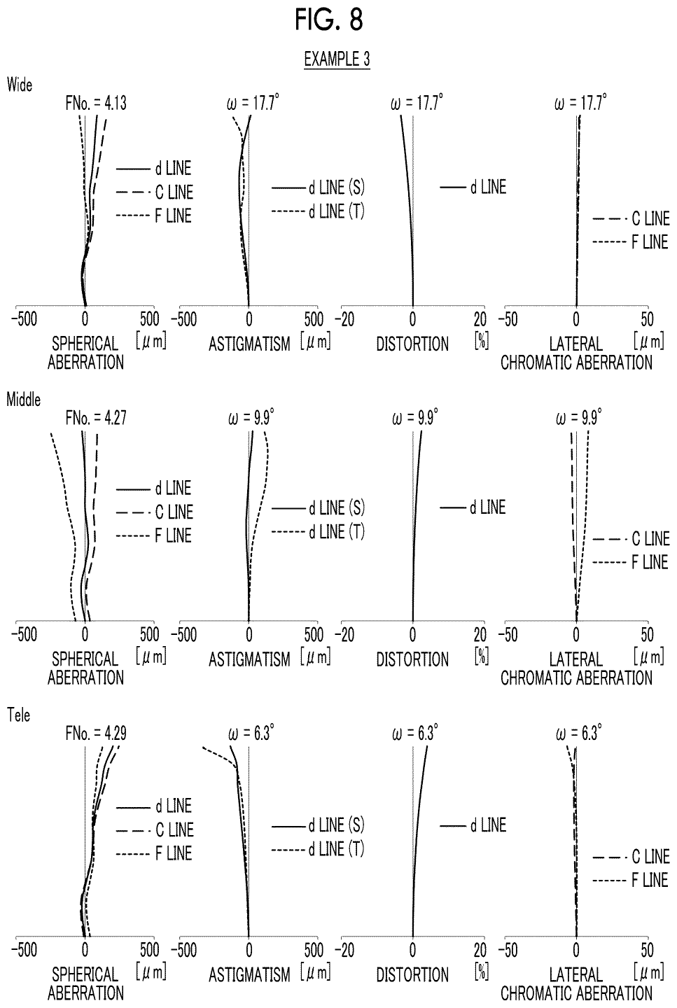

For the variable magnification optical system according to Example 3, basic lens data is shown in Table 7, specifications and variable surface spacings are shown in Table 8, aspherical coefficients are shown in Table 9, and each aberration diagram is shown in FIG. 8.

TABLE 7
Example 3

| | | Sn | R | D | Nd | νd | θgF | ρ |
|---|---|---|---|---|---|---|---|---|
| | GF | 1 | 154.8816 | 1.1148 | 1.81600 | 46.62 | 0.55682 | 5.07 |
| | | 2 | 56.0705 | 5.5716 | 1.49710 | 81.56 | 0.53848 | 3.64 |
| | | 3 | 5006.0398 | 0.0434 | | | | |
| | | 4 | 60.9720 | 6.0804 | 1.43700 | 95.10 | 0.53364 | 3.53 |
| | | 5 | −299.3219 | DD[5] | | | | |
| | GM | 6 | −206.2348 | 3.1278 | 1.80610 | 40.73 | 0.56719 | |
| | | 7 | −52.5856 | 0.8662 | 1.49710 | 81.56 | 0.53848 | |
| | | 8 | −71.6252 | 0.0362 | | | | |
| | | 9 | −73.6274 | 0.8319 | 1.55032 | 75.50 | 0.54001 | |
| | | 10 | 33.2796 | 2.2508 | 1.89190 | 37.13 | 0.57813 | |
| | | 11 | 47.9213 | 4.5703 | | | | |
| | | 12 | −43.9719 | 0.7281 | 1.49710 | 81.56 | 0.53848 | |
| | | 13 | 96.9818 | DD[13] | | | | |
| | GR1 | *14 | 29.4975 | 4.4453 | 1.49710 | 81.56 | 0.53848 | |
| | | *15 | −469.4366 | 0.0998 | | | | |
| | | 16(St) | ∞ | 0.0998 | | | | |
| | | 17 | 32.6578 | 6.3082 | 1.45650 | 90.27 | 0.53477 | |
| | | 18 | −163.4803 | 0.0447 | | | | |
| | | 19 | 46.0997 | 0.6033 | 1.57099 | 50.80 | 0.55887 | |
| | | 20 | 29.5935 | 0.6609 | | | | |
| | | 21 | 40.7871 | 0.5835 | 1.81600 | 46.62 | 0.55682 | |
| | | 22 | 19.4693 | 1.7643 | 1.45650 | 90.27 | 0.53477 | |
| | | 23 | 23.2304 | 6.0128 | | | | |
| | | 24 | 31.2209 | 4.1386 | 1.43700 | 95.10 | 0.53364 | |
| | | 25 | −52.4427 | DD[25] | | | | |
| Gois | GR2 | 26 | −1255.6936 | 1.5133 | 1.61772 | 49.81 | 0.56035 | |
| | | 27 | −86.5650 | 0.4999 | 1.62041 | 60.29 | 0.54266 | |
| | | 28 | 33.5975 | 31.37 | | | | |
| Gf | | 29 | 59.6918 | 3.3397 | 1.51823 | 58.96 | 0.54420 | |
| | | 30 | −139.2408 | DD[30] | | | | |
| | GR3 | 31 | −62.2843 | 2.8688 | 1.51742 | 52.15 | 0.55896 | |
| | | 32 | −31.0937 | 0.7404 | 1.43700 | 95.10 | 0.53364 | |
| | | 33 | 54.7212 | 32.0100 | | | | |

TABLE 8
Example 3

| | Wide | Middle | Tele |
|---|---|---|---|
| Zr | 1.0 | 1.7 | 2.7 |
| f | 70.00 | 121.32 | 188.37 |
| Bf | 32.01 | 32.01 | 32.01 |
| FNo. | 4.13 | 4.27 | 4.29 |
| 2ω[°] | 35.4 | 19.8 | 12.6 |
| DD[5] | 0.46 | 24.46 | 44.47 |
| DD[13] | 44.10 | 20.10 | 0.09 |
| DD[25] | 0.49 | 3.50 | 0.10 |
| DD[30] | 4.38 | 1.38 | 4.78 |

TABLE 9
Example 3

| Sn | 14 | 15 |
|---|---|---|
| KA | 1.0000000E+00 | 1.0000000E+00 |
| A3 | 0.0000000E+00 | 0.0000000E+00 |
| A4 | −4.7125522E−06 | 4.0703818E−06 |
| A5 | −4.4100049E−07 | 3.0250576E−07 |
| A6 | 5.3015167E−08 | −6.1606598E−08 |
| A7 | −1.6763868E−09 | 3.3019031E−09 |
| A8 | −8.2365810E−11 | 1.9460157E−10 |
| A9 | −1.4775527E−11 | −1.5904396E−11 |
| A10 | 1.9761864E−12 | −1.1885328E−12 |
| A11 | −2.0565238E−15 | 8.3987508E−14 |
| A12 | −1.8198123E−14 | −7.5075669E−15 |
| A13 | 9.3065740E−16 | −6.2315585E−16 |
| A14 | 1.5282984E−17 | 1.9623592E−16 |
| A15 | −5.3287229E−19 | −1.5988325E−17 |
| A16 | −3.8645797E−20 | 6.4888230E−19 |
| A17 | 5.8883705E−21 | 2.9174258E−20 |
| A18 | −2.2441743E−22 | −2.7835488E−21 |
| A19 | −5.2185606E−23 | −1.3626386E−22 |
| A20 | 1.6425807E−24 | 8.8088368E−24 |

### Example 4

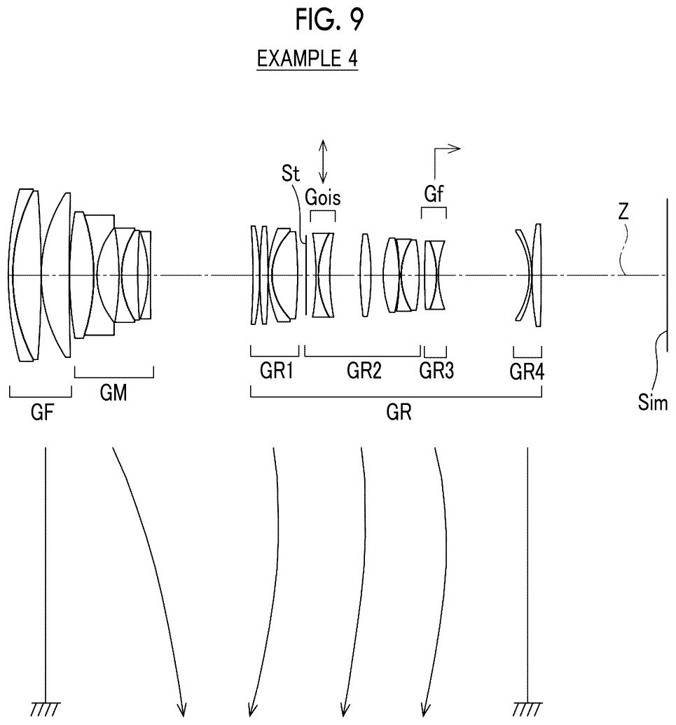

A configuration and a movement trajectory of a variable magnification optical system according to Example 4 are shown in FIG. 9. The variable magnification optical system according to Example 4 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power.

During magnification change from the wide angle end to the telephoto end, the front group GF and the fourth subsequent lens group GR4 are fixed with respect to the image plane Sim, and the intermediate group GM, the first subsequent lens group GR1, the second subsequent lens group GR2, and the third subsequent lens group GR3 move by changing the spacings between the adjacent lens groups. The variable magnification optical system according to Example 4 includes only one focusing group Gf. The focusing group Gf consists of the third subsequent lens group GR3. The anti-vibration group Gois consists of a first lens and a second lens of the second subsequent lens group GR2 from the object side.

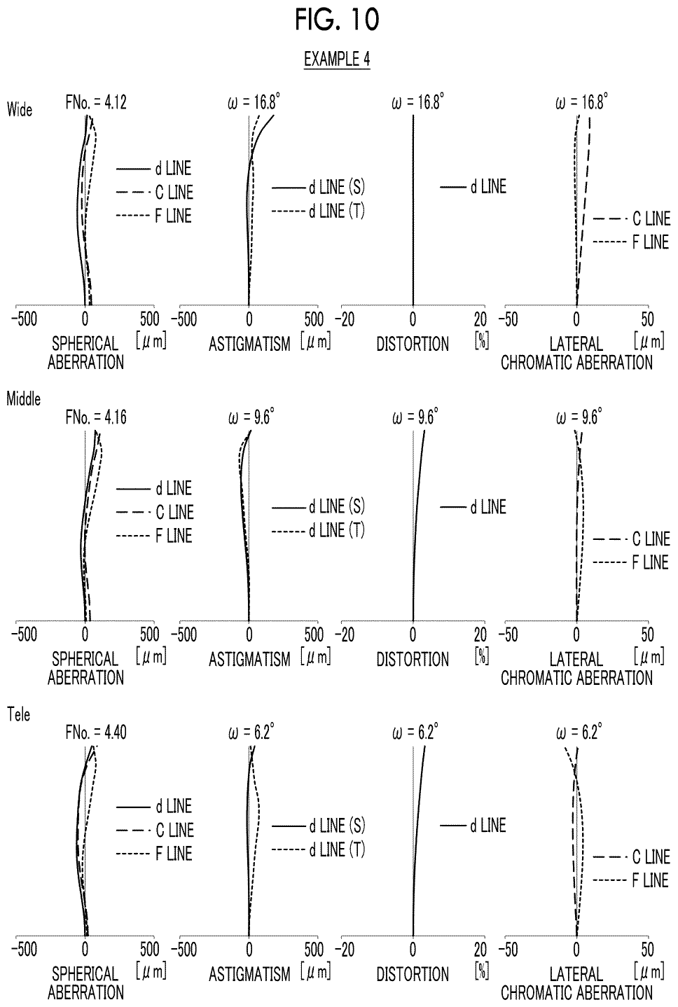

For the variable magnification optical system according to Example 4, basic lens data is shown in Table 10, specifications and variable surface spacings are shown in Table 11, aspherical coefficients are shown in Table 12, and each aberration diagram is shown in FIG. 10.

TABLE 10
Example 4

| | | Sn | R | D | Nd | νd | θgF | ρ |
|---|---|---|---|---|---|---|---|---|
| | GF | 1 | 97.7661 | 1.2275 | 1.97717 | 30.93 | 0.59415 | 5.38 |
| | | 2 | 54.3669 | 7.7805 | 1.49700 | 81.54 | 0.53748 | 3.62 |
| | | 3 | −322.1917 | 0.0497 | | | | |
| | | 4 | 44.2674 | 7.6418 | 1.49700 | 81.54 | 0.53748 | 3.62 |
| | | 5 | 792.5879 | DD[5] | | | | |
| | GM | 6 | 110.7893 | 6.6172 | 1.73781 | 28.11 | 0.60896 | |
| | | 7 | −57.6120 | 0.8876 | 1.61800 | 63.39 | 0.54415 | |
| | | 8 | 21.5664 | 6.0426 | | | | |
| | | 9 | −79.4640 | 0.7037 | 1.44439 | 67.10 | 0.52640 | |
| | | 10 | 24.5950 | 4.4365 | 1.87310 | 26.40 | 0.61199 | |
| | | 11 | 183.1418 | 2.8252 | | | | |
| | | 12 | −36.6573 | 0.6458 | 1.99194 | 25.25 | 0.61647 | |
| | | 13 | 935.7371 | DD[13] | | | | |
| | GR1 | 14 | −208.7132 | 1.8425 | 1.85779 | 43.15 | 0.56344 | |
| | | 15 | −78.2098 | 0.0493 | | | | |
| | | 16 | 131.9538 | 2.2363 | 1.66824 | 59.28 | 0.54269 | |
| | | 17 | −226.3060 | 0.0495 | | | | |
| | | 18 | 34.8525 | 1.0348 | 1.92077 | 20.95 | 0.63815 | |
| | | 19 | 18.0444 | 7.0190 | 1.57295 | 70.04 | 0.54163 | |
| | | 20 | −138.3982 | DD[20] | | | | |
| | GR2 | 21(St) | ∞ | 2.7251 | | | | |
| Gois | | 22 | −76.8517 | 0.6336 | 1.81227 | 34.99 | 0.58638 | |
| | | 23 | 25.5500 | 3.1221 | 1.99879 | 18.56 | 0.65546 | |
| | | 24 | 68.1623 | 8.1953 | | | | |
| | | *25 | 82.2580 | 2.9571 | 1.85400 | 40.38 | 0.56890 | |
| | | *26 | −72.1778 | 3.3567 | | | | |
| | | 27 | 33.4475 | 4.3457 | 1.50803 | 53.49 | 0.55491 | |
| | | 28 | −46.9801 | 0.0490 | | | | |
| | | 29 | −70.9798 | 0.5365 | 1.82419 | 41.63 | 0.56821 | |
| | | 30 | 19.7921 | 4.9118 | 1.44982 | 64.41 | 0.52918 | |
| | | 31 | −59.8257 | DD[31] | | | | |
| Gf | GR3 | 32 | 214.4787 | 3.2741 | 1.62832 | 35.17 | 0.59088 | |
| | | 33 | −26.5767 | 0.5168 | 1.58515 | 68.16 | 0.54226 | |
| | | 34 | 28.3940 | DD[34] | | | | |
| | GR4 | *35 | −23.2617 | 0.7004 | 2.00178 | 19.32 | 0.64480 | |
| | | *36 | −29.4560 | 0.0494 | | | | |
| | | 37 | 88.4414 | 2.5739 | 1.58466 | 57.76 | 0.54514 | |
| | | 38 | −377.3240 | 26.7500 | | | | |

TABLE 11
Example 4

| | Wide | Middle | Tele |
|---|---|---|---|
| Zr | 1.0 | 1.7 | 2.7 |
| f | 71.60 | 124.10 | 192.69 |
| Bf | 26.75 | 26.75 | 26.75 |
| FNo. | 4.12 | 4.16 | 4.40 |
| 2ω[°] | 33.6 | 19.2 | 12.4 |
| DD[5] | 0.12 | 13.67 | 19.49 |
| DD[13] | 28.11 | 14.72 | 2.30 |
| DD[20] | 2.34 | 2.13 | 3.81 |
| DD[31] | 1.50 | 3.95 | 3.32 |
| DD[34] | 24.87 | 22.47 | 28.02 |

TABLE 12
Example 4

| Sn | 25 | 26 |
|---|---|---|
| KA | 1.0000000E+00 | 1.0000000E+00 |
| A4 | −3.3297691E−06 | −3.1099690E−06 |
| A6 | −1.3300866E−09 | 3.2661946E−09 |
| A8 | 6.0626134E−11 | −6.6526294E−12 |
| A10 | −1.1397772E−12 | −7.5997100E−13 |
| A12 | 2.3431211E−15 | 1.5876066E−15 |
| Sn | 35 | 36 |
| KA | 1.0000000E+00 | 1.0000000E+00 |
| A4 | −1.5024084E−07 | −1.7060912E−06 |
| A6 | −1.2113002E−08 | −1.8224366E−08 |
| A8 | −1.3388317E−10 | −4.3872311E−11 |
| A10 | 1.1170315E−12 | 4.6515169E−13 |
| A12 | −1.3454979E−15 | −1.0133581E−16 |
| A14 | −4.9461369E−18 | −3.6478487E−18 |

### Example 5

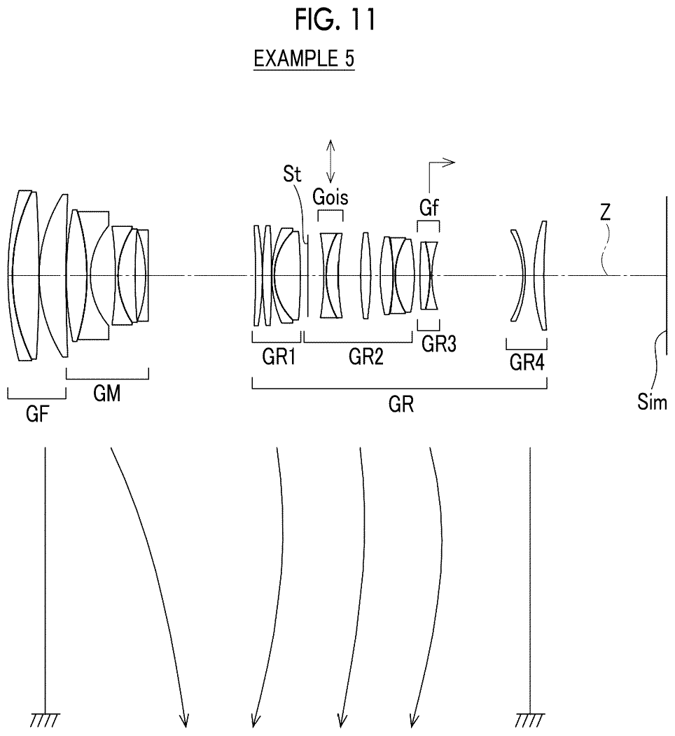

A configuration and a movement trajectory of a variable magnification optical system according to Example 5 are shown in FIG. 11. The variable magnification optical system according to Example 5 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power.

During magnification change from the wide angle end to the telephoto end, the front group GF and the fourth subsequent lens group GR4 are fixed with respect to the image plane Sim, and the intermediate group GM, the first subsequent lens group GR1, the second subsequent lens group GR2, and the third subsequent lens group GR3 move by changing the spacings between the adjacent lens groups. The variable magnification optical system according to Example 5 includes only one focusing group Gf. The focusing group Gf consists of the third subsequent lens group GR3. The anti-vibration group Gois consists of a first lens and a second lens of the second subsequent lens group GR2 from the object side.

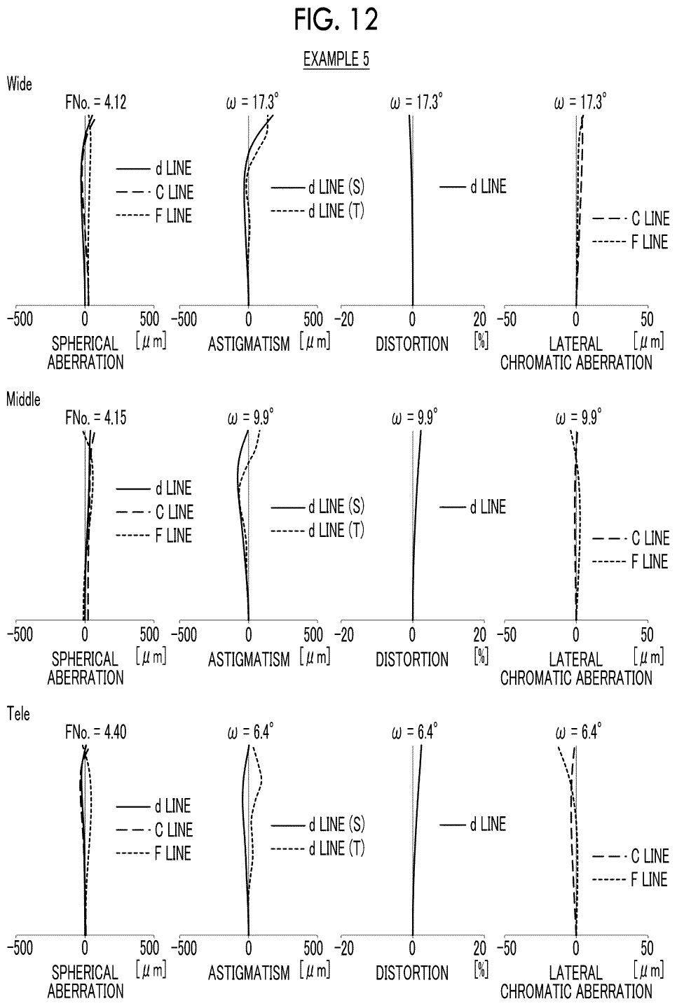

For the variable magnification optical system according to Example 5, basic lens data is shown in Table 13, specifications and variable surface spacings are shown in Table 14, aspherical coefficients are shown in Table 15, and each aberration diagram is shown in FIG. 12.

TABLE 13
Example 5

| | | Sn | R | D | Nd | νd | θgF | ρ |
|---|---|---|---|---|---|---|---|---|
| | GF | 1 | 94.7845 | 1.1680 | 1.99543 | 29.07 | 0.59986 | 5.28 |
| | | 2 | 54.3587 | 7.0129 | 1.49700 | 81.54 | 0.53748 | 3.62 |
| | | 3 | −366.7391 | 0.0496 | | | | |
| | | 4 | 43.0640 | 7.0512 | 1.49700 | 81.54 | 0.53748 | 3.62 |
| | | 5 | 514.0247 | DD[5] | | | | |
| | GM | 6 | 97.8251 | 5.4351 | 1.73241 | 28.38 | 0.60820 | |
| | | 7 | −62.1924 | 0.9102 | 1.61800 | 63.39 | 0.54415 | |
| | | 8 | 21.8556 | 6.5862 | | | | |
| | | 9 | −103.7258 | 0.7091 | 1.44099 | 68.47 | 0.52495 | |
| | | 10 | 23.9021 | 4.5128 | 1.82473 | 25.28 | 0.61667 | |
| | | 11 | 162.2997 | 2.7480 | | | | |
| | | 12 | −36.6507 | 0.6484 | 2.00000 | 24.92 | 0.61829 | |
| | | 13 | 1823.7337 | DD[13] | | | | |
| | GR1 | 14 | −246.8643 | 1.8107 | 1.77692 | 51.42 | 0.54863 | |
| | | 15 | −83.5136 | 0.0494 | | | | |
| | | 16 | 103.3368 | 2.3680 | 1.69503 | 57.96 | 0.54218 | |
| | | 17 | −246.3567 | 0.0495 | | | | |
| | | 18 | 33.5362 | 0.6731 | 1.94850 | 21.45 | 0.63681 | |
| | | 19 | 17.5663 | 6.8683 | 1.57369 | 69.93 | 0.54167 | |
| | | 20 | −156.2803 | DD[20] | | | | |
| | GR2 | 21(St) | ∞ | 4.2141 | | | | |
| Gois | | 22 | −76.0322 | 0.6146 | 1.82335 | 37.60 | 0.57867 | |
| | | 23 | 24.8234 | 3.0879 | 1.99063 | 19.42 | 0.64984 | |
| | | 24 | 68.2947 | 5.8651 | | | | |
| | | *25 | 81.7116 | 2.6259 | 1.85400 | 40.38 | 0.56890 | |
| | | *26 | −91.4109 | 2.5165 | | | | |
| | | 27 | 48.5228 | 3.3702 | 1.77535 | 50.30 | 0.55004 | |
| | | 28 | −56.1999 | 0.0491 | | | | |
| | | 29 | −70.6213 | 0.5421 | 1.82869 | 46.12 | 0.55794 | |
| | | 30 | 19.9487 | 5.0323 | 1.45407 | 74.15 | 0.52696 | |
| | | 31 | −52.2939 | DD[31] | | | | |
| Gf | GR3 | 32 | 143.3798 | 2.6141 | 1.66147 | 32.75 | 0.59725 | |
| | | 33 | −37.3363 | 0.5100 | 1.59831 | 66.10 | 0.54296 | |
| | | 34 | 28.9606 | DD[34] | | | | |
| | GR4 | *35 | −24.6626 | 0.6476 | 2.00178 | 19.32 | 0.64480 | |
| | | *36 | −32.6768 | 2.3050 | | | | |
| | | 37 | 50.5339 | 2.5995 | 1.43600 | 67.00 | 0.52556 | |
| | | 38 | 154.8871 | 22.4600 | | | | |

TABLE 14
Example 5

| | Wide | Middle | Tele |
|---|---|---|---|
| Zr | 1.0 | 1.7 | 2.7 |
| f | 70.01 | 121.35 | 188.41 |
| Bf | 22.46 | 22.46 | 22.46 |
| FNo. | 4.12 | 4.15 | 4.40 |
| 2ω[°] | 34.6 | 19.8 | 12.8 |
| DD[5] | 0.10 | 13.91 | 19.87 |
| DD[13] | 28.33 | 14.78 | 2.30 |
| DD[20] | 1.97 | 1.60 | 3.10 |
| DD[31] | 1.50 | 3.60 | 1.78 |
| DD[34] | 23.99 | 22.01 | 28.84 |

TABLE 15
Example 5

| Sn | 25 | 26 |
|---|---|---|
| KA | 1.0000000E+00 | 1.0000000E+00 |
| A4 | −3.5060586E−06 | −3.4893445E−06 |
| A6 | 2.4349606E−09 | 4.4441364E−11 |
| A8 | 4.5176414E−11 | 2.1239270E−11 |
| A10 | −1.0337036E−12 | −9.1260475E−13 |
| A12 | 2.7597814E−15 | 2.5155120E−15 |
| Sn | 35 | 36 |
| KA | 1.0000000E+00 | 1.0000000E+00 |
| A4 | 9.8543961E−06 | 7.5494808E−06 |
| A6 | −6.3098983E−08 | −5.0988449E−08 |
| A8 | −4.1224037E−13 | −3.2877746E−10 |
| A10 | −3.6091397E−12 | 1.7763183E−12 |
| A12 | 4.6725183E−14 | 7.4228093E−15 |
| A14 | −1.4606407E−16 | −4.3071068E−17 |

### Example 6

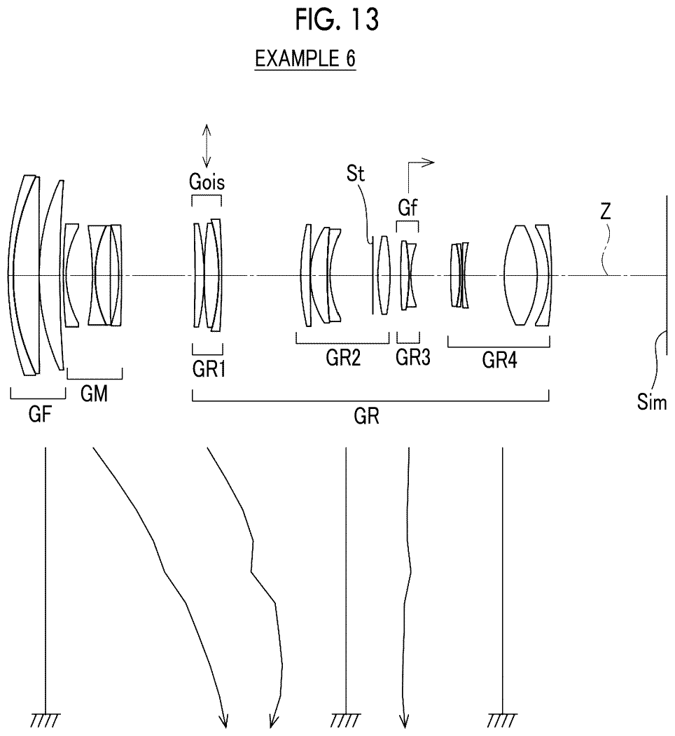

A configuration and a movement trajectory of a variable magnification optical system according to Example 6 are shown in FIG. 13. The variable magnification optical system according to Example 6 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, and the fourth subsequent lens group GR4 having a negative refractive power.

During magnification change from the wide angle end to the telephoto end, the front group GF, the second subsequent lens group GR2, and the fourth subsequent lens group GR4 are fixed with respect to the image plane Sim, and the intermediate group GM, the first subsequent lens group GR1, and the third subsequent lens group GR3 move by changing the spacings between the adjacent lens groups. The variable magnification optical system according to Example 6 includes only one focusing group Gf. The focusing group Gf consists of the third subsequent lens group GR3. The anti-vibration group Gois consists of the first subsequent lens group GR1.

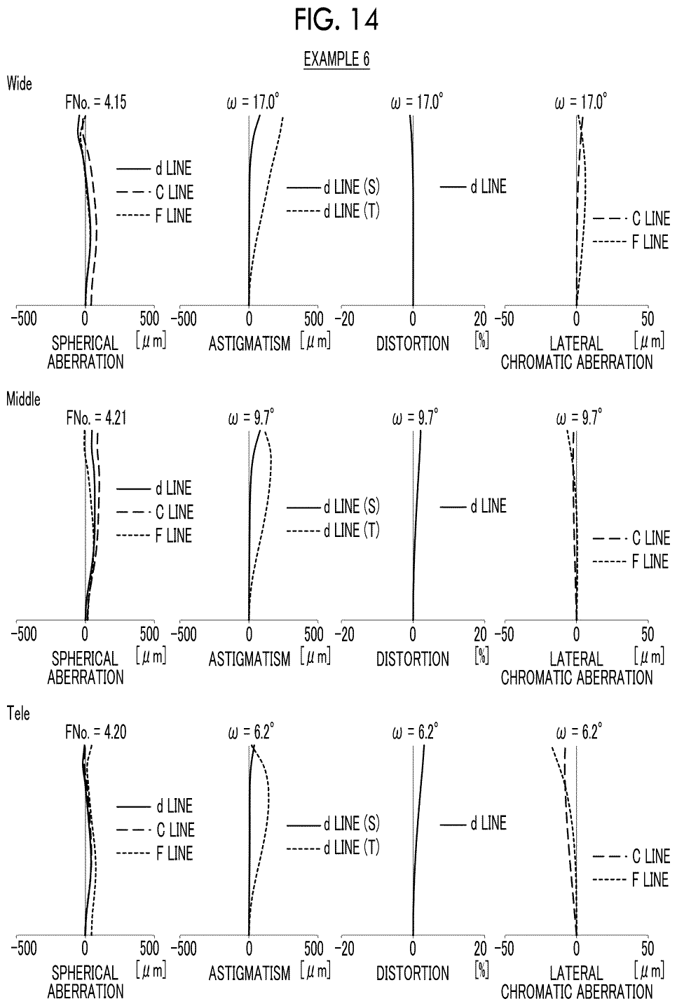

For the variable magnification optical system according to Example 6, basic lens data is shown in Table 16, specifications and variable surface spacings are shown in Table 17, aspherical coefficients are shown in Table 18, and each aberration diagram is shown in FIG. 14.

TABLE 16
Example 6

| | | Sn | R | D | Nd | νd | θgF | ρ |
|---|---|---|---|---|---|---|---|---|
| | GF | 1 | 89.3808 | 1.3409 | 1.87289 | 21.38 | 0.63450 | 3.63 |
| | | 2 | 63.9929 | 6.7525 | 1.56108 | 71.85 | 0.54100 | 3.64 |
| | | 3 | 2830.2626 | 0.0485 | | | | |
| | | 4 | 64.6388 | 5.4530 | 1.50575 | 80.27 | 0.53803 | 3.56 |
| | | 5 | 342.8176 | DD[5] | | | | |
| | GM | 6 | 168.6533 | 0.7273 | 1.87961 | 34.84 | 0.58499 | |
| | | 7 | 27.8195 | 6.9231 | | | | |
| | | 8 | −80.1948 | 0.7112 | 1.45034 | 64.31 | 0.52932 | |
| | | 9 | 32.8807 | 3.9380 | 1.91701 | 19.15 | 0.64781 | |
| | | 10 | 463.3164 | 2.2909 | | | | |
| | | 11 | −46.0905 | 0.7131 | 1.88060 | 39.03 | 0.57318 | |
| | | 12 | −399.3601 | DD[12] | | | | |
| Gois | GR1 | 13 | −448.2601 | 2.3662 | 1.90192 | 38.63 | 0.57368 | |
| | | 14 | −67.4883 | 0.0479 | | | | |
| | | 15 | 109.9552 | 3.8360 | 1.59690 | 66.32 | 0.54288 | |
| | | 16 | −59.1930 | 0.7650 | 1.89936 | 23.58 | 0.62321 | |
| | | 17 | −239.9466 | DD[17] | | | | |
| | GR2 | *18 | 59.1699 | 2.4700 | 1.88640 | 40.22 | 0.56974 | |
| | | *19 | 365.0346 | 0.0488 | | | | |
| | | 20 | 24.7325 | 4.4579 | 1.51192 | 79.34 | 0.53837 | |
| | | 21 | 135.2994 | 0.7491 | 1.84410 | 22.80 | 0.62764 | |
| | | 22 | 27.7486 | 11.0759 | | | | |
| | | 23(St) | ∞ | 1.3411 | | | | |
| | | *24 | 46.5785 | 3.1953 | 1.63859 | 46.29 | 0.56435 | |
| | | *25 | −65.6127 | DD[25] | | | | |
| Gf | GR3 | 26 | 153.8935 | 2.1654 | 1.92997 | 18.50 | 0.65232 | |
| | | 27 | −56.1577 | 0.5099 | 1.82308 | 46.70 | 0.55686 | |
| | | 28 | 25.5331 | DD[28] | | | | |
| | GR4 | *29 | 93.0541 | 2.4704 | 1.43767 | 66.69 | 0.52601 | |
| | | 30 | −39.6879 | 0.4998 | 1.98745 | 29.88 | 0.59738 | |
| | | 31 | −101.7178 | 0.1757 | | | | |
| | | 32 | 923.4820 | 0.5090 | 1.60213 | 65.51 | 0.54318 | |
| | | 33 | 41.3815 | 10.4267 | | | | |
| | | 34 | 31.3886 | 8.7008 | 1.43647 | 66.91 | 0.52569 | |
| | | 35 | −28.6884 | 3.0253 | | | | |
| | | 36 | −26.9439 | 0.7412 | 1.88415 | 40.45 | 0.56924 | |
| | | 37 | −114.3138 | 30.3700 | | | | |

TABLE 17
Example 6

| | Wide | Middle | Tele |
|---|---|---|---|
| Zr | 1.0 | 1.7 | 2.7 |
| f | 71.51 | 123.94 | 192.44 |
| Bf | 30.37 | 30.37 | 30.37 |
| FNo. | 4.15 | 4.21 | 4.20 |
| 2ω[°] | 34.0 | 19.4 | 12.5 |
| DD[5] | 0.95 | 25.29 | 35.85 |
| DD[12] | 19.35 | 12.85 | 1.10 |
| DD[17] | 20.82 | 2.98 | 4.16 |
| DD[25] | 2.82 | 1.63 | 1.78 |
| DD[28] | 10.47 | 11.66 | 11.52 |

TABLE 18
Example 6

| Sn | 18 | 19 | 24 |
|---|---|---|---|
| KA | 1.0000000E+00 | 1.0000000E+00 | 1.0000000E+00 |
| A4 | −8.7226161E−07 | 4.3152273E−08 | −6.3781872E−06 |
| A6 | 3.7978491E−09 | 8.5329150E−10 | −4.3912501E−08 |
| A8 | −7.2963060E−11 | −3.3834358E−11 | 6.0464991E−10 |
| A10 | 3.3479281E−13 | 1.0669572E−13 | −4.4478980E−12 |
| A12 | −1.4571986E−15 | −9.8463093E−16 | 1.0036914E−14 |

| Sn | 25 | 29 |
|---|---|---|
| KA | 1.0000000E+00 | 1.0000000E+00 |
| A4 | −1.1307512E−06 | 2.2701007E−06 |
| A6 | −3.5538515E−08 | 4.3260915E−08 |
| A8 | 6.0017632E−10 | −7.2043980E−10 |
| A10 | −4.8747066E−12 | 7.2024175E−12 |
| A12 | 1.2566552E−14 | −3.4074464E−14 |

### Example 7

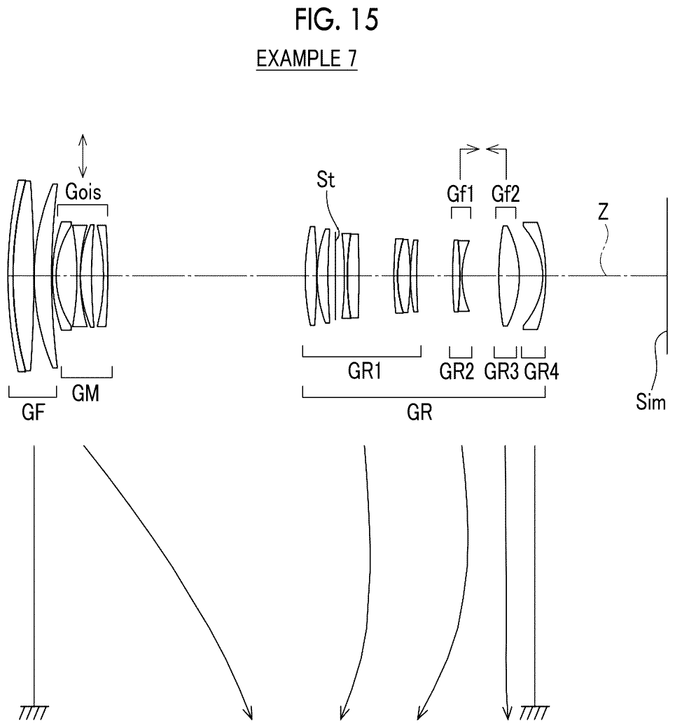

A configuration and a movement trajectory of a variable magnification optical system according to Example 7 are shown in FIG. 15. The variable magnification optical system according to Example 7 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power.

During magnification change from the wide angle end to the telephoto end, the front group GF and the fourth subsequent lens group GR4 are fixed with respect to the image plane Sim, and the intermediate group GM, the first subsequent lens group GR1, the second subsequent lens group GR2, and the third subsequent lens group GR3 move by changing the spacings between the adjacent lens groups. The variable magnification optical system according to Example 7 includes two focusing groups, that is, the first focusing group Gf1 and the second focusing group Gf2. The first focusing group Gf1 consists of the second subsequent lens group GR2. The second focusing group Gf2 consists of the third subsequent lens group GR3. The anti-vibration group Gois consists of the intermediate group GM.

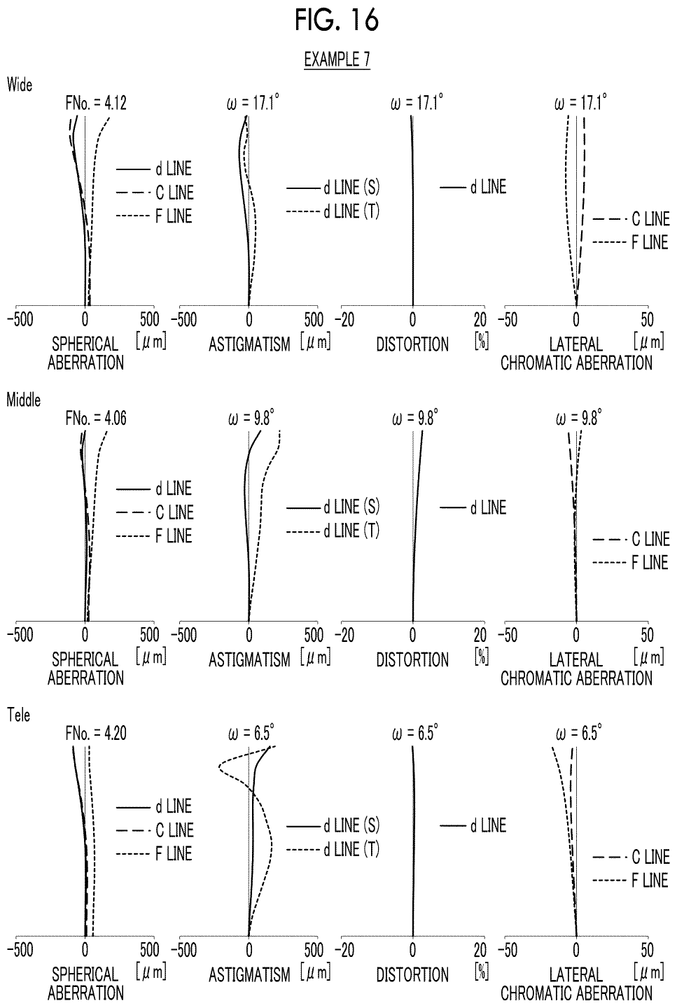

For the variable magnification optical system according to Example 7, basic lens data is shown in Table 19, specifications and variable surface spacings are shown in Table 20, aspherical coefficients are shown in Table 21, and each aberration diagram is shown in FIG. 16.

TABLE 19
Example 7

| | | Sn | R | D | Nd | νd | θgF | ρ |
|---|---|---|---|---|---|---|---|---|
| | GF | 1 | 130.4534 | 1.3527 | 1.94269 | 20.89 | 0.63932 | 3.86 |
| | | 2 | 105.9516 | 5.6043 | 1.43875 | 94.66 | 0.53402 | 3.59 |
| | | 3 | −383.5326 | 0.1000 | | | | |
| | | 4 | 67.7378 | 4.6646 | 1.43875 | 94.66 | 0.53402 | 3.59 |
| | | 5 | 212.3102 | DD[5] | | | | |
| Gois | GM | 6 | 48.5086 | 1.0000 | 1.99057 | 21.59 | 0.63751 | |
| | | 7 | 26.4585 | 5.5714 | | | | |
| | | 8 | −87.3668 | 0.8750 | 1.43986 | 89.40 | 0.53127 | |
| | | 9 | 54.9151 | 0.0502 | | | | |
| | | 10 | 38.1398 | 3.0104 | 1.98599 | 19.00 | 0.65214 | |
| | | 11 | 154.0074 | 3.2002 | | | | |
| | | 12 | −60.1436 | 1.1685 | 1.79571 | 38.95 | 0.57573 | |
| | | 13 | −180.0994 | DD[13] | | | | |
| | GR1 | 14 | 68.8686 | 3.0810 | 1.62714 | 61.60 | 0.54351 | |
| | | 15 | −163.6859 | 0.1000 | | | | |
| | | 16 | 39.3151 | 2.9309 | 1.58838 | 67.66 | 0.54243 | |
| | | 17 | 178.5090 | 2.0059 | | | | |
| | | 18(St) | ∞ | 2.2645 | | | | |
| | | 19 | −108.3861 | 0.7737 | 1.70039 | 29.98 | 0.60398 | |
| | | 20 | 75.5514 | 3.1032 | 1.43875 | 94.66 | 0.53402 | |
| | | 21 | −375.5543 | 9.4273 | | | | |
| | | 22 | 109.4545 | 0.9999 | 1.90708 | 31.81 | 0.59316 | |
| | | 23 | 35.7735 | 3.3949 | 1.49127 | 56.64 | 0.54967 | |
| | | 24 | −76.3554 | 0.0485 | | | | |
| | | *25 | 54.0478 | 1.6854 | 1.57534 | 40.87 | 0.57774 | |
| | | *26 | 177.7487 | DD[26] | | | | |
| Gf1 | GR2 | 27 | 110.3899 | 1.9661 | 1.90800 | 19.60 | 0.64470 | |
| | | 28 | −103.7446 | 0.5768 | 1.88300 | 39.22 | 0.57288 | |
| | | 29 | 25.8521 | DD[29] | | | | |
| Gf2 | GR3 | 30 | 83.7730 | 5.5213 | 1.59374 | 58.95 | 0.54359 | |
| | | 31 | −31.7628 | DD[31] | | | | |
| | GR4 | *32 | −19.3962 | 0.8030 | 1.67798 | 54.89 | 0.54485 | |
| | | *33 | −56.5479 | 32.6100 | | | | |

TABLE 20
Example 7

| | Wide | Middle | Tele |
|---|---|---|---|
| Zr | 1.0 | 1.7 | 2.7 |
| f | 70.53 | 122.24 | 189.80 |
| Bf | 32.61 | 32.61 | 32.61 |
| FNo. | 4.12 | 4.06 | 4.20 |
| 2ω[°] | 34.2 | 19.6 | 13.0 |
| DD[5] | 0.25 | 29.02 | 45.42 |
| DD[13] | 53.08 | 25.39 | 1.50 |
| DD[26] | 9.65 | 8.98 | 4.21 |
| DD[29] | 9.88 | 9.77 | 22.46 |
| DD[31] | 6.30 | 6.01 | 5.57 |

TABLE 21
Example 7

| Sn | 25 | 26 |
|---|---|---|
| KA | 1.0000000E+00 | 1.0000000E+00 |
| A3 | 0.0000000E+00 | 0.0000000E+00 |
| A4 | −3.7473935E−06 | −1.5414799E−06 |
| A5 | −1.0836600E−07 | −9.4740905E−08 |
| A6 | 1.1970165E−08 | −5.5494267E−09 |
| A7 | −1.8940270E−09 | 4.0156586E−10 |
| A8 | −1.2519204E−11 | −2.7215422E−11 |
| A9 | 4.1491882E−12 | −1.3786909E−11 |
| A10 | −1.5260816E−13 | 9.0918210E−13 |
| Sr | 32 | 33 |
| KA | 0.0000000E+00 | 1.0000000E+00 |
| A3 | 0.0000000E+00 | 0.0000000E+00 |
| A4 | −5.8240849E−06 | −2.3327133E−06 |
| A5 | 5.9826989E−07 | −6.0206015E−08 |
| A6 | −8.4847276E−08 | −6.0643913E−09 |
| A7 | 9.3570654E−10 | −1.4568092E−10 |
| A8 | 6.8392328E−10 | −2.6905551E−12 |
| A9 | −5.8951898E−11 | −2.9424569E−14 |
| A10 | 1.6377188E−12 | 8.7156510E−15 |
| A11 | −6.4914553E−14 | 1.3433097E−17 |
| A12 | 8.7314909E−15 | −1.7325977E−17 |
| A13 | −4.6032804E−16 | −3.3349292E−18 |
| A14 | −1.0511852E−16 | −5.4038438E−19 |
| A15 | 5.6259192E−18 | −3.3298039E−20 |
| A16 | 1.0371653E−18 | −1.4856529E−21 |
| A17 | −3.8883264E−20 | −1.5199472E−22 |
| A18 | −3.1549116E−21 | −4.3748505E−24 |
| A19 | −4.4772148E−23 | 6.1190835E−25 |
| A20 | 1.0518329E−23 | 1.1535708E−25 |

### Example 8

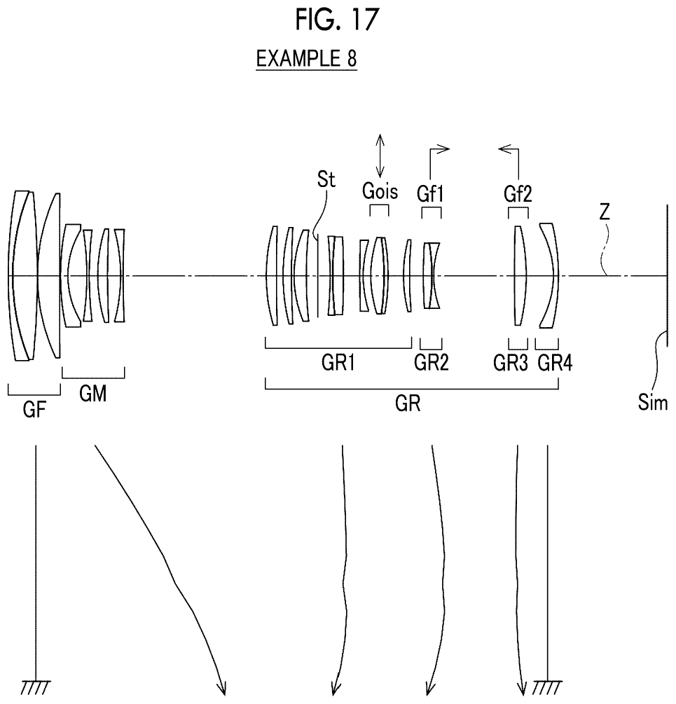

A configuration and a movement trajectory of a variable magnification optical system according to Example 8 are shown in FIG. 17. The variable magnification optical system according to Example 8 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power.

During magnification change from the wide angle end to the telephoto end, the front group GF and the fourth subsequent lens group GR4 are fixed with respect to the image plane Sim, and the intermediate group GM, the first subsequent lens group GR1, the second subsequent lens group GR2, and the third subsequent lens group GR3 move by changing the spacings between the adjacent lens groups. The variable magnification optical system according to Example 8 includes two focusing groups, that is, the first focusing group Gf1 and the second focusing group Gf2. The first focusing group Gf1 consists of the second subsequent lens group GR2. The second focusing group Gf2 consists of the third subsequent lens group GR3. The anti-vibration group Gois consists of a second lens and a third lens of the first subsequent lens group GR1 from the image side.

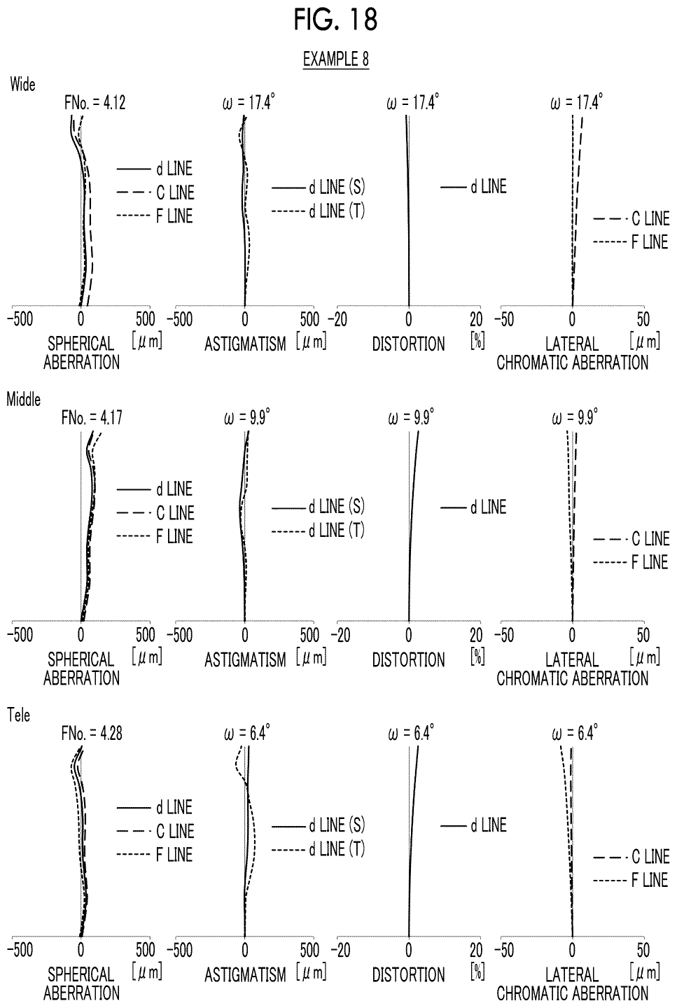

For the variable magnification optical system according to Example 8, basic lens data is shown in Table 22, specifications and variable surface spacings are shown in Table 23, aspherical coefficients are shown in Table 24, and each aberration diagram is shown in FIG. 18.

TABLE 22
Example 8

| | | Sn | R | D | Nd | νd | θgF | ρ |
|---|---|---|---|---|---|---|---|---|
| | GF | 1 | 160.7693 | 1.3124 | 1.88725 | 40.13 | 0.56993 | 5.00 |
| | | 2 | 71.2859 | 7.2663 | 1.48255 | 83.81 | 0.53605 | 3.44 |
| | | 3 | −265.4517 | 0.0499 | | | | |
| | | 4 | 61.3239 | 6.5442 | 1.44146 | 90.07 | 0.53189 | 3.13 |
| | | 5 | 5951.1180 | DD[5] | | | | |
| | GM | 6 | 77.8549 | 2.1767 | 1.65544 | 58.08 | 0.54302 | |
| | | 7 | 27.7429 | 5.5900 | | | | |
| | | 8 | −94.9624 | 0.7220 | 1.70492 | 57.47 | 0.54233 | |
| | | 9 | 119.7046 | 2.5164 | | | | |
| | | 10 | 50.7695 | 2.8976 | 1.89624 | 25.91 | 0.61381 | |
| | | 11 | 320.8118 | 3.8437 | | | | |
| | | 12 | −56.1556 | 0.7333 | 1.51465 | 78.92 | 0.53853 | |
| | | 13 | 307.0189 | DD[13] | | | | |
| | GR1 | 14 | 56.7298 | 3.0071 | 1.53533 | 48.38 | 0.56390 | |
| | | 15 | 545.9116 | 1.9599 | | | | |
| | | 16 | 62.8278 | 2.4786 | 1.48159 | 83.95 | 0.53595 | |
| | | 17 | 278.5933 | 0.7703 | | | | |
| | | 18 | 37.5321 | 3.5994 | 1.44753 | 89.14 | 0.53251 | |
| | | 19 | 135.8887 | 3.3889 | | | | |
| | | 20(St) | ∞ | 3.6450 | | | | |
| | | 21 | −125.1418 | 0.7500 | 1.62541 | 45.65 | 0.56615 | |
| | | 22 | 109.7705 | 3.0099 | 1.59090 | 67.26 | 0.54256 | |
| | | 23 | −272.1996 | 4.8363 | | | | |
| | | 24 | 345.1341 | 1.0002 | 1.96010 | 24.52 | 0.62006 | |
| | | 25 | 36.5767 | 2.2498 | | | | |
| Gois | | *26 | 36.9712 | 3.9013 | 1.51651 | 78.64 | 0.53863 | |
| | | 27 | −86.9277 | 1.1910 | 1.81744 | 47.27 | 0.55575 | |
| | | 28 | −71.5244 | 4.5520 | | | | |
| | | 29 | 45.8806 | 1.7934 | 1.66280 | 42.71 | 0.57101 | |
| | | 30 | 130.6196 | DD[30] | | | | |
| Gf1 | GR2 | 31 | 174.8200 | 2.5378 | 1.90698 | 22.81 | 0.62887 | |
| | | 32 | −63.3059 | 0.5323 | 1.76436 | 42.04 | 0.56916 | |
| | | 33 | 29.7863 | DD[33] | | | | |
| Gf2 | GR3 | 34 | 525.1652 | 3.4873 | 1.77535 | 50.30 | 0.55004 | |
| | | 35 | −67.0629 | DD[35] | | | | |
| | GR4 | *36 | −27.9412 | 1.4791 | 1.53373 | 76.01 | 0.53957 | |
| | | 37 | −70.0136 | 32.1500 | | | | |

TABLE 23
Example 8

| | Wide | Middle | Tele |
|---|---|---|---|
| Zr | 1.0 | 1.7 | 2.7 |
| f | 69.51 | 120.47 | 187.04 |
| Bf | 32.15 | 32.15 | 32.15 |
| FNo. | 4.12 | 4.17 | 4.28 |
| 2ω[°] | 34.8 | 19.8 | 12.8 |
| DD[5] | 0.25 | 23.99 | 38.55 |
| DD[13] | 42.27 | 18.71 | 1.40 |
| DD[30] | 4.07 | 7.05 | 5.25 |
| DD[33] | 23.82 | 20.61 | 26.90 |
| DD[35] | 8.04 | 8.09 | 6.35 |

TABLE 24
Example 8

| Sn | 26 | 36 |
|---|---|---|
| KA | 0.0000000E+00 | 0.0000000E+00 |
| A3 | 0.0000000E+00 | 0.0000000E+00 |
| A4 | −6.1150257E−06 | 1.7342925E−06 |
| A5 | 1.2374648E−06 | −2.9473612E−07 |
| A6 | −2.2925763E−07 | 6.1825489E−08 |
| A7 | 1.6038388E−08 | −3.2200645E−09 |
| A8 | −4.6310827E−11 | 1.4182520E−11 |
| A9 | 1.0951366E−10 | −2.1910856E−11 |
| A10 | −3.6202574E−11 | 1.9423498E−12 |
| A11 | 3.2618877E−12 | 3.3856996E−14 |
| A12 | −1.5512133E−13 | 6.0799683E−15 |
| A13 | 2.1661284E−14 | −4.4091352E−16 |
| A14 | −1.5157984E−15 | −1.0687597E−16 |
| A15 | −6.9706722E−17 | 1.7348422E−18 |
| A16 | −1.4931255E−17 | 6.8006181E−19 |
| A17 | 3.0025747E−18 | −1.2045722E−20 |
| A18 | 1.2571224E−19 | −1.4319271E−21 |
| A19 | −3.3775823E−20 | 1.4331340E−23 |
| A20 | 1.2432191E−21 | 1.2644659E−24 |

### Example 9

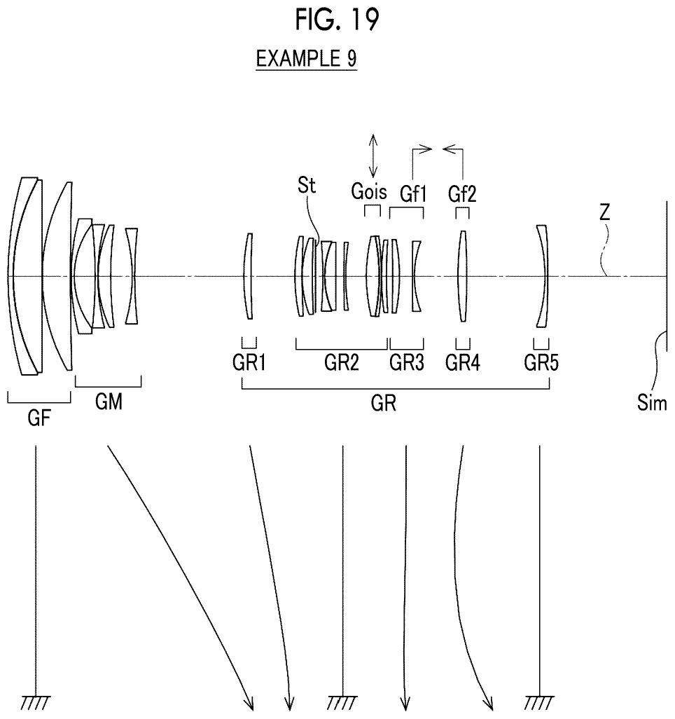

A configuration and a movement trajectory of a variable magnification optical system according to Example 9 are shown in FIG. 19. The variable magnification optical system according to Example 9 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power.

During magnification change from the wide angle end to the telephoto end, the front group GF, the second subsequent lens group GR2, and the fifth subsequent lens group GR5 are fixed with respect to the image plane Sim, and the intermediate group GM, the first subsequent lens group GR1, the third subsequent lens group GR3, and the fourth subsequent lens group GR4 move by changing the spacings between the adjacent lens groups. The variable magnification optical system according to Example 9 includes two focusing groups, that is, the first focusing group Gf1 and the second focusing group Gf2. The first focusing group Gf1 consists of the third subsequent lens group GR3. The second focusing group Gf2 consists of the fourth subsequent lens group GR4. The anti-vibration group Gois consists of a second lens and a third lens of the second subsequent lens group GR2 from the image side.

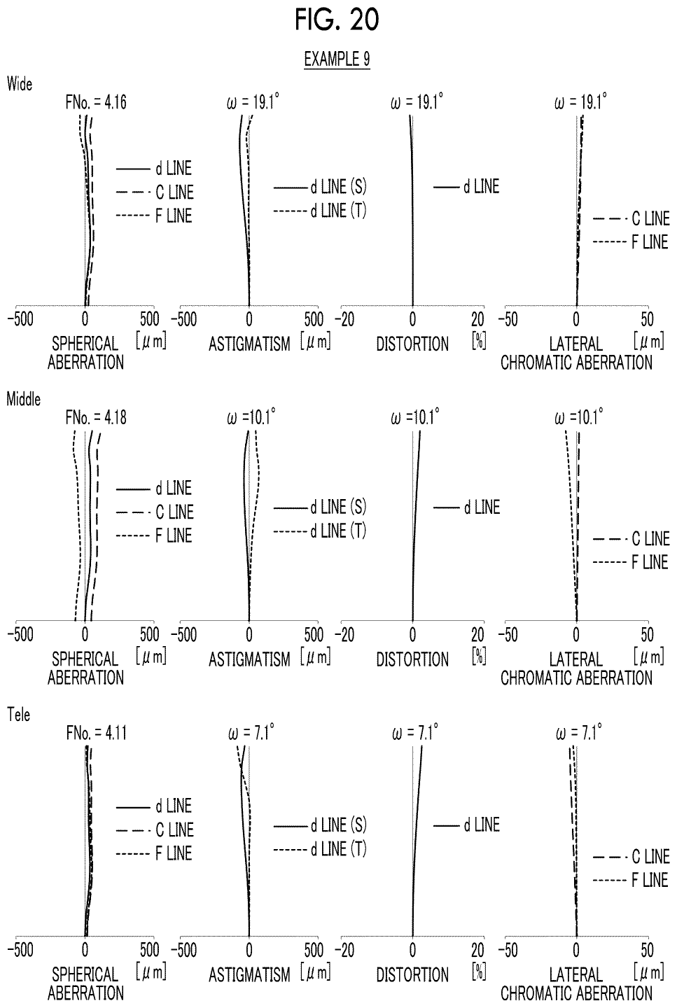

For the variable magnification optical system according to Example 9, basic lens data is shown in Table 25, specifications and variable surface spacings are shown in Table 26, aspherical coefficients are shown in Table 27, and each aberration diagram is shown in FIG. 20.

TABLE 25
Example 9

| | | Sn | R | D | Nd | νd | θgF | ρ |
|---|---|---|---|---|---|---|---|---|
| | GF | 1 | 108.4565 | 1.4248 | 1.86135 | 42.78 | 0.56411 | 4.82 |
| | | 2 | 60.1870 | 8.0639 | 1.47863 | 84.41 | 0.53565 | 3.41 |
| | | 3 | 10978.1309 | 0.0468 | | | | |
| | | 4 | 56.2889 | 7.8978 | 1.46013 | 87.22 | 0.53378 | 3.23 |
| | | 5 | 1061.3979 | DD[5] | | | | |
| | GM | 6 | 67.0258 | 0.8555 | 1.77535 | 50.30 | 0.55004 | |
| | | 7 | 25.5178 | 5.8258 | | | | |
| | | 8 | −143.5052 | 0.7735 | 1.48468 | 81.55 | 0.53529 | |
| | | 9 | 61.6752 | 0.0442 | | | | |
| | | 10 | 35.7028 | 3.5286 | 1.82074 | 29.88 | 0.60136 | |
| | | 11 | 122.9097 | 5.9870 | | | | |
| | | 12 | −51.3570 | 0.7141 | 1.47251 | 85.06 | 0.53490 | |
| | | 13 | 128.6112 | DD[13] | | | | |
| | GR1 | 14 | 62.1053 | 2.0209 | 1.91953 | 32.64 | 0.59021 | |
| | | 15 | 261.9771 | DD[15] | | | | |
| | GR2 | 16 | 55.0060 | 1.9838 | 1.51797 | 78.41 | 0.53871 | |
| | | 17 | 196.9715 | 0.0476 | | | | |
| | | 18 | 32.3265 | 2.8298 | 1.54513 | 74.28 | 0.54017 | |
| | | 19 | 209.3184 | 0.8784 | | | | |
| | | 20(St) | ∞ | 2.0578 | | | | |
| | | 21 | −121.0034 | 0.5258 | 1.89828 | 39.00 | 0.57275 | |
| | | 22 | 26.2633 | 3.0516 | 1.49432 | 82.01 | 0.53724 | |
| | | 23 | 718.0657 | 2.1372 | | | | |
| | | 24 | 359.0249 | 0.5130 | 1.96766 | 17.79 | 0.65849 | |
| | | 25 | 68.9479 | 5.7292 | | | | |
| Gois | | *26 | 48.1107 | 3.6082 | 1.54634 | 74.09 | 0.54023 | |
| | | 27 | −60.1765 | 0.5956 | 1.86778 | 25.58 | 0.61546 | |
| | | 28 | −95.4826 | 0.0447 | | | | |
| | | 29 | 77.4926 | 1.3898 | 1.84065 | 40.06 | 0.57151 | |
| | | 30 | 154.6071 | DD[30] | | | | |
| Gf1 | GR3 | 31 | −358.4777 | 1.8623 | 1.98278 | 20.34 | 0.64379 | |
| | | 32 | −60.6135 | 3.6490 | | | | |
| | | 33 | 764.8967 | 0.5300 | 1.59852 | 48.25 | 0.56176 | |
| | | 34 | 29.3552 | DD[34] | | | | |
| Gf2 | GR4 | 35 | 90.6531 | 2.4330 | 1.77535 | 50.30 | 0.55004 | |
| | | 36 | −217.6085 | DD[36] | | | | |
| | GR5 | *37 | −53.9264 | 0.7579 | 1.61881 | 63.85 | 0.54182 | |
| | | *38 | −1333.7353 | 33.2800 | | | | |

TABLE 26
Example 9

| | Wide | Middle | Tele |
|---|---|---|---|
| Zr | 1.0 | 1.9 | 2.7 |
| f | 63.00 | 118.94 | 169.53 |
| Bf | 33.28 | 33.28 | 33.28 |
| FNo. | 4.16 | 4.18 | 4.11 |
| 2ω[°] | 38.2 | 20.2 | 14.2 |
| DD[5] | 0.20 | 27.87 | 40.71 |
| DD[13] | 30.46 | 11.11 | 1.10 |
| DD[15] | 12.25 | 3.92 | 1.10 |
| DD[30] | 1.74 | 1.21 | 1.61 |
| DD[34] | 12.18 | 11.58 | 20.48 |
| DD[36] | 21.84 | 22.97 | 13.67 |

TABLE 27
Example 9

| Sn | 26 | 37 | 38 |
|---|---|---|---|
| KA | 0.0000000E+00 | 0.0000000E+00 | 1.0000000E+00 |
| A4 | −3.9914996E−06 | −1.0710926E−05 | −1.0742814E−05 |
| A6 | 2.7998165E−08 | 3.2803996E−09 | 1.1456634E−09 |
| A8 | −7.0612433E−10 | 1.8005887E−11 | 6.4767552E−11 |
| A10 | 1.2071466E−11 | 3.7827010E−13 | −9.6320924E−14 |
| A12 | −1.3705322E−13 | −3.2506269E−15 | −1.4519383E−15 |
| A14 | 1.0611183E−15 | −4.3325202E−18 | −4.3903805E−18 |
| A16 | −5.4084821E−18 | 5.1242829E−20 | 6.8729984E−20 |
| A18 | 1.6224023E−20 | 1.6955525E−22 | −1.1286350E−22 |
| A20 | −2.1717994E−23 | −9.9546789E−25 | −1.8434991E−25 |

### Example 10

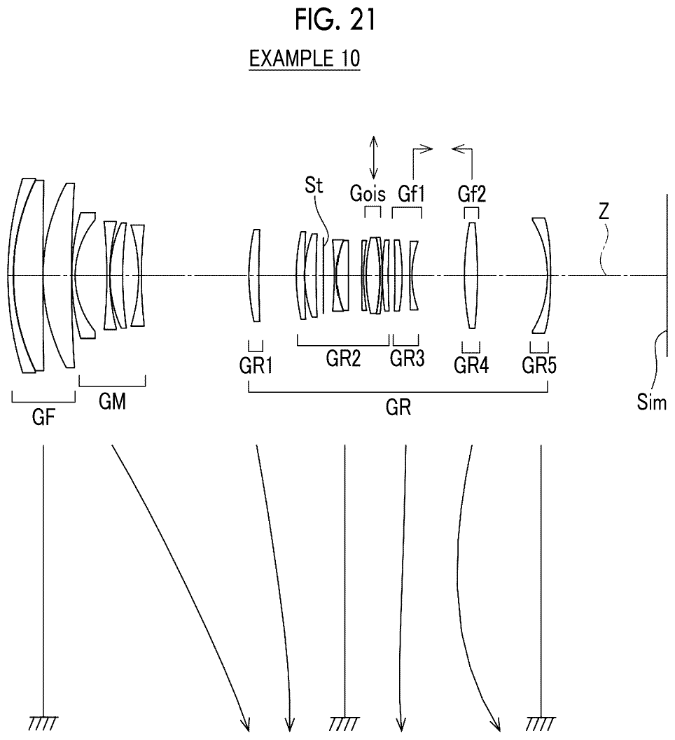

A configuration and a movement trajectory of a variable magnification optical system according to Example 10 are shown in FIG. 21. The variable magnification optical system according to Example 10 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power.

During magnification change from the wide angle end to the telephoto end, the front group GF, the second subsequent lens group GR2, and the fifth subsequent lens group GR5 are fixed with respect to the image plane Sim, and the intermediate group GM, the first subsequent lens group GR1, the third subsequent lens group GR3, and the fourth subsequent lens group GR4 move by changing the spacings between the adjacent lens groups. The variable magnification optical system according to Example 10 includes two focusing groups, that is, the first focusing group Gf1 and the second focusing group Gf2. The first focusing group Gf1 consists of the third subsequent lens group GR3. The second focusing group Gf2 consists of the fourth subsequent lens group GR4. The anti-vibration group Gois consists of a second lens and a third lens of the second subsequent lens group GR2 from the image side.

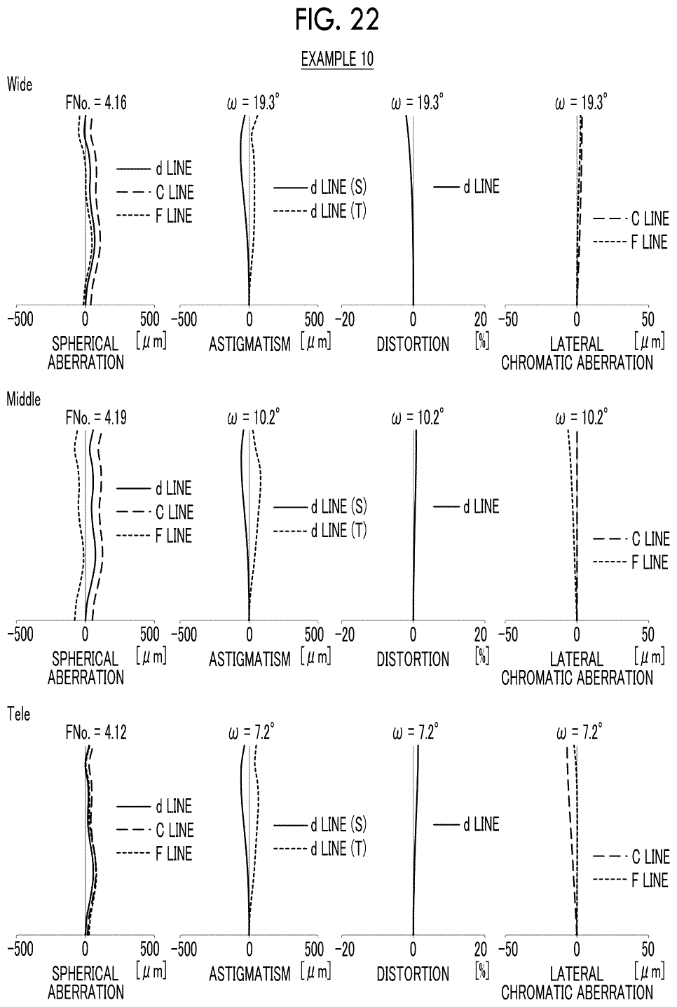

For the variable magnification optical system according to Example 10, basic lens data is shown in Table 28, specifications and variable surface spacings are shown in Table 29, aspherical coefficients are shown in Table 30, and each aberration diagram is shown in FIG. 22.

TABLE 28
Example 10

| | | Sn | R | D | Nd | νd | θgF | ρ |
|---|---|---|---|---|---|---|---|---|
| | GF | 1 | 90.8990 | 1.3995 | 1.92349 | 33.37 | 0.58798 | 5.19 |
| | | 2 | 60.2043 | 7.6279 | 1.50737 | 80.03 | 0.53812 | 3.56 |
| | | 3 | 1717.2292 | 0.0423 | | | | |
| | | 4 | 53.8256 | 7.2929 | 1.45597 | 87.86 | 0.53336 | 3.18 |
| | | 5 | 385.6870 | DD[5] | | | | |
| | GM | 6 | 63.1448 | 0.8654 | 1.73429 | 46.08 | 0.56138 | |
| | | 7 | 24.3483 | 8.1624 | | | | |
| | | 8 | −153.0784 | 0.7548 | 1.53110 | 58.20 | 0.54573 | |
| | | 9 | 60.5009 | 0.0441 | | | | |
| | | 10 | 35.3254 | 3.2936 | 1.82586 | 23.71 | 0.62054 | |
| | | 11 | 105.0732 | 4.0964 | | | | |
| | | 12 | −47.4959 | 0.7242 | 1.50408 | 80.53 | 0.53794 | |
| | | 13 | 122.3784 | DD[13] | | | | |
| | GR1 | 14 | 59.1282 | 2.5509 | 1.92319 | 36.46 | 0.57918 | |
| | | 15 | 336.9672 | DD[15] | | | | |
| | GR2 | 16 | 55.1848 | 2.1596 | 1.53995 | 75.07 | 0.53990 | |
| | | 17 | 253.5274 | 0.0454 | | | | |
| | | 18 | 33.3791 | 2.9259 | 1.56084 | 71.88 | 0.54099 | |
| | | 19 | 243.4765 | 1.8849 | | | | |
| | | 20(St) | ∞ | 2.7799 | | | | |
| | | 21 | −112.8579 | 0.5078 | 1.91285 | 35.32 | 0.58271 | |
| | | 22 | 26.5866 | 2.9709 | 1.48492 | 83.45 | 0.53629 | |
| | | 23 | 10772.7047 | 3.4631 | | | | |
| | | 24 | 385.1691 | 0.5063 | 1.99999 | 15.00 | 0.67771 | |
| | | 25 | 61.9426 | 0.6450 | | | | |
| Gois | | *26 | 43.9045 | 3.5551 | 1.54782 | 73.87 | 0.54031 | |
| | | 27 | −55.1680 | 0.5661 | 1.83085 | 34.85 | 0.58629 | |
| | | 28 | −95.8939 | 0.0467 | | | | |
| | | 29 | 71.3754 | 1.5046 | 1.84989 | 26.88 | 0.61036 | |
| | | 30 | 210.1558 | DD[30] | | | | |
| Gf1 | GR3 | 31 | −345.7133 | 1.8642 | 1.97508 | 16.25 | 0.66852 | |
| | | 32 | −62.0262 | 1.9867 | | | | |
| | | 33 | 315.2703 | 0.5749 | 1.58517 | 62.21 | 0.54194 | |
| | | 34 | 27.4508 | DD[34] | | | | |
| Gf2 | GR4 | 35 | 76.6920 | 3.3379 | 1.59962 | 57.55 | 0.54504 | |
| | | 36 | −160.3423 | DD[36] | | | | |
| | GR5 | *37 | −33.0039 | 0.8371 | 1.43599 | 90.90 | 0.53134 | |
| | | *38 | −144.3719 | 30.0000 | | | | |

TABLE 29
Example 10

| | Wide | Middle | Tele |
|---|---|---|---|
| Zr | 1.0 | 1.9 | 2.7 |
| f | 62.99 | 118.92 | 169.49 |
| Bf | 30.00 | 30.00 | 30.00 |
| FNo. | 4.16 | 4.19 | 4.12 |
| 2ω[°] | 38.6 | 20.4 | 14.4 |
| DD[5] | 0.10 | 24.39 | 35.29 |
| DD[13] | 27.74 | 10.54 | 1.09 |
| DD[15] | 9.63 | 2.53 | 1.09 |
| DD[30] | 1.72 | 0.33 | 0.60 |
| DD[34] | 13.51 | 12.14 | 21.81 |
| DD[36] | 18.05 | 20.81 | 10.87 |

TABLE 30
Example 10

| Sn | 26 | 37 | 38 |
|---|---|---|---|
| KA | 0.0000000E+00 | 0.0000000E+00 | 1.0000000E+00 |
| A4 | −5.7902508E−06 | −1.0493783E−05 | −1.1881762E−05 |
| A6 | 9.4059887E−08 | 4.6628075E−09 | −3.4898681E−09 |
| A8 | −2.2775309E−09 | −2.9683942E−11 | 5.7224069E−11 |
| A10 | 2.4222381E−11 | 4.1164669E−13 | −1.7766692E−13 |
| A12 | −4.5062559E−14 | −3.3147361E−15 | −1.3387822E−15 |
| A14 | 3.1260189E−16 | −6.8759945E−18 | −4.4988815E−18 |
| A16 | −3.0377922E−17 | 4.3847292E−20 | 6.5971857E−20 |
| A18 | 3.4078703E−19 | 3.2017834E−22 | −9.9616114E−23 |
| A20 | −1.1208149E−21 | −1.2029694E−24 | −1.1310963E−25 |

### Example 11

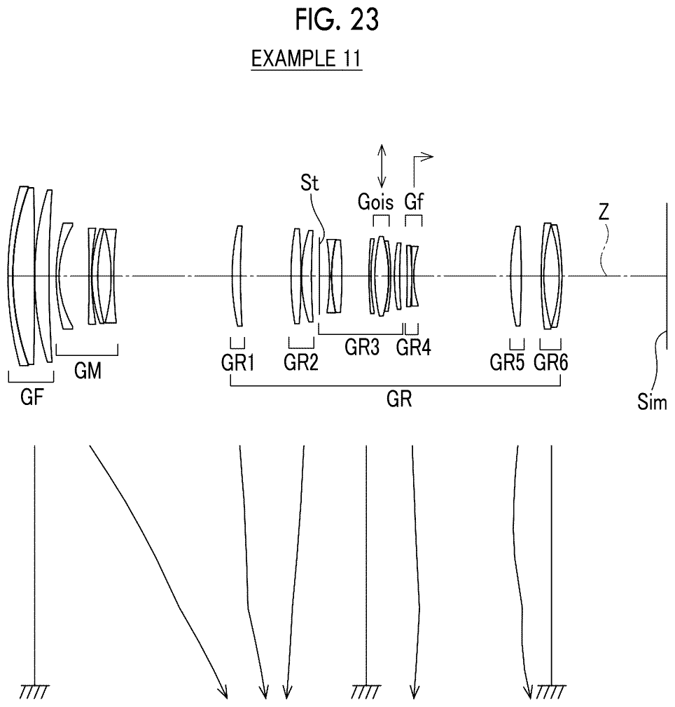

A configuration and a movement trajectory of a variable magnification optical system according to Example 11 are shown in FIG. 23. The variable magnification optical system according to Example 11 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a positive refractive power, the fourth subsequent lens group GR4 having a negative refractive power, the fifth subsequent lens group GR5 having a positive refractive power, and the sixth subsequent lens group GR6 having a negative refractive power.

During magnification change from the wide angle end to the telephoto end, the front group GF, the third subsequent lens group GR3, and the sixth subsequent lens group GR6 are fixed with respect to the image plane Sim, and the intermediate group GM, the first subsequent lens group GR1, the second subsequent lens group GR2, the fourth subsequent lens group GR4, and the fifth subsequent lens group GR5 move by changing the spacings between the adjacent lens groups. The variable magnification optical system according to Example 11 includes only one focusing group Gf. The focusing group Gf consists of the fourth subsequent lens group GR4. The anti-vibration group Gois consists of a second lens and a third lens of the third subsequent lens group GR3 from the image side.

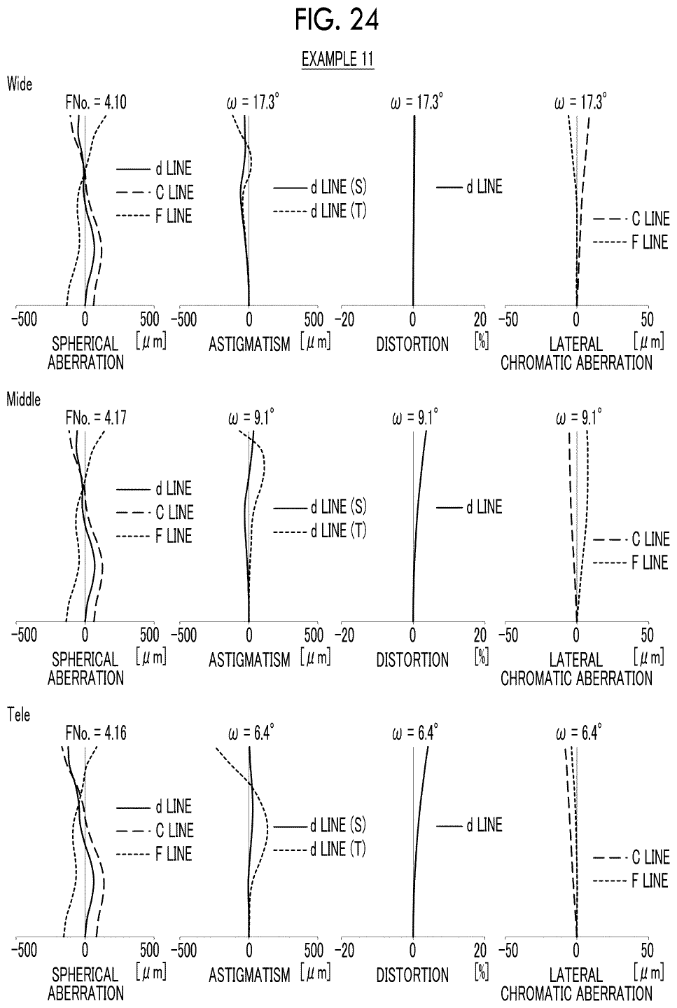

For the variable magnification optical system according to Example 11, basic lens data is shown in Table 31, specifications and variable surface spacings are shown in Table 32, aspherical coefficients are shown in Table 33, and each aberration diagram is shown in FIG. 24.

TABLE 31
Example 11

| | | Sn | R | D | Nd | νd | θgF | ρ |
|---|---|---|---|---|---|---|---|---|
| | GF | 1 | 106.8586 | 1.4122 | 1.94294 | 21.01 | 0.63877 | 3.88 |
| | | 2 | 81.2807 | 6.3176 | 1.51226 | 79.28 | 0.53839 | 3.57 |
| | | 3 | −1479.7921 | 0.0517 | | | | |
| | | 4 | 92.9758 | 4.1504 | 1.47856 | 84.42 | 0.53565 | 3.41 |
| | | 5 | 377.8849 | DD[5] | | | | |
| | GM | 6 | 64.0395 | 0.8501 | 1.58966 | 60.14 | 0.54290 | |
| | | 7 | 31.2521 | 8.7218 | | | | |
| | | 8 | −731.3968 | 0.7528 | 1.49443 | 69.34 | 0.53119 | |
| | | 9 | 86.8667 | 0.0949 | | | | |
| | | 10 | 44.2450 | 1.6820 | 1.89584 | 20.21 | 0.64050 | |
| | | 11 | 56.1932 | 3.9014 | | | | |
| | | 12 | −57.6517 | 0.7516 | 1.53497 | 75.82 | 0.53963 | |
| | | 13 | 137.4175 | DD[13] | | | | |
| | GR1 | 14 | 72.6930 | 2.4202 | 2.00000 | 15.45 | 0.67488 | |
| | | 15 | 252.2017 | DD[15] | | | | |
| | GR2 | 16 | 91.2858 | 2.9194 | 1.53976 | 75.09 | 0.53989 | |
| | | 17 | −209.7781 | 0.1510 | | | | |
| | | 18 | 45.7069 | 2.8895 | 1.59006 | 67.39 | 0.54251 | |
| | | 19 | 205.8244 | DD[19] | | | | |
| | GR3 | 20(St) | ∞ | 2.9942 | | | | |
| | | 21 | −80.3310 | 0.5852 | 1.91308 | 19.35 | 0.64645 | |
| | | 22 | 51.2142 | 2.8273 | 1.51699 | 78.56 | 0.53865 | |
| | | 23 | −133.9390 | 7.9012 | | | | |
| | | 24 | 144.0243 | 0.5637 | 1.83882 | 26.61 | 0.61174 | |
| | | 25 | 64.0630 | 1.1298 | | | | |
| Gois | | *26 | 53.4265 | 4.0404 | 1.63547 | 60.88 | 0.54339 | |
| | | 27 | −44.5855 | 0.5951 | 1.45355 | 88.22 | 0.53312 | |
| | | 28 | −73.4744 | 1.0618 | | | | |
| | | 29 | 60.8452 | 1.5213 | 1.83187 | 23.80 | 0.62014 | |
| | | 30 | 126.8345 | DD[30] | | | | |
| Gf | GR4 | 31 | −337.3182 | 1.3535 | 1.90229 | 19.89 | 0.64273 | |
| | | 32 | −109.0119 | 0.0446 | | | | |
| | | 33 | −579.2569 | 0.5323 | 1.80548 | 48.50 | 0.55338 | |
| | | 34 | 30.8123 | DD[34] | | | | |
| | GR5 | 35 | 72.9757 | 3.0940 | 1.77299 | 26.35 | 0.61393 | |
| | | 36 | −299.9834 | DD[36] | | | | |
| | GR6 | *37 | 139.6827 | 0.8069 | 1.61321 | 63.77 | 0.54382 | |
| | | 38 | 58.4053 | 4.4403 | | | | |
| | | 39 | −51.8717 | 0.7948 | 1.74821 | 54.36 | 0.54439 | |
| | | 40 | −82.6115 | 30.5500 | | | | |

TABLE 32
Example 11

| | Wide | Middle | Tele |
|---|---|---|---|
| Zr | 1.0 | 1.9 | 2.7 |
| f | 69.00 | 130.29 | 185.67 |
| Bf | 30.55 | 30.55 | 30.55 |
| FNo. | 4.10 | 4.17 | 4.16 |
| 2ω[°] | 34.7 | 18.2 | 12.8 |
| DD[5] | 2.10 | 28.22 | 42.07 |
| DD[13] | 34.47 | 10.73 | 2.07 |
| DD[15] | 14.70 | 8.97 | 2.10 |
| DD[19] | 2.29 | 5.63 | 7.29 |
| DD[30] | 2.17 | 4.27 | 2.68 |
| DD[34] | 28.20 | 27.43 | 31.42 |
| DD[36] | 5.78 | 4.48 | 2.09 |

TABLE 33
Example 11

| Sn | 26 | 37 |
|---|---|---|
| KA | 1.0000000E+00 | 1.0000000E+00 |
| A4 | −4.3272852E−06 | 3.7499667E−07 |
| A6 | 5.6098817E−08 | −3.1249599E−09 |
| A8 | −1.2415348E−09 | 5.4980918E−11 |
| A10 | 1.1520486E−11 | −2.3237727E−13 |
| A12 | 1.4134507E−15 | −6.3636512E−16 |
| A14 | −7.8860321E−16 | 9.4319780E−18 |
| A16 | 4.6739169E−18 | −3.2916462E−20 |
| A18 | −3.2718657E−21 | 4.4573553E−23 |
| A20 | −2.6675799E−23 | −1.4446764E−26 |

### Example 12

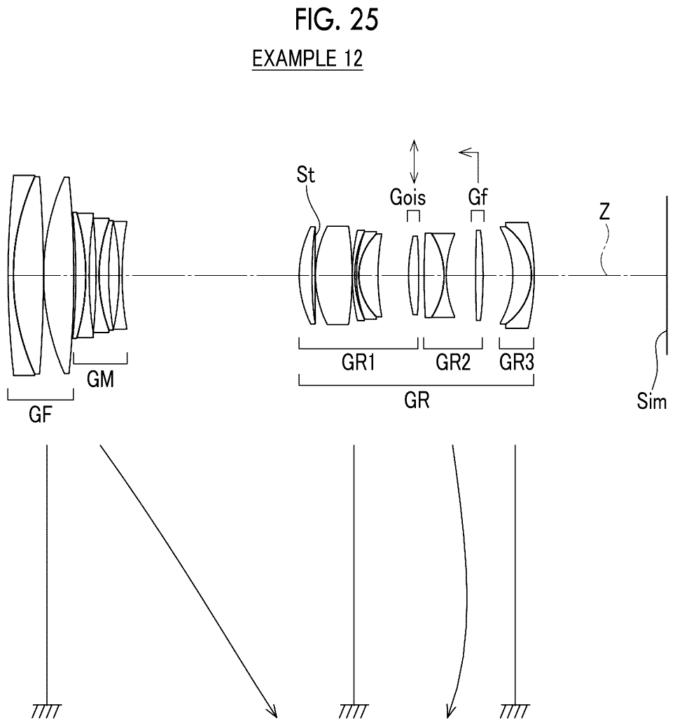

A configuration and a movement trajectory of a variable magnification optical system according to Example 12 are shown in FIG. 25. The variable magnification optical system according to Example 12 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, and the third subsequent lens group GR3 having a negative refractive power.

During magnification change from the wide angle end to the telephoto end, the front group GF, the first subsequent lens group GR1, and the third subsequent lens group GR3 are fixed with respect to the image plane Sim, and the intermediate group GM and the second subsequent lens group GR2 move by changing the spacings between the adjacent lens groups. The variable magnification optical system according to Example 12 includes only one focusing group Gf. The focusing group Gf consists of one lens of the second subsequent lens group GR2 closest to the image side. The anti-vibration group Gois consists of one lens of the first subsequent lens group GR1 closest to the image side.

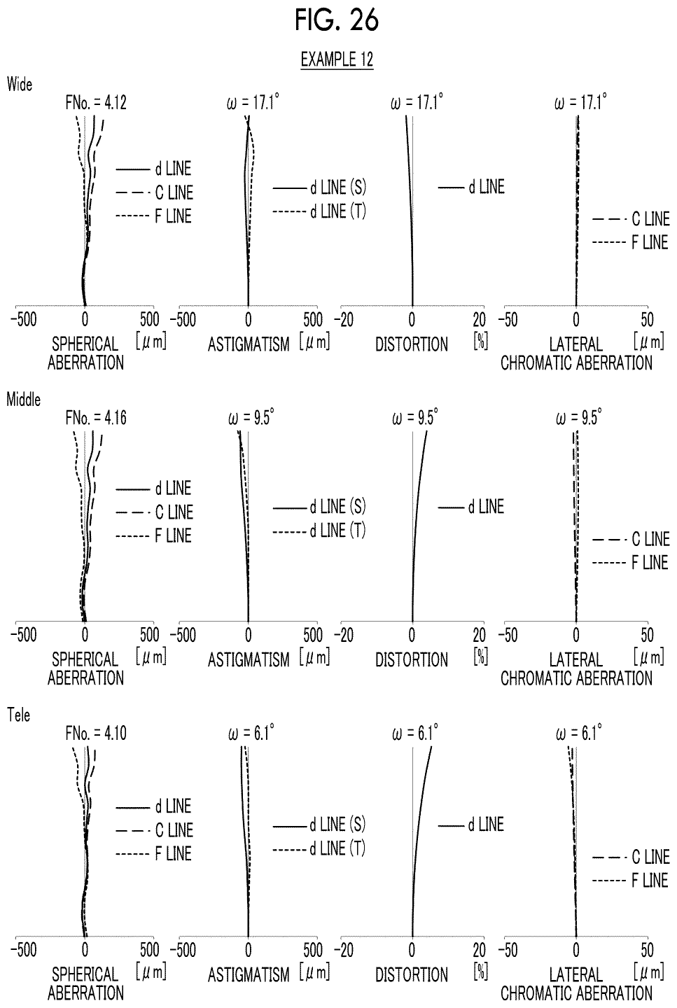

For the variable magnification optical system according to Example 12, basic lens data is shown in Table 34, specifications and variable surface spacings are shown in Table 35, aspherical coefficients are shown in Table 36, and each aberration diagram is shown in FIG. 26.

TABLE 34
Example 12

| | | Sn | R | D | Nd | νd | θgF | ρ |
|---|---|---|---|---|---|---|---|---|
| | GF | 1 | 262.0286 | 1.4096 | 1.81600 | 46.62 | 0.55682 | 5.07 |
| | | 2 | 68.8259 | 8.1164 | 1.49710 | 81.56 | 0.53848 | 3.64 |
| | | 3 | −361.2633 | 0.0482 | | | | |
| | | 4 | 70.1939 | 8.1336 | 1.43700 | 95.10 | 0.53364 | 3.53 |
| | | 5 | −293.5532 | DD[5] | | | | |
| | GM | 6 | −192.1086 | 2.6760 | 1.80610 | 40.73 | 0.56719 | |
| | | 7 | −64.5574 | 0.9062 | 1.49710 | 81.56 | 0.53848 | |
| | | 8 | 118.0773 | 1.8760 | | | | |
| | | 9 | −172.6198 | 0.8345 | 1.55032 | 75.50 | 0.54001 | |
| | | 10 | 45.1234 | 2.5849 | 1.89190 | 37.13 | 0.57813 | |
| | | 11 | 96.0680 | 2.8196 | | | | |
| | | 12 | 73.9536 | 0.7788 | 1.49710 | 81.56 | 0.53848 | |
| | | 13 | 87.1292 | DD[13] | | | | |
| | GR1 | *14 | 30.5541 | 3.4478 | 1.49710 | 81.56 | 0.53848 | |
| | | *15 | 136.5260 | 0.8478 | | | | |
| | | 16(St) | ∞ | 0.1001 | | | | |
| | | 17 | 31.2422 | 9.7004 | 1.45650 | 90.27 | 0.53477 | |
| | | 18 | −101.8513 | 0.0473 | | | | |
| | | 19 | 58.1396 | 0.6564 | 1.57099 | 50.80 | 0.55887 | |
| | | 20 | 29.7849 | 0.4915 | | | | |
| | | 21 | 35.7870 | 0.6357 | 1.81600 | 46.62 | 0.55682 | |
| | | 22 | 16.5298 | 5.1597 | 1.45650 | 90.27 | 0.53477 | |
| | | 23 | 65.9550 | 8.2582 | | | | |
| Gois | | 24 | 49.8126 | 2.7291 | 1.43700 | 95.10 | 0.53364 | |
| | | 25 | −173.3099 | DD[25] | | | | |
| | GR2 | 26 | 200.1287 | 5.3726 | 1.61772 | 49.81 | 0.56035 | |
| | | 27 | −22.1172 | 0.6114 | 1.62041 | 60.29 | 0.54266 | |
| | | 28 | 30.3163 | 7.9500 | | | | |
| Gf | | 29 | 407.6313 | 1.9849 | 1.51823 | 58.96 | 0.54420 | |
| | | 30 | −110.9616 | DD[30] | | | | |
| | GR3 | 31 | −27.6492 | 5.0042 | 1.51742 | 52.15 | 0.55896 | |
| | | 32 | −16.8772 | 0.7663 | 1.43700 | 95.10 | 0.53364 | |
| | | 33 | −66.7704 | 35.7700 | | | | |

TABLE 35
Example 12

| | Wide | Middle | Tele |
|---|---|---|---|
| Zr | 1.0 | 1.7 | 2.7 |
| f | 71.51 | 123.95 | 192.44 |
| Bf | 35.77 | 35.77 | 35.77 |
| FNo. | 4.12 | 4.16 | 4.10 |
| 2ω[°] | 34.2 | 19.0 | 12.2 |
| DD[5] | 0.55 | 27.77 | 48.23 |
| DD[13] | 47.78 | 20.55 | 0.10 |
| DD[25] | 1.45 | 5.33 | 0.10 |
| DD[30] | 8.03 | 4.15 | 9.37 |

TABLE 36
Example 12

| Sn | 14 | 15 |
|---|---|---|
| KA | 1.0000000E+00 | 1.0000000E+00 |
| A3 | 0.0000000E+00 | 0.0000000E+00 |
| A4 | −1.1240575E−06 | 4.9228569E−06 |
| A5 | −2.8488229E−07 | 3.3445369E−07 |
| A6 | 4.2663510E−08 | −5.9391910E−08 |
| A7 | −1.4614017E−09 | 3.5554811E−09 |
| A8 | −5.4038967E−11 | 2.0074778E−10 |
| A9 | −1.3429099E−11 | −1.4000455E−11 |
| A10 | 2.0820112E−12 | −1.2801177E−12 |
| A11 | 8.1989089E−17 | 9.2689378E−14 |
| A12 | −1.8163541E−14 | −7.6899132E−15 |
| A13 | 8.9916281E−16 | −6.3232261E−16 |
| A14 | 1.5775243E−17 | 1.9867456E−16 |
| A15 | −6.3763231E−19 | −1.6035500E−17 |
| A16 | −4.2627782E−20 | 6.4710014E−19 |
| A17 | 4.6791577E−21 | 2.7817753E−20 |
| A18 | −1.2825693E−22 | −2.7065968E−21 |
| A19 | −4.7707282E−23 | −1.3114210E−22 |
| A20 | 2.1585608E−24 | 9.1266300E−24 |

### Example 13

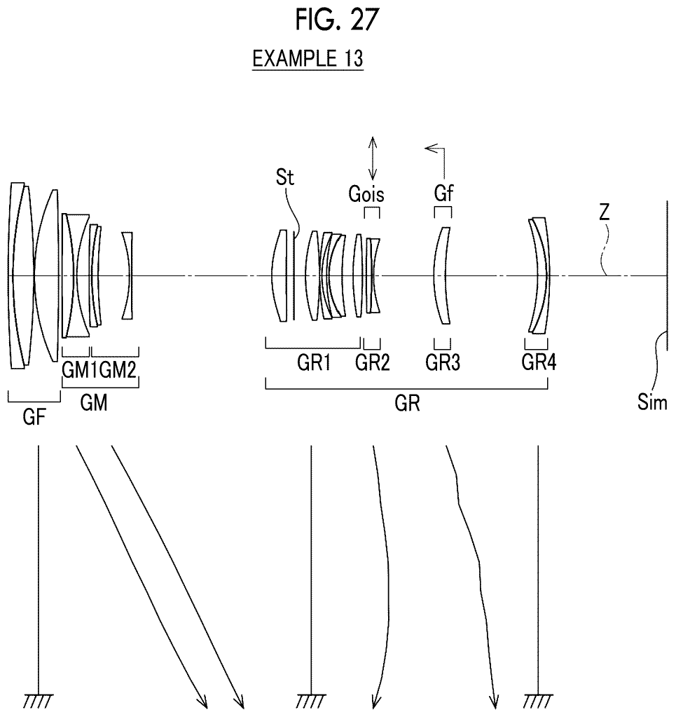

A configuration and a movement trajectory of a variable magnification optical system according to Example 13 are shown in FIG. 27. The variable magnification optical system according to Example 13 consists of, in order from the object side to the image side, the front group GF, the intermediate group GM, and the subsequent group GR. The front group GF consists of one lens group having a positive refractive power. The intermediate group GM consists of two lens groups, that is a first intermediate lens group GM1 having a negative refractive power and a second intermediate lens group GM2 having a negative refractive power. The subsequent group GR consists of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power.

During magnification change from the wide angle end to the telephoto end, the front group GF, the first subsequent lens group GR1, and the fourth subsequent lens group GR4 are fixed with respect to the image plane Sim, and the first intermediate lens group GM1, the second intermediate lens group GM2, the second subsequent lens group GR2, and the third subsequent lens group GR3 move by changing the spacings between the adjacent lens groups. The variable magnification optical system according to Example 13 includes only one focusing group Gf. The focusing group Gf consists of the third subsequent lens group GR3. The anti-vibration group Gois consists of the second subsequent lens group GR2.

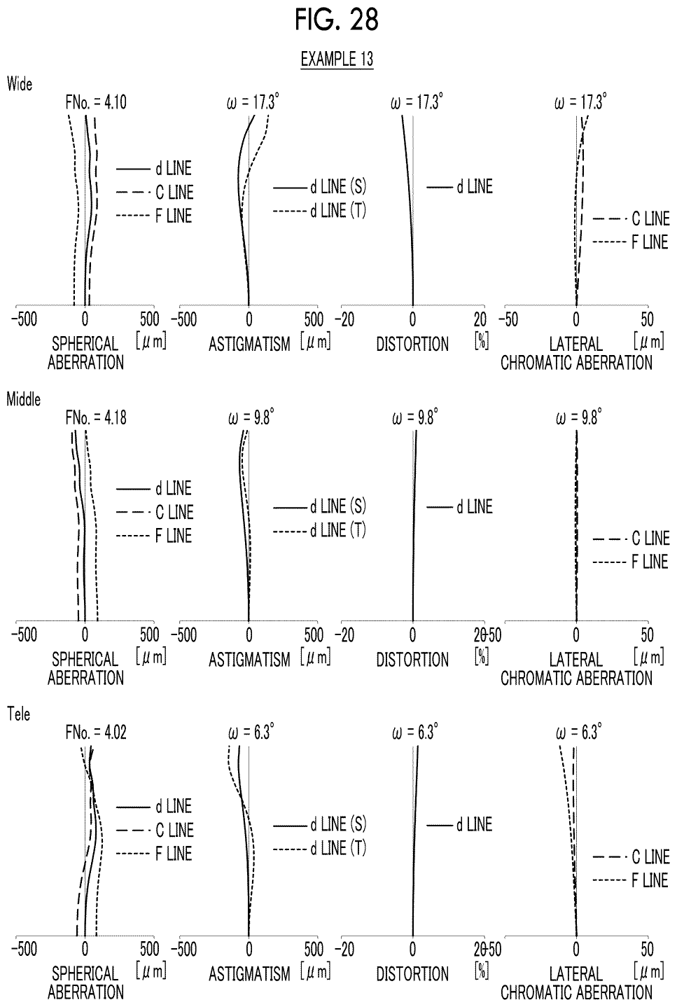

For the variable magnification optical system according to Example 13, basic lens data is shown in Table 37, specifications and variable surface spacings are shown in Table 38, aspherical coefficients are shown in Table 39, and each aberration diagram is shown in FIG. 28.

TABLE 37
Example 13

| | | Sn | R | D | Nd | νd | θgF | ρ |
|---|---|---|---|---|---|---|---|---|
| | GF | 1 | 396.7206 | 1.3493 | 1.91650 | 31.60 | 0.59117 | 4.74 |
| | | 2 | 108.6693 | 5.8291 | 1.49710 | 81.56 | 0.53848 | 3.64 |
| | | 3 | −228.3823 | 0.2000 | | | | |
| | | *4 | 62.9752 | 6.7843 | 1.49710 | 81.56 | 0.53848 | 3.64 |
| | | *5 | −688.7689 | DD[5] | | | | |
| | GM1 | 6 | 3682.2376 | 3.1912 | 1.90366 | 31.31 | 0.59481 | |
| | | 7 | −78.7892 | 0.9233 | 1.51823 | 58.96 | 0.54420 | |
| | GM2 | 8 | 43.8481 | DD[8] | | | | |
| | | 9 | 363.9118 | 0.7781 | 1.55032 | 75.50 | 0.54001 | |
| | | 10 | 68.1185 | 1.7788 | 1.86966 | 20.02 | 0.64349 | |
| | | 11 | 125.2583 | 8.7720 | | | | |
| | | *12 | 37.9375 | 0.6540 | 1.69350 | 53.20 | 0.54661 | |
| | | *13 | 1767.6757 | DD[13] | | | | |
| | GR1 | *14 | 32.0671 | 4.0551 | 1.55332 | 71.68 | 0.54029 | |
| | | *15 | 341.1477 | 2.1748 | | | | |
| | | 16(St) | ∞ | 3.2501 | | | | |
| | | 17 | 44.0188 | 3.9139 | 1.49710 | 81.56 | 0.53848 | |
| | | 18 | −112.3533 | 0.0477 | | | | |
| | | 19 | 65.7237 | 0.6490 | 1.53359 | 55.47 | 0.54898 | |
| | | 20 | 27.8047 | 1.3121 | | | | |
| | | 21 | 49.4021 | 0.6277 | 1.85451 | 25.15 | 0.61031 | |
| | | 22 | 22.9727 | 3.5295 | 1.48749 | 70.24 | 0.53007 | |
| | | 23 | 72.9942 | 3.0922 | | | | |
| | | 24 | 66.0453 | 2.6075 | 1.77535 | 50.30 | 0.55004 | |
| | | 25 | −170.3055 | DD[25] | | | | |
| Gois | GR2 | 26 | 365.4003 | 1.4916 | 1.98613 | 16.48 | 0.66558 | |
| | | 27 | −196.3781 | 0.5669 | 1.72916 | 54.67 | 0.54534 | |
| | | 28 | 33.4389 | DD[28] | | | | |
| Gf | GR3 | 29 | 41.3430 | 3.2529 | 1.55032 | 75.50 | 0.54001 | |
| | | 30 | 77.5129 | DD[30] | | | | |
| | GR4 | 31 | −53.0917 | 2.4825 | 1.74400 | 44.79 | 0.56560 | |
| | | 32 | −36.3004 | 0.8786 | 1.51823 | 58.96 | 0.54420 | |
| | | 33 | −104.2151 | 33.0100 | | | | |

TABLE 38
Example 13

| | Wide | Middle | Tele |
|---|---|---|---|
| Zr | 1.0 | 1.7 | 2.7 |
| f | 71.50 | 123.92 | 192.41 |
| Bf | 33.01 | 33.01 | 33.01 |
| FNo. | 4.10 | 4.18 | 4.07 |
| 2ω[°] | 34.8 | 19.8 | 12.8 |
| DD[5] | 1.00 | 20.76 | 37.70 |
| DD[8] | 3.43 | 4.86 | 3.73 |
| DD[13] | 39.29 | 18.11 | 2.29 |
| DD[25] | 1.10 | 5.38 | 1.10 |
| DD[28] | 16.89 | 22.30 | 30.73 |
| DD[30] | 25.90 | 16.21 | 12.07 |

TABLE 39
Example 13

| Sn | 4 | 5 | 12 | 13 |
|---|---|---|---|---|
| KA | 1.0000000E+00 | 1.0000000E+00 | 1.0000000E+00 | 1.0000000E+00 |
| A4 | 2.6070511E−08 | 2.3663889E−07 | 1.3902081E−06 | 7.8355515E−07 |
| A6 | 9.4405733E−11 | 2.9034250E−11 | 5.1680978E−10 | 2.2297302E−09 |
| A8 | −1.5906458E−14 | 1.8420684E−14 | −6.8273571E−12 | −1.7351280E−11 |
| A10 | −6.9274836E−18 | −3.5493839E−17 | 4.5694466E−14 | 6.6112641E−14 |

| Sn | 14 | 15 |
|---|---|---|
| KA | 1.0000000E+00 | 1.0000000E+00 |
| A4 | −7.0692079E−06 | 3.4882889E−08 |
| A6 | −4.2205111E−09 | −1.4142411E−09 |
| A8 | −2.5854011E−10 | −2.7674922E−10 |
| A10 | 2.4909537E−12 | 1.6830805E−12 |
| A12 | −2.6035018E−14 | −1.0943743E−14 |
| A14 | 1.2665498E−16 | 1.9162629E−17 |
| A16 | −3.0696216E−19 | 2.5919496E−20 |
| A18 | 3.6840597E−23 | −2.8348650E−22 |

### Example 14

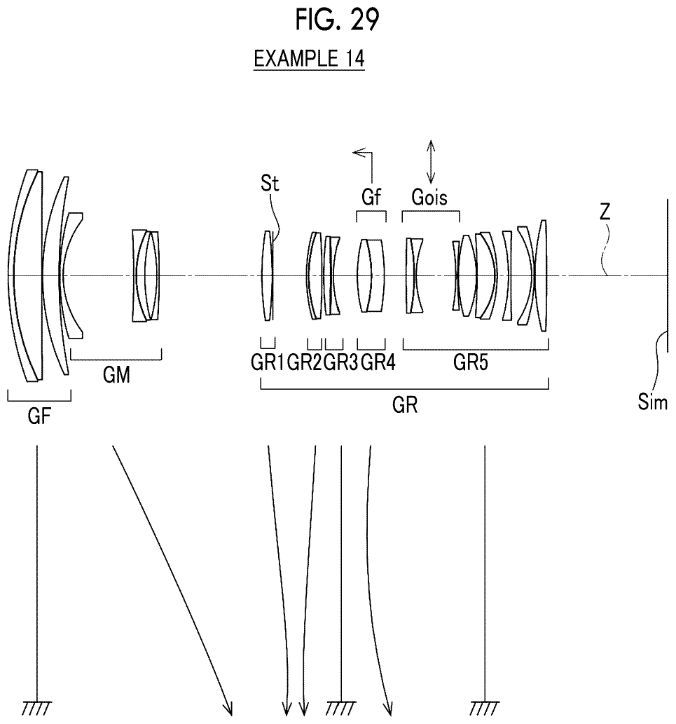

A configuration and a movement trajectory of a variable magnification optical system according to Example 14 are shown in FIG. 29. The variable magnification optical system according to Example 14 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, the fourth subsequent lens group GR4 having a positive refractive power, and the fifth subsequent lens group GR5 having a negative refractive power.

During magnification change from the wide angle end to the telephoto end, the front group GF, the third subsequent lens group GR3, and the fifth subsequent lens group GR5 are fixed with respect to the image plane Sim, and the intermediate group GM, the first subsequent lens group GR1, the second subsequent lens group GR2, and the fourth subsequent lens group GR4 move by changing the spacings between the adjacent lens groups. The variable magnification optical system according to Example 14 includes only one focusing group Gf. The focusing group Gf consists of the fourth subsequent lens group GR4. The anti-vibration group Gois consists of a first lens, a second lens, and a third lens of the fifth subsequent lens group GR5 from the object side.

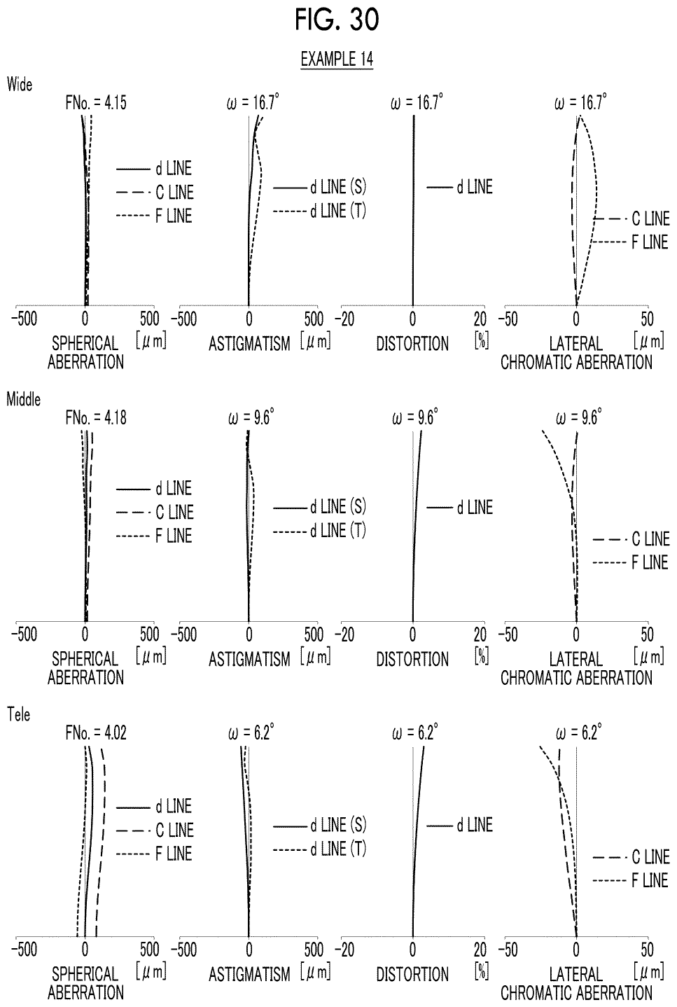

For the variable magnification optical system according to Example 14, basic lens data is shown in Table 40, specifications and variable surface spacings are shown in Table 41, aspherical coefficients are shown in Table 42, and each aberration diagram is shown in FIG. 30.

TABLE 40
Example 14

| | | Sn | R | D | Nd | νd | θgF | ρ |
|---|---|---|---|---|---|---|---|---|
| | GF | 1 | 89.7524 | 1.5021 | 1.98613 | 16.48 | 0.66558 | 3.54 |
| | | 2 | 69.7014 | 7.6719 | 1.59282 | 68.62 | 0.54414 | 4.13 |
| | | 3 | 4137.3348 | 0.2001 | | | | |
| | | 4 | 68.9883 | 4.5174 | 1.61800 | 63.33 | 0.54414 | 3.67 |
| | | 5 | 150.3710 | DD[5] | | | | |
| | GM | 6 | 64.8342 | 0.9146 | 1.51742 | 52.15 | 0.55896 | |
| | | 7 | 26.7585 | 19.2741 | | | | |
| | | 8 | −256.8551 | 0.6853 | 1.48749 | 70.24 | 0.53007 | |
| | | 9 | 29.7853 | 2.3492 | 1.98613 | 16.48 | 0.66558 | |
| | | 10 | 50.4139 | 3.2852 | | | | |
| | | 11 | −49.5510 | 0.6452 | 1.95375 | 32.32 | 0.59015 | |
| | | 12 | −192.2851 | DD[12] | | | | |
| | GR1 | *13 | 80.6482 | 2.8001 | 1.88202 | 37.22 | 0.57699 | |
| | | *14 | −110.3159 | 0.1999 | | | | |
| | | 15(St) | ∞ | DD[15] | | | | |
| | GR2 | 16 | 47.2865 | 0.6388 | 1.88100 | 40.14 | 0.57010 | |
| | | 17 | 37.9453 | 3.5981 | 1.55032 | 75.50 | 0.54001 | |
| | | 18 | −191.4730 | DD[18] | | | | |
| | GR3 | 19 | 99.3115 | 1.8226 | 1.83481 | 42.72 | 0.56477 | |
| | | 20 | −466.9796 | 0.2596 | | | | |
| | | 21 | −210.8095 | 0.5673 | 1.80518 | 25.46 | 0.61572 | |
| | | 22 | 36.9411 | DD[22] | | | | |
| Gf | GR4 | 23 | 43.3161 | 3.8398 | 1.45650 | 90.27 | 0.53477 | |
| | | 24 | −39.3109 | 3.5287 | 1.80809 | 22.76 | 0.62868 | |
| | | 25 | −60.5602 | DD[25] | | | | |
| Gois | GR5 | 26 | 470.3583 | 2.1922 | 1.92119 | 23.96 | 0.62025 | |
| | | 27 | −57.1525 | 0.5545 | 1.56732 | 42.84 | 0.57436 | |
| | | 28 | 28.7860 | 10.8182 | | | | |
| | | 29 | −55.7125 | 0.5019 | 1.83481 | 42.72 | 0.56477 | |
| | | 30 | 103.9591 | 0.1998 | | | | |
| | | 31 | 45.4007 | 4.9059 | 1.48749 | 70.24 | 0.53007 | |
| | | 32 | −31.2503 | 0.1998 | | | | |
| | | 33 | −161.0574 | 4.8491 | 1.67270 | 32.17 | 0.59633 | |
| | | 34 | −19.8590 | 0.6371 | 1.90043 | 37.37 | 0.57668 | |
| | | 35 | −36.4296 | 3.0960 | | | | |
| | | 36 | −48.1277 | 0.6535 | 1.65160 | 58.54 | 0.53901 | |
| | | 37 | 565.4717 | 5.6539 | | | | |
| | | 38 | −24.3261 | 0.7173 | 1.69680 | 55.46 | 0.54260 | |
| | | 39 | −48.6684 | 0.1998 | | | | |
| | | *40 | 62.4381 | 3.1927 | 1.77250 | 49.46 | 0.55399 | |
| | | 41 | −521.9186 | 33.0500 | | | | |

TABLE 41
Example 14

| | Wide | Middle | Tele |
|---|---|---|---|
| Zr | 1.0 | 1.7 | 2.7 |
| f | 72.00 | 124.79 | 193.75 |
| Bf | 33.05 | 33.05 | 33.05 |
| FNo. | 4.15 | 4.18 | 4.02 |
| 2ω[°] | 33.4 | 19.2 | 12.4 |
| DD[5] | 0.20 | 19.22 | 32.73 |
| DD[12] | 28.06 | 13.00 | 0.50 |
| DD[15] | 9.17 | 2.66 | 1.09 |
| DD[18] | 0.50 | 3.06 | 3.61 |
| DD[22] | 6.36 | 6.04 | 11.85 |
| DD[25] | 5.99 | 6.30 | 0.50 |

TABLE 42
Example 14

| Sn | 13 | 14 | 40 |
|---|---|---|---|
| KA | 1.0000000E+00 | 1.0000000E+00 | 1.0000000E+00 |
| A4 | −2.8365253E−06 | −5.6394224E−07 | −2.8258903E−06 |
| A6 | 1.2339467E−08 | 1.1644214E−08 | 2.2316543E−09 |
| A8 | −8.1365679E−11 | −7.9188887E−11 | −1.5070694E−12 |
| A10 | 2.5343877E−13 | 2.4906490E−13 | −2.0393445E−15 |

### Example 15

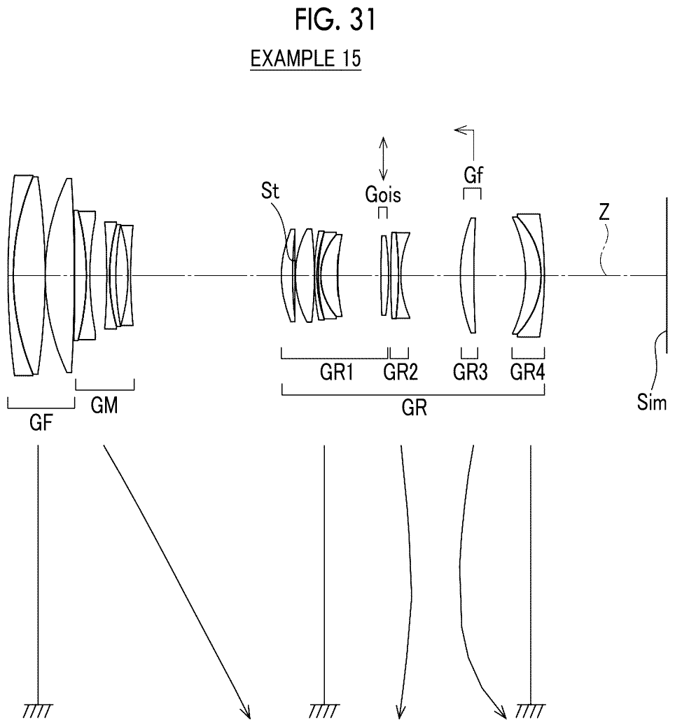

A configuration and a movement trajectory of a variable magnification optical system according to Example 15 are shown in FIG. 31. The variable magnification optical system according to Example 15 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a negative refractive power, the third subsequent lens group GR3 having a positive refractive power, and the fourth subsequent lens group GR4 having a negative refractive power.

During magnification change from the wide angle end to the telephoto end, the front group GF, the first subsequent lens group GR1, and the fourth subsequent lens group GR4 are fixed with respect to the image plane Sim, and the intermediate group GM, the second subsequent lens group GR2, and the third subsequent lens group GR3 move by changing the spacings between the adjacent lens groups. The variable magnification optical system according to Example 15 includes only one focusing group Gf. The focusing group Gf consists of the third subsequent lens group GR3. The anti-vibration group Gois consists of one lens of the first subsequent lens group GR1 closest to the image side.

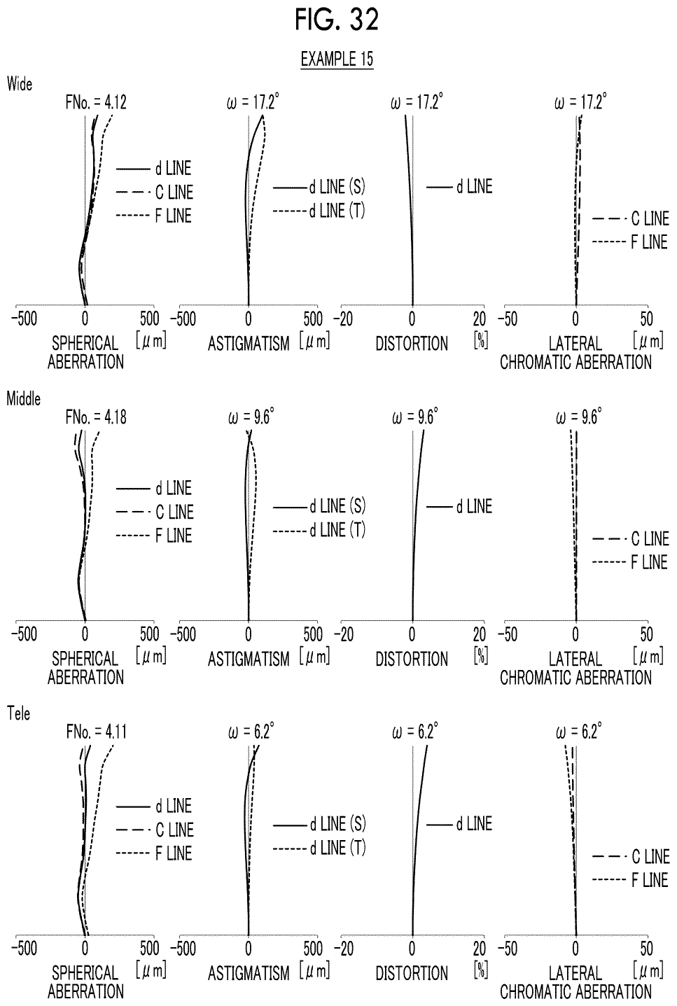

For the variable magnification optical system according to Example 15, basic lens data is shown in Table 43, specifications and variable surface spacings are shown in Table 44, aspherical coefficients are shown in Table 45, and each aberration diagram is shown in FIG. 32.

TABLE 43
Example 15

| | | Sn | R | D | Nd | νd | θgF | ρ |
|---|---|---|---|---|---|---|---|---|
| | GF | 1 | 224.3024 | 1.4101 | 1.88300 | 40.80 | 0.56557 | 5.42 |
| | | 2 | 74.3004 | 8.5940 | 1.49710 | 81.56 | 0.53848 | 3.64 |
| | | 3 | −194.0773 | 0.0495 | | | | |
| | | 4 | 66.1721 | 7.8215 | 1.43700 | 95.10 | 0.53364 | 3.53 |
| | | 5 | −490.0066 | DD[5] | | | | |
| | GM | 6 | −932.3304 | 3.1652 | 1.91082 | 35.25 | 0.58224 | |
| | | 7 | −73.5887 | 0.9331 | 1.49710 | 81.56 | 0.53848 | |
| | | 8 | 86.4819 | 4.5541 | | | | |
| | | 9 | −207.6307 | 0.7826 | 1.55032 | 75.50 | 0.54001 | |
| | | 10 | 55.1909 | 1.6837 | 1.84666 | 23.78 | 0.61923 | |
| | | 11 | 80.2071 | 3.2567 | | | | |
| | | 12 | −51.5415 | 0.7229 | 1.61800 | 63.33 | 0.54414 | |
| | | 13 | 150.5053 | DD[13] | | | | |
| | GR1 | *14 | 31.2648 | 3.0113 | 1.58313 | 59.38 | 0.54237 | |
| | | *15 | 122.0255 | 0.6626 | | | | |
| | | 16(St) | ∞ | 0.0998 | | | | |
| | | 17 | 28.7351 | 5.1051 | 1.49710 | 81.56 | 0.53848 | |
| | | 18 | −121.6151 | 0.0495 | | | | |
| | | 19 | 68.0721 | 0.6435 | 1.61800 | 63.33 | 0.54414 | |
| | | 20 | 38.3578 | 0.4154 | | | | |
| | | 21 | 47.8022 | 0.6273 | 1.83400 | 37.16 | 0.57759 | |
| | | 22 | 17.6526 | 4.4323 | 1.43700 | 95.10 | 0.53364 | |
| | | 23 | 58.2414 | 11.6502 | | | | |
| Gois | | 24 | 281.2820 | 2.0337 | 1.43700 | 95.10 | 0.53364 | |
| | | 25 | −84.6980 | DD[25] | | | | |
| | GR2 | 26 | 210.7377 | 2.1086 | 1.95375 | 32.32 | 0.59015 | |
| | | 27 | −106.8604 | 0.6344 | 1.51680 | 64.20 | 0.53430 | |
| | | 28 | 30.2182 | DD[28] | | | | |
| Gf | GR3 | 29 | 46.4278 | 3.6409 | 1.45860 | 90.19 | 0.53516 | |
| | | 30 | 305.1085 | DD[30] | | | | |
| | GR4 | 31 | −38.9600 | 4.1848 | 1.72916 | 54.67 | 0.54534 | |
| | | 32 | −24.1129 | 0.8959 | 1.59282 | 68.62 | 0.54414 | |
| | | 33 | −113.4726 | 33.0000 | | | | |

TABLE 44
Example 15

| | Wide | Middle | Tele |
|---|---|---|---|
| Zr | 1.0 | 1.7 | 2.7 |
| f | 71.50 | 123.92 | 192.40 |
| Bf | 33.00 | 33.00 | 33.00 |
| FNo. | 4.12 | 4.18 | 4.11 |
| 2ω[°] | 34.3 | 19.2 | 12.3 |
| DD[5] | 0.10 | 22.40 | 39.50 |
| DD[13] | 40.65 | 18.36 | 1.25 |
| DD[25] | 0.59 | 3.44 | 0.10 |
| DD[28] | 16.05 | 9.77 | 25.27 |
| DD[30] | 13.94 | 17.37 | 5.21 |

TABLE 45
Example 15

| Sn | 14 | 15 |
|---|---|---|
| KA | 1.0000000E+00 | 1.0000000E+00 |
| A3 | 0.0000000E+00 | 0.0000000E+00 |
| A4 | −1.5450933E−06 | 4.8560860E−06 |
| A5 | −6.3884357E−07 | 4.3654027E−09 |
| A6 | 8.4916591E−08 | −7.7115478E−09 |
| A7 | −3.8397640E−09 | 2.1735148E−10 |
| A8 | −1.0974413E−10 | 1.5639365E−10 |
| A9 | −2.2690735E−11 | −2.9413508E−11 |
| A10 | 3.6322000E−12 | 1.8014941E−13 |
| A11 | −5.2504731E−14 | 1.0690380E−13 |
| A12 | −2.2252305E−14 | −8.6261865E−15 |
| A13 | 1.1974736E−15 | −7.5101830E−16 |
| A14 | −2.9490171E−17 | 1.3210999E−16 |
| A15 | 1.5707842E−19 | −9.0593915E−18 |
| A16 | 2.2648845E−19 | 8.8701887E−19 |
| A17 | 2.5213648E−20 | −3.9266042E−20 |
| A18 | −3.0680504E−21 | −1.1525023E−21 |
| A19 | −9.4320729E−23 | 2.7186199E−24 |
| A20 | 7.8534098E−24 | 3.5294997E−24 |

### Example 16

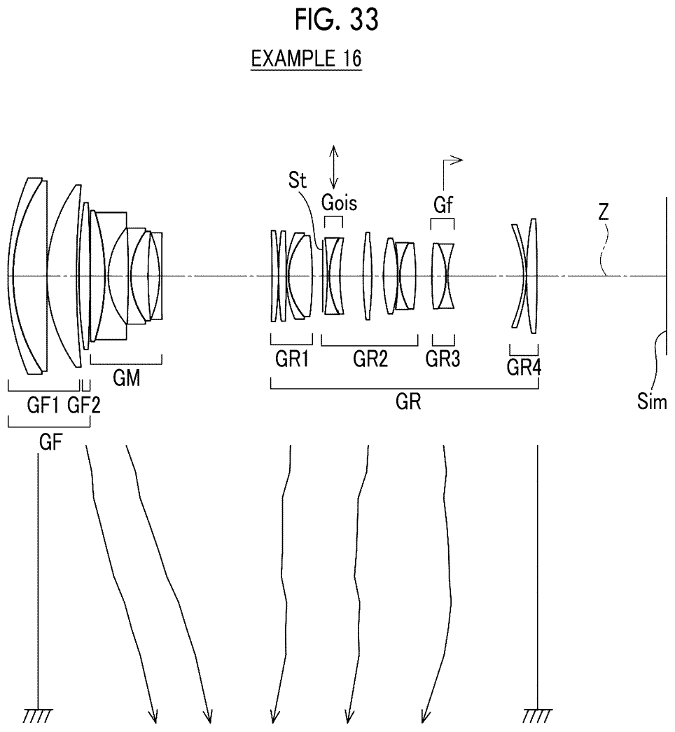

A configuration and a movement trajectory of a variable magnification optical system according to Example 16 are shown in FIG. 33. The variable magnification optical system according to Example 16 consists of, in order from the object side to the image side, the front group GF, the intermediate group GM, and the subsequent group GR. The front group GF consists of two lens groups, that is, a first front lens group GF1 having a positive refractive power and a second front lens group GF2 having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, the third subsequent lens group GR3 having a negative refractive power, and the fourth subsequent lens group GR4 having a positive refractive power.

During magnification change from the wide angle end to the telephoto end, the first front lens group GF1 and the fourth subsequent lens group GR4 are fixed with respect to the image plane Sim, and the second front lens group GF2, the intermediate group GM, the first subsequent lens group GR1, the second subsequent lens group GR2, and the third subsequent lens group GR3 move by changing the spacings between the adjacent lens groups. The variable magnification optical system according to Example 16 includes only one focusing group Gf. The focusing group Gf consists of the third subsequent lens group GR3. The anti-vibration group Gois consists of a first lens and a second lens of the second subsequent lens group GR2 from the object side.

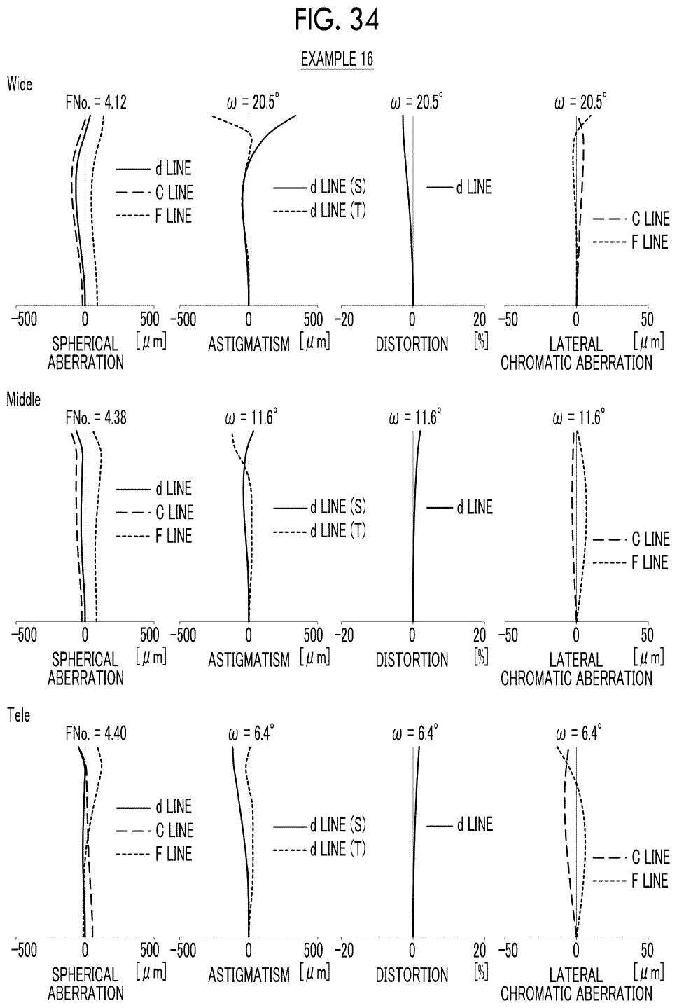

For the variable magnification optical system according to Example 16, basic lens data is shown in Table 46, specifications and variable surface spacings are shown in Table 47, aspherical coefficients are shown in Table 48, and each aberration diagram is shown in FIG. 34.

TABLE 46
Example 16

| | | Sn | R | D | Nd | νd | θgF | ρ |
|---|---|---|---|---|---|---|---|---|
| | GF1 | 1 | 71.4247 | 1.3491 | 2.00001 | 27.00 | 0.60625 | 4.94 |
| | | 2 | 48.7497 | 8.9542 | 1.49700 | 81.54 | 0.53748 | 3.62 |
| | | 3 | 13705.8702 | 0.0472 | | | | |
| | | 4 | 44.6454 | 7.8404 | 1.49700 | 81.54 | 0.53748 | 3.62 |
| | | 5 | 257.9657 | DD[5] | | | | |
| | GF2 | 6 | 148.5757 | 2.9198 | 1.48749 | 70.32 | 0.52917 | 2.45 |
| | | 7 | 452.8439 | DD[7] | | | | |
| | GM | 8 | 1428.6258 | 3.8726 | 1.77536 | 26.23 | 0.61426 | |
| | | 9 | −60.4037 | 0.9106 | 1.61800 | 63.39 | 0.54415 | |
| | | 10 | 20.9134 | 5.2797 | | | | |
| | | 11 | −333.1907 | 0.6976 | 1.43875 | 94.66 | 0.53402 | |
| | | 12 | 21.3355 | 4.5608 | 1.80432 | 28.80 | 0.60515 | |
| | | 13 | 109.6594 | 3.0307 | | | | |
| | | 14 | −32.0607 | 0.6177 | 1.95049 | 31.93 | 0.59154 | |
| | | 15 | 1163.6901 | DD[15] | | | | |
| | GR1 | 16 | −448.0067 | 1.6795 | 1.85530 | 43.40 | 0.56297 | |
| | | 17 | −98.0476 | 0.0470 | | | | |
| | | 18 | 108.1762 | 2.0037 | 1.77535 | 50.30 | 0.55004 | |
| | | 19 | −354.9159 | 0.0465 | | | | |
| | | 20 | 31.9319 | 0.6151 | 1.92786 | 27.11 | 0.60764 | |
| | | 21 | 17.0774 | 6.2884 | 1.53643 | 75.60 | 0.53971 | |
| | | 22 | −94.1126 | DD[22] | | | | |
| | GR2 | 23(St) | ∞ | 1.2022 | | | | |
| Gois | | 24 | −89.4203 | 0.5594 | 1.80601 | 27.51 | 0.60928 | |
| | | 25 | 23.6973 | 2.6181 | 1.95906 | 17.47 | 0.65993 | |
| | | 26 | 55.7660 | 6.1552 | | | | |
| | | *27 | 75.4965 | 2.3248 | 1.85400 | 40.38 | 0.56890 | |
| | | *28 | −103.7422 | 3.1073 | | | | |
| | | 29 | 43.8113 | 3.7563 | 1.48749 | 70.32 | 0.52917 | |
| | | 30 | −40.7406 | 0.0492 | | | | |
| | | 31 | −74.2116 | 0.5555 | 1.74976 | 50.74 | 0.55090 | |
| | | 32 | 19.2366 | 4.1863 | 1.49700 | 81.54 | 0.53748 | |
| | | 33 | −70.4125 | DD[33] | | | | |
| Gf | GR3 | 34 | 96.5191 | 3.7749 | 1.56739 | 42.36 | 0.57496 | |
| | | 35 | −20.2331 | 0.5092 | 1.55777 | 72.35 | 0.54083 | |
| | | 36 | 25.1224 | DD[36] | | | | |
| | GR4 | *37 | −25.8712 | 0.7346 | 2.00178 | 19.32 | 0.64480 | |
| | | *38 | −31.9707 | 0.0472 | | | | |
| | | 39 | 91.5407 | 2.7806 | 1.77535 | 50.30 | 0.55004 | |
| | | 40 | −378.8822 | 34.4200 | | | | |

TABLE 47
Example 16

| | Wide | Middle | Tele |
|---|---|---|---|
| Zr | 1.0 | 1.7 | 3.2 |
| f | 59.50 | 103.12 | 190.40 |
| Bf | 34.42 | 34.42 | 34.42 |
| FNo. | 4.12 | 4.38 | 4.40 |
| 2ω[°] | 41.0 | 23.2 | 12.8 |
| DD[5] | 0.65 | 8.05 | 19.13 |
| DD[7] | 0.10 | 3.48 | 3.93 |
| DD[15] | 29.28 | 16.07 | 2.29 |
| DD[22] | 2.78 | 1.54 | 1.97 |
| DD[33] | 4.29 | 9.47 | 4.18 |
| DD[36] | 20.06 | 18.55 | 25.66 |

TABLE 48
Example 16

| Sn | 27 | 28 |
|---|---|---|
| KA | 1.0000000E+00 | 1.0000000E+00 |
| A4 | −4.4679831E−06 | −4.5477340E−06 |
| A6 | −6.9747809E−09 | −5.8633950E−09 |
| A8 | 4.8429249E−11 | −1.2393061E−11 |
| A10 | −1.9283233E−12 | −1.5353915E−12 |
| A12 | 1.8878000E−15 | 8.5019761E−16 |

| Sn | 37 | 38 |
|---|---|---|
| KA | 1.0000000E+00 | 1.0000000E+00 |
| A4 | 3.0869123E−05 | 2.6769191E−05 |
| A6 | 4.6287011E−09 | −1.2108957E−08 |
| A8 | −4.2714569E−10 | −3.1040158E−10 |
| A10 | 1.4179094E−12 | 9.2671558E−13 |
| A12 | −1.1921828E−15 | −1.3626015E−16 |
| A14 | 6.0895994E−18 | 2.4048693E−18 |

### Example 17

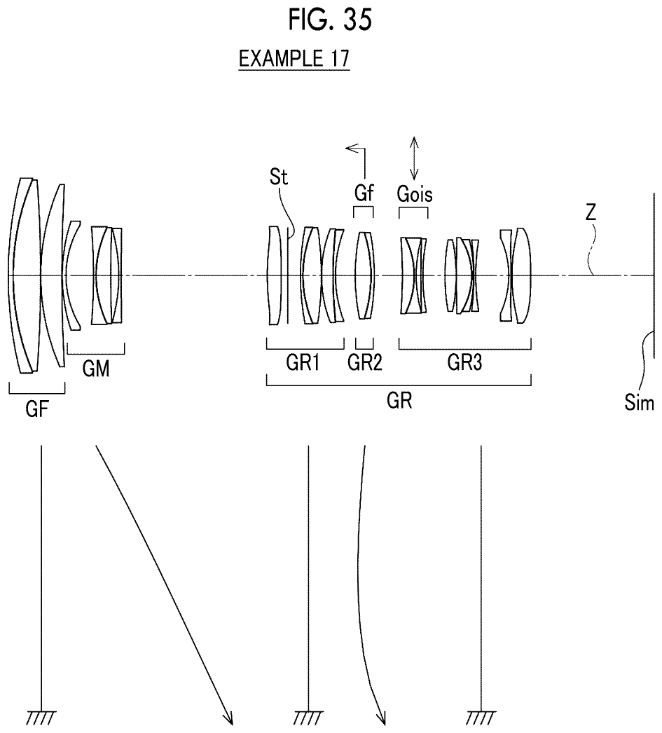

A configuration and a movement trajectory of a variable magnification optical system according to Example 17 are shown in FIG. 35. The variable magnification optical system according to Example 17 consists of, in order from the object side to the image side, the front group GF, the intermediate group GM, and the subsequent group GR. The front group GF consists of one lens group having a positive refractive power. The intermediate group GM consists of one lens group having a negative refractive power. The subsequent group GR consists of, in order from the object side to the image side, the first subsequent lens group GR1 having a positive refractive power, the second subsequent lens group GR2 having a positive refractive power, and the third subsequent lens group GR3 having a negative refractive power.

During magnification change from the wide angle end to the telephoto end, the front group GF, the first subsequent lens group GR1, and the third subsequent lens group GR3 are fixed with respect to the image plane Sim, and the intermediate group GM and the second subsequent lens group GR2 move by changing the spacings between the adjacent lens groups. The variable magnification optical system according to Example 17 includes only one focusing group Gf. The focusing group Gf consists of the second subsequent lens group GR2. The anti-vibration group Gois consists of a first lens, a second lens, and a third lens of the third subsequent lens group GR3 from the object side.

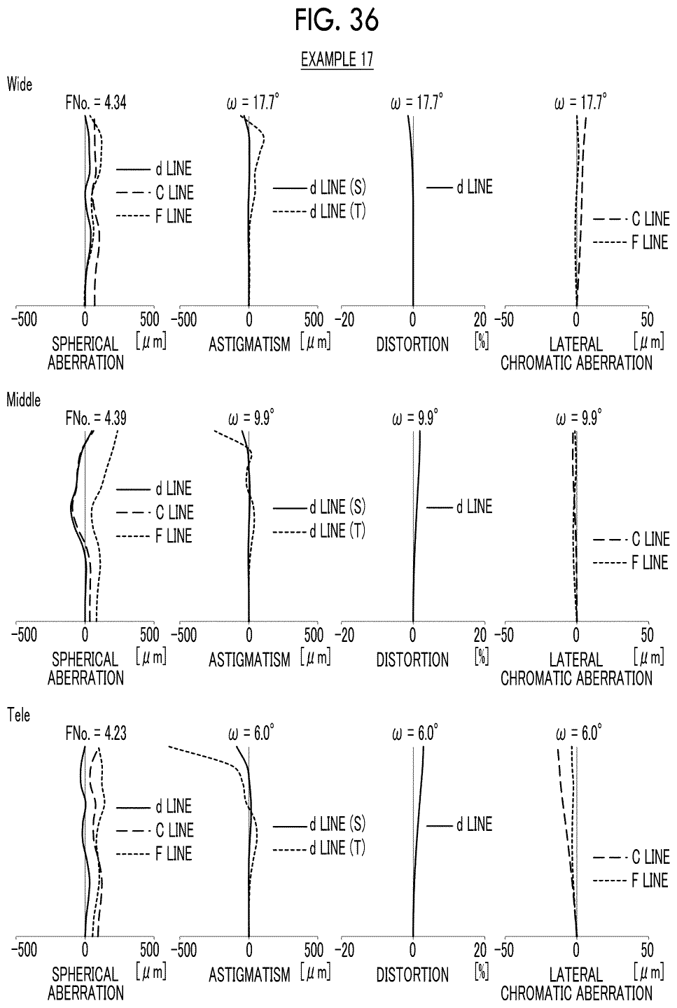

For the variable magnification optical system according to Example 17, basic lens data is shown in Table 49, specifications and variable surface spacings are shown in Table 50, aspherical coefficients are shown in Table 51, and each aberration diagram is shown in FIG. 36.

TABLE 49
Example 17

| | | Sn | R | D | Nd | νd | θgF | ρ |
|---|---|---|---|---|---|---|---|---|
| | GF | 1 | 104.5982 | 1.2887 | 1.85025 | 30.05 | 0.59797 | 4.00 |
| | | 2 | 65.2525 | 7.2562 | 1.49700 | 81.54 | 0.53748 | 3.62 |
| | | 3 | −341.7051 | 0.0483 | | | | |
| | | 4 | 60.0064 | 5.5563 | 1.43875 | 94.66 | 0.53402 | 3.59 |
| | | 5 | 438.1640 | DD[5] | | | | |
| | GM | 6 | 45.5256 | 1.0000 | 1.95632 | 29.21 | 0.60029 | |
| | | 7 | 25.7897 | 7.2554 | | | | |
| | | 8 | −149.1801 | 0.6785 | 1.48749 | 70.32 | 0.52917 | |
| | | 9 | 29.1698 | 3.8616 | 1.83959 | 23.56 | 0.62192 | |
| | | 10 | 293.7635 | 2.1148 | | | | |
| | | *11 | −44.2272 | 0.6460 | 1.77311 | 51.81 | 0.54807 | |
| | | *12 | 816.2623 | DD[12] | | | | |
| | GR1 | *13 | 61.3260 | 3.6544 | 1.68151 | 58.63 | 0.54210 | |
| | | *14 | −407.6955 | 1.7499 | | | | |
| | | 15(St) | ∞ | 3.3453 | | | | |
| | | 16 | 67.3284 | 0.6588 | 1.94573 | 26.66 | 0.60929 | |
| | | 17 | 31.7879 | 4.8514 | 1.54533 | 74.25 | 0.54018 | |
| | | 18 | −83.0012 | 0.0495 | | | | |
| | | 19 | 33.9807 | 2.8624 | 1.79469 | 40.35 | 0.57218 | |
| | | 20 | 120.8573 | 0.0484 | | | | |
| | | 21 | 107.9975 | 0.6272 | 1.82859 | 46.13 | 0.55792 | |
| | | 22 | 33.9093 | DD[22] | | | | |
| Gf | GR2 | 23 | 57.1248 | 4.1625 | 1.49700 | 81.54 | 0.53748 | |
| | | 24 | −37.4507 | 0.8751 | 1.93125 | 28.77 | 0.60228 | |
| | | 25 | −62.4925 | DD[25] | | | | |
| Gois | GR3 | 26 | −132.5512 | 3.1183 | 1.80997 | 28.98 | 0.60444 | |
| | | 27 | −22.6050 | 0.5274 | 1.67419 | 56.52 | 0.54419 | |
| | | 28 | 34.6784 | 1.2668 | | | | |
| | | 29 | 484.7445 | 0.4999 | 1.81987 | 47.03 | 0.55623 | |
| | | 30 | 50.7432 | 5.8355 | | | | |
| | | 31 | 54.7951 | 2.9534 | 1.77535 | 50.30 | 0.55004 | |
| | | 32 | −46.4213 | 0.0492 | | | | |
| | | 33 | 454.6156 | 4.0478 | 1.80100 | 34.97 | 0.58642 | |
| | | 34 | −18.2709 | 0.5000 | 1.93826 | 30.18 | 0.59759 | |
| | | 35 | −40.4677 | 0.0489 | | | | |
| | | 36 | −80.0039 | 0.4999 | 1.80107 | 48.95 | 0.55250 | |
| | | 37 | 55.7311 | 8.7261 | | | | |
| | | *38 | −23.6274 | 0.5999 | 1.90323 | 38.50 | 0.57401 | |
| | | *39 | −116.4579 | 0.2480 | | | | |
| | | *40 | 47.4537 | 4.9407 | 1.43601 | 68.26 | 0.52451 | |
| | | *41 | −157.3820 | 32.5300 | | | | |

TABLE 50
Example 17

| | Wide | Middle | Tele |
|---|---|---|---|
| Zr | 1.0 | 1.8 | 2.9 |
| f | 68.63 | 121.61 | 199.04 |
| Bf | 32.53 | 32.53 | 32.53 |
| FNo. | 4.34 | 4.39 | 4.23 |
| 2ω[°] | 35.4 | 19.8 | 12.0 |
| DD[5] | 0.10 | 20.01 | 36.06 |
| DD[12] | 38.56 | 18.64 | 2.60 |
| DD[22] | 5.19 | 3.45 | 10.50 |
| DD[25] | 7.41 | 9.15 | 2.10 |

TABLE 51
Example 17

| Sn | 11 | 12 | 13 | 14 |
|---|---|---|---|---|
| KA | 1.0000000E+00 | 1.0000000E+00 | 1.0000000E+00 | 1.0000000E+00 |
| A4 | −6.1960872E−07 | −2.0165000E−06 | −1.4739784E−05 | −1.2452962E−05 |
| A6 | −1.1316788E−08 | −2.8928354E−08 | −1.0767401E−07 | −9.5507863E−08 |
| A8 | 7.1496064E−10 | 1.2845764E−09 | 1.4821550E−09 | 9.6653487E−10 |
| A10 | −7.3750595E−12 | −1.7074361E−11 | −2.0018458E−11 | −9.1604409E−12 |
| A12 | 2.5128059E−14 | 1.1849176E−13 | 1.1398376E−13 | −1.2482810E−15 |
| A14 | 8.1097973E−17 | −4.3292661E−16 | −2.4763904E−16 | 4.3475743E−16 |
| A16 | −9.3255618E−19 | 5.9955916E−19 | −3.6075329E−19 | −2.4637666E−18 |
| A18 | 2.3041710E−21 | 3.4316140E−22 | 1.4984975E−21 | 4.2596164E−21 |

| Sn | 38 | 39 | 40 | 41 |
|---|---|---|---|---|
| KA | 1.0000000E+00 | 1.0000000E+00 | 1.0000000E+00 | 1.0000000E+00 |
| A4 | 8.9601787E−06 | 4.3521051E−05 | −1.6610346E−06 | −5.2115260E−05 |
| A6 | 6.6715822E−10 | 6.0803741E−08 | 4.0394519E−08 | −8.9109896E−09 |
| A8 | −4.6910336E−10 | −1.9038743E−10 | 1.7791999E−10 | −1.9454118E−10 |
| A10 | −9.2172014E−13 | −1.3704761E−12 | −1.4148507E−12 | −3.6941472E−14 |
| A12 | 7.6311852E−14 | −1.3756859E−14 | −2.6628287E−14 | 2.2170743E−15 |
| A14 | −1.4187172E−15 | 4.1003584E−17 | 7.3370016E−17 | 6.8017895E−17 |
| A16 | 1.0669989E−17 | −2.2910354E−18 | −5.3641002E−19 | −5.4966037E−19 |
| A18 | −5.5411658E−20 | 1.0579853E−20 | 1.6116403E−21 | −1.9599096E−21 |

Tables 52 to 59 show the corresponding values of Conditional Expressions (1) to (50D), EDf, and EDr of the variable magnification optical systems according to Examples 1 to 17. Preferable ranges of the conditional expressions may be set using the corresponding values of the examples shown in Tables 52 to 59 as the upper limits and the lower limits of the conditional expressions.

TABLE 52

| | | Example | Example | Example | Example | Example |
|---|---|---|---|---|---|---|
| | | 1 | 2 | 3 | 4 | 5 |
| (1) | ft/(fw × tan ωw) | 7.618 | 7.736 | 8.432 | 8.914 | 8.640 |
| (2) | Bfw/(fw × tan ωw) | 0.951 | 1.470 | 1.433 | 1.237 | 1.030 |
| (3) | TLw/(fw × tan ωw) | 7.139 | 7.833 | 7.688 | 7.990 | 7.502 |
| (4) | TLt/ft | 0.937 | 1.012 | 0.912 | 0.896 | 0.868 |
| (5) | FNot/(ft/fw) | 1.796 | 1.748 | 1.594 | 1.635 | 1.635 |
| (6) | ft/(fw × tan ωw) | 7.618 | 7.736 | 8.432 | 8.914 | 8.640 |
| (7) | (fw × TLw)/ft² | 0.407 | 0.425 | 0.339 | 0.333 | 0.323 |
| (8) | ft/fw | 2.300 | 2.380 | 2.691 | 2.691 | 2.691 |
| (9) | fF1/fw | 1.296 | 1.551 | 1.770 | 1.054 | 1.080 |
| (10) | fF1/(−fM) | 3.248 | 3.189 | 2.908 | 3.285 | 3.224 |
| (11) | fF1/(fw × ft)^{1/2} | 0.854 | 1.006 | 1.079 | 0.642 | 0.658 |
| (12) | (−fM)/(fw × ft)^{1/2} | 0.263 | 0.315 | 0.371 | 0.196 | 0.204 |
| (13) | fF1/(ft/FNot) | 2.326 | 2.711 | 2.822 | 1.723 | 1.765 |
| (14) | TLw/fw | 2.155 | 2.410 | 2.454 | 2.412 | 2.337 |
| (15) | tan ωw/FNow | 0.073 | 0.074 | 0.077 | 0.073 | 0.076 |
| (16) | DDL1STw/fF1 | 0.875 | 0.835 | 0.600 | 1.082 | 1.046 |
| (17) | Denw/{(fw × tan ωw) × | 7.743 | 8.628 | 5.530 | 6.940 | 6.647 |
| | log(ft/fw)} | | | | | |
| (18) | Denw/(fw × ft)^{1/2} | 0.558 | 0.648 | 0.462 | 0.549 | 0.543 |
| (19) | DDL1STw/TLw | 0.526 | 0.537 | 0.433 | 0.473 | 0.483 |
| (20) | fw/Dexw | 1.425 | 1.194 | 0.888 | 0.844 | 0.899 |
| (21) | \|DDFMt − DDFMw\|/TLw | 0.163 | 0.181 | 0.256 | 0.112 | 0.121 |
| (22) | fw/fRw | 2.363 | 1.810 | 1.465 | 1.810 | 1.847 |
| (23) | ft/fRt | 5.329 | 3.921 | 3.915 | 5.059 | 5.111 |
| (24) | dFsum/(ft/FNot) | 0.340 | 0.384 | 0.291 | 0.380 | 0.356 |
| (25) | fF1/fL1STw | 2.542 | 1.845 | 1.695 | 1.312 | 1.353 |
| (26) | fw/fL1STw | 1.962 | 1.189 | 0.958 | 1.245 | 1.253 |
| (27) | βMt/βMw | 2.752 | 3.059 | 2.739 | 2.309 | 2.351 |
| (28) | fR1/(fw × ft)^{1/2} | 0.292 | 0.360 | 0.302 | 0.328 | 0.334 |
| (29) | EDf/EDr | 1.678 | 1.786 | 1.536 | 1.680 | 1.560 |
| (30) | fw/fR1 | 2.257 | 1.802 | 2.019 | 1.859 | 1.824 |
| (31) | \|fIS/ft\| | 1.503 | 1.603 | 1.518 | 1.440 | 1.392 |

TABLE 53

| | | Example | Example | Example | Example | Example |
|---|---|---|---|---|---|---|
| | | 1 | 2 | 3 | 4 | 5 |
| (32) | Ndn + 0.01 × νdn | 2.286 | 2.288 | 2.282 | 2.286 | 2.286 |
| (33) | Ndp + 0.01 × νdp | 2.337 | 2.316 | 2.313 | 2.312 | 2.312 |
| (34) | (1/Rcnf − 1/Rcnr)/(1/Rynf − | 2.523 | — | — | 1.184 | 1.143 |
| | 1/Rynr) | | | | | |
| (35) | νdFp_ave | 88.23 | 76.40 | 88.33 | 81.54 | 81.54 |
| (36) | dF1/EDf | 0.288 | 0.315 | 0.291 | 0.341 | 0.329 |
| (37) | dF1/(Denw × tan ωw) | 0.753 | 0.723 | 0.756 | 0.858 | 0.787 |
| (38) | dF1/fF1 | 0.148 | 0.143 | 0.103 | 0.221 | 0.202 |
| (39) | GFave | 3.889 | 3.675 | 4.080 | 4.206 | 4.173 |
| (40) | NLp − (2.015 − 0.0068 × | — | — | — | — | 0.1024 |
| | νLp) | | | | | |
| (41) | νLp | — | — | — | — | 50.30 |
| (42) | θLp | — | — | — | — | 0.55 |
| (43) | θLp − (0.6418 − 0.00168 × | — | — | — | — | −0.0073 |
| | νLp) | | | | | |
| (44) | fR1/fR3 | −0.2965 | 0.1877 | −0.0103 | — | — |
| (45) | fR1/(−fR2) | 0.9745 | 1.2986 | 0.6587 | — | — |
| (46) | fR1/(−fR3) | — | — | — | — | — |
| (47) | fR2/(−fR3) | — | — | — | — | — |
| (46A) | fR1/(−fR3) | — | — | — | 0.613 | 0.544 |
| (47A) | fR2/(−fR3) | — | — | — | 1.3159 | 1.1093 |
| (48A) | fR1/fR2 | — | — | — | 0.4658 | 0.4904 |
| (47B) | fR2/(−fR3) | — | — | — | — | — |
| (48B) | fR1/fR2 | — | — | — | — | — |
| (44C) | fR1/fR3 | — | — | — | — | — |
| (45C) | fR1/(−fR2) | — | — | — | — | — |
| (48D) | fR1/fR2 | — | — | — | — | — |
| (49D) | fR2/fR3 | — | — | — | — | — |
| (50D) | fR3/(−fR4) | — | — | — | — | — |
| | EDf | 48.0 | 50.0 | 44.0 | 49.0 | 46.5 |
| | EDr | 28.6 | 28.0 | 28.6 | 29.2 | 29.8 |

TABLE 54

| | | Example | Example | Example | Example | Example |
|---|---|---|---|---|---|---|
| | | 6 | 7 | 8 | 9 | 10 |
| (1) | ft/(fw × tan ωw) | 8.815 | 8.747 | 8.586 | 7.771 | 7.684 |
| (2) | Bfw/(fw × tan ωw) | 1.391 | 1.503 | 1.476 | 1.526 | 1.360 |
| (3) | TLw/(fw × tan ωw) | 7.936 | 8.160 | 8.925 | 8.423 | 7.696 |
| (4) | TLt/ft | 0.900 | 0.933 | 1.039 | 1.084 | 1.002 |
| (5) | FNot/(ft/fw) | 1.560 | 1.561 | 1.591 | 1.527 | 1.531 |
| (6) | ft/(fw × tan ωw) | 8.815 | 8.747 | 8.586 | 7.771 | 7.684 |
| (7) | (fw × TLw)/ft² | 0.335 | 0.347 | 0.386 | 0.403 | 0.372 |
| (8) | ft/fw | 2.691 | 2.691 | 2.691 | 2.691 | 2.691 |
| (9) | fF1/fw | 1.275 | 1.765 | 1.639 | 1.720 | 1.558 |
| (10) | fF1/(−fM) | 3.635 | 2.421 | 2.887 | 3.095 | 3.210 |
| (11) | fF1/(fw × ft)^{1/2} | 0.777 | 1.076 | 0.999 | 1.049 | 0.950 |
| (12) | (−fM)/(fw × ft)^{1/2} | 0.214 | 0.445 | 0.346 | 0.339 | 0.296 |
| (13) | fF1/(ft/FNot) | 1.988 | 2.755 | 2.606 | 2.628 | 2.386 |
| (14) | TLw/fw | 2.423 | 2.510 | 2.797 | 2.917 | 2.695 |
| (15) | tan ωw/FNow | 0.074 | 0.075 | 0.076 | 0.083 | 0.084 |
| (16) | DDL1STw/fF1 | 1.051 | 0.707 | 0.802 | 0.792 | 0.829 |
| (17) | Denw/{(fw × tan ωw) × | 5.933 | 6.365 | 6.124 | 6.209 | 5.937 |
| | log(ft/fw)} | | | | | |
| (18) | Denw/(fw × ft)^{1/2} | 0.475 | 0.513 | 0.503 | 0.563 | 0.545 |
| (19) | DDL1STw/TLw | 0.553 | 0.497 | 0.470 | 0.467 | 0.479 |
| (20) | fw/Dexw | 1.140 | 1.062 | 0.804 | 0.824 | 0.892 |
| (21) | \|DDFMt − DDFMw\|/TLw | 0.201 | 0.255 | 0.197 | 0.220 | 0.207 |
| (22) | fw/fRw | 2.132 | 1.370 | 1.333 | 1.365 | 1.531 |
| (23) | ft/fRt | 5.997 | 2.933 | 3.580 | 3.500 | 3.935 |
| (24) | dFsum/(ft/FNot) | 0.295 | 0.257 | 0.346 | 0.422 | 0.397 |
| (25) | fF1/fL1STw | 1.206 | 3.426 | 2.658 | 3.406 | 3.263 |
| (26) | fw/fL1STw | 0.946 | 1.941 | 1.622 | 1.980 | 2.095 |
| (27) | βMt/βMw | 2.794 | 3.542 | 2.526 | 3.124 | 2.993 |
| (28) | fR1/(fw × ft)^{1/2} | 0.550 | 0.371 | 0.389 | 0.852 | 0.748 |
| (29) | EDf/EDr | 1.981 | 1.790 | 1.627 | 1.942 | 1.682 |
| (30) | fw/fR1 | 1.108 | 1.645 | 1.566 | 0.715 | 0.814 |
| (31) | \|fIS/ft\| | 1.000 | 1.199 | 1.044 | 0.757 | 0.814 |

TABLE 55

| | | Example | Example | Example | Example | Example |
|---|---|---|---|---|---|---|
| | | 6 | 7 | 8 | 9 | 10 |
| (32) | Ndn + 0.01 × νdn | 2.087 | 2.152 | 2.289 | 2.289 | 2.257 |
| (33) | Ndp + 0.01 × νdp | 2.280 | 2.385 | 2.321 | 2.323 | 2.308 |
| (34) | (1/Rcnf − 1/Rcnr)/(1/Rynf − | — | 1.526 | 1.359 | 1.143 | 1.496 |
| | 1/Rynr) | | | | | |
| (35) | νdFp_ave | 76.06 | 94.66 | 86.94 | 85.82 | 83.95 |
| (36) | dF1/EDf | 0.249 | 0.220 | 0.292 | 0.306 | 0.315 |
| (37) | dF1/(Denw × tan ωw) | 0.800 | 0.642 | 0.844 | 0.865 | 0.830 |
| (38) | dF1/fF1 | 0.149 | 0.094 | 0.133 | 0.161 | 0.167 |
| (39) | GFave | 3.611 | 3.680 | 3.857 | 3.821 | 3.978 |
| (40) | NLp − (2.015 − 0.0068 × νLp) | — | — | 0.1024 | 0.1024 | — |
| (41) | νLp | — | — | 50.3 | 50.3 | — |
| (42) | θLp | — | — | 0.55 | 0.55 | — |
| (43) | θLp − (0.6418 − 0.00168 × | — | — | −0.0073 | −0.0073 | — |
| | νLp) | | | | | |
| (44) | fR1/fR3 | — | — | — | — | — |
| (45) | fR1/(−fR2) | — | — | — | — | — |
| (46) | fR1/(−fR3) | — | — | — | — | — |
| (47) | fR2/(−fR3) | — | — | — | — | — |
| (46A) | fR1/(−fR3) | 1.5493 | — | — | — | — |
| (47A) | fR2/(−fR3) | 0.9194 | — | — | — | — |
| (48A) | fR1/fR2 | 1.6851 | — | — | — | — |
| (47B) | fR2/(−fR3) | — | — | — | 0.5317 | 0.5658 |
| (48B) | fR1/fR2 | — | — | — | 0.8417 | 0.8141 |
| (44C) | fR1/fR3 | — | 1.0858 | 0.5773 | — | — |
| (45C) | fR1/(−fR2) | — | 1.0854 | 0.7991 | — | — |
| (48D) | fR1/fR2 | — | — | — | — | — |
| (49D) | fR2/fR3 | — | — | — | — | — |
| (50D) | fR3/(−fR4) | — | — | — | — | — |
| | EDf | 54.6 | 53.4 | 52.0 | 57.0 | 52.0 |
| | EDr | 27.6 | 29.8 | 32.0 | 29.4 | 30.9 |

TABLE 56

| | | Example | Example | Example | Example | Example |
|---|---|---|---|---|---|---|
| | | 11 | 12 | 13 | 14 | 15 |
| (1) | ft/(fw × tan ωw) | 8.615 | 8.748 | 8.587 | 8.969 | 8.708 |
| (2) | Bfw/(fw × tan ωw) | 1.417 | 1.626 | 1.473 | 1.530 | 1.494 |
| (3) | TLw/(fw × tan ωw) | 8.891 | 8.070 | 8.248 | 8.333 | 8.034 |
| (4) | TLt/ft | 1.032 | 0.922 | 0.961 | 0.929 | 0.923 |
| (5) | FNot/(ft/fw) | 1.546 | 1.524 | 1.512 | 1.494 | 1.528 |
| (6) | ft/(fw × tan ωw) | 8.615 | 8.748 | 8.587 | 8.969 | 8.708 |
| (7) | (fw × TLw)/ft² | 0.384 | 0.343 | 0.357 | 0.345 | 0.343 |
| (8) | ft/fw | 2.691 | 2.691 | 2.691 | 2.691 | 2.691 |
| (9) | fF1/fw | 1.876 | 1.844 | 1.509 | 1.377 | 1.586 |
| (10) | fF1/(−fM) | 3.441 | 2.840 | 2.990 | 3.455 | 2.905 |
| (11) | fF1/(fw × ft)^{1/2} | 1.143 | 1.124 | 0.920 | 0.839 | 0.967 |
| (12) | (−fM)/(fw × ft)^{1/2} | 0.332 | 0.396 | 0.308 | 0.243 | 0.333 |
| (13) | fF1/(ft/FNot) | 2.900 | 2.810 | 2.283 | 2.056 | 2.423 |
| (14) | TLw/fw | 2.777 | 2.483 | 2.585 | 2.500 | 2.483 |
| (15) | tan ωw/FNow | 0.076 | 0.075 | 0.076 | 0.072 | 0.075 |
| (16) | DDL1STw/fF1 | 0.700 | 0.628 | 0.743 | 0.730 | 0.683 |
| (17) | Denw/{(fw × tan ωw) × | 6.774 | 6.089 | 6.524 | 6.662 | 6.264 |
| | log(ft/fw)} | | | | | |
| (18) | Denw/(fw × ft)^{1/2} | 0.555 | 0.491 | 0.536 | 0.524 | 0.507 |
| (19) | DDL1STw/TLw | 0.473 | 0.466 | 0.434 | 0.402 | 0.436 |
| (20) | fw/Dexw | 0.797 | 0.944 | 0.765 | 0.805 | 0.849 |
| (21) | \|DDFMt − DDFMw\|/TLw | 0.209 | 0.269 | 0.199 | 0.181 | 0.222 |
| (22) | fw/fRw | 1.363 | 1.459 | 1.429 | 1.697 | 1.495 |
| (23) | ft/fRt | 4.062 | 3.843 | 3.524 | 4.423 | 3.717 |
| (24) | dFsum/(ft/FNot) | 0.266 | 0.376 | 0.295 | 0.284 | 0.381 |
| (25) | fF1/fL1STw | 3.436 | 0.948 | 0.925 | 0.932 | 0.752 |
| (26) | fw/fL1STw | 1.832 | 0.514 | 0.613 | 0.677 | 0.474 |
| (27) | βMt/βMW | 2.152 | 2.794 | 3.023 | 2.963 | 2.947 |
| (28) | fR1/(fw × ft)^{1/2} | 0.896 | 0.339 | 0.312 | 0.450 | 0.382 |
| (29) | EDf/EDr | 1.750 | 1.888 | 1.573 | 1.913 | 1.629 |
| (30) | fw/fR1 | 0.680 | 1.798 | 1.956 | 1.354 | 1.595 |
| (31) | \|fIS/ft\| | 0.452 | 2.235 | 1.543 | 0.504 | 3.328 |

TABLE 57

| | | Example | Example | Example | Example | Example |
|---|---|---|---|---|---|---|
| | | 11 | 12 | 13 | 14 | 15 |
| (32) | Ndn + 0.01 × νdn | 2.153 | 2.282 | 2.233 | 2.151 | 2.291 |
| (33) | Ndp + 0.01 × νdp | 2.305 | 2.313 | 2.313 | 2.279 | 2.313 |
| (34) | (1/Rcnf − 1/Rcnr)/(1/Rynf − | — | — | — | — | — |
| | 1/Rynr) | | | | | |
| (35) | νdFp1_ave | 81.85 | 88.33 | 81.56 | 65.98 | 88.33 |
| (36) | dF1/EDf | 0.221 | 0.316 | 0.267 | 0.232 | 0.319 |
| (37) | dF1/(Denw × tan ωw) | 0.609 | 1.000 | 0.719 | 0.748 | 0.972 |
| (38) | dF1/fF1 | 0.092 | 0.134 | 0.131 | 0.140 | 0.158 |
| (39) | GFave | 3.619 | 4.080 | 4.007 | 3.780 | 4.197 |
| (40) | NLp − (2.015 − 0.0068 × | — | — | 0.1024 | — | 0.0859 |
| | νLp) | | | | | |
| (41) | νLp | — | — | 50.3 | — | 54.67 |
| (42) | θLp | — | — | 0.55 | — | 0.5453 |
| (43) | θLp − (0.6418 − 0.00168 × | — | — | −0.0073 | — | −0.0046 |
| | νLp) | | | | | |
| (44) | fR1/fR3 | — | −0.4167 | — | — | — |
| (45) | fR1/(−fR2) | — | 0.6865 | — | — | — |
| (46) | fR1/(−fR3) | — | — | — | — | — |
| (47) | fR2/(−fR3) | — | — | — | — | — |
| (46A) | fR1/(−fR3) | — | — | — | — | — |
| (47A) | fR2/(−fR3) | — | — | — | — | — |
| (48A) | fR1/fR2 | — | — | — | — | — |
| (47B) | fR2/(−fR3) | — | — | — | 1.1842 | — |
| (48B) | fR1/fR2 | — | — | — | 0.6787 | — |
| (44C) | fR1/fR3 | — | — | 0.2343 | — | 0.3771 |
| (45C) | fR1/(−fR2) | — | — | 0.648 | — | 0.3749 |
| (48D) | fR1/fR2 | 1.8752 | — | — | — | — |
| (49D) | fR2/fR3 | 0.6327 | — | — | — | — |
| (50D) | fR3/(−fR4) | 1.8749 | — | — | — | — |
| | EDf | 54.0 | 56.0 | 53.0 | 60.0 | 56.0 |
| | EDr | 30.8 | 29.7 | 33.7 | 31.4 | 34.4 |

TABLE 58

| | | Example | Example |
|---|---|---|---|
| | | 16 | 17 |
| (1) | ft/(fw × tan ωw) | 8.559 | 9.087 |
| (2) | Bfw/(fw × tan ωw) | 1.547 | 1.485 |
| (3) | TLw/(fw × tan ωw) | 7.853 | 7.773 |
| (4) | TLt/ft | 0.918 | 0.855 |
| (5) | FNot/(ft/fw) | 1.375 | 1.459 |
| (6) | ft/(fw × tan ωw) | 8.559 | 9.087 |
| (7) | (fw × TLw)/ft² | 0.287 | 0.295 |
| (8) | ft/fw | 3.200 | 2.900 |
| (9) | fF1/fw | 1.313 | 1.400 |
| (10) | fF1/(−fM) | 4.211 | 2.898 |
| (11) | fF1/(fw × ft)^{1/2} | 0.734 | 0.822 |
| (12) | (−fM)/(fw × ft)^{1/2} | 0.174 | 0.284 |
| (13) | fF1/(ft/FNot) | 1.805 | 2.042 |
| (14) | TLw/fw | 2.936 | 2.481 |
| (15) | tan ωw/FNow | 0.091 | 0.074 |
| (16) | DDL1STw/fF1 | 1.070 | 0.768 |
| (17) | Denw/{(fw × tan ωw) × log(ft/fw)} | 6.057 | 5.177 |
| (18) | Denw/(fw × ft)^{1/2} | 0.639 | 0.449 |
| (19) | DDL1STw/TLw | 0.478 | 0.433 |
| (20) | fw/Dexw | 0.695 | 1.043 |
| (21) | \|DDFMt − DDFMw\|/TLw | 0.022 | 0.211 |
| (22) | fw/fRw | 1.490 | 1.742 |
| (23) | ft/fRt | 4.652 | 4.469 |
| (24) | dFsum/(ft/FNot) | 0.487 | 0.300 |
| (25) | fF1/fL1STw | 1.511 | 0.397 |
| (26) | fw/fL1STw | 1.151 | 0.283 |
| (27) | βMt/βMw | 2.784 | 3.549 |
| (28) | fR1/(fw × ft)^{1/2} | 0.341 | 0.394 |
| (29) | EDf/EDr | 1.714 | 2.056 |
| (30) | fw/fR1 | 1.638 | 1.490 |
| (31) | \|fIS/ft\| | 1.388 | 0.625 |

TABLE 59

| | | Example | Example |
|---|---|---|---|
| | | 16 | 17 |
| (32) | Ndn + 0.01 × νdn | 2.270 | 2.151 |
| (33) | Ndp + 0.01 × νdp | 2.312 | 2.312 |
| (34) | (1/Rcnf − 1/Rcnr)/(1/Rynf − 1/Rynr) | 1.390 | 0.666 |
| (35) | νdFp_ave | 77.80 | 88.10 |
| (36) | dF1/EDf | 0.337 | 0.275 |
| (37) | dF1/(Denw × tan ωw) | 0.715 | 0.845 |
| (38) | dF1/fF1 | 0.233 | 0.147 |
| (39) | GFave | 3.656 | 3.737 |
| (40) | NLp − (2.015 − 0.0068 × νLp) | 0.1024 | 0.1024 |
| (41) | NLp | 50.3 | 50.3 |
| (42) | θLp | 0.55 | 0.55 |
| (43) | θLp − (0.6418 − 0.00168 × νLp) | −0.0073 | −0.0073 |
| (44) | fR1/fR3 | — | — |
| (45) | fR1/(−fR2) | — | — |
| (46) | fR1/(−fR3) | — | 1.2766 |
| (47) | fR2/(−fR3) | — | 2.3196 |
| (46A) | fR1/(−fR3) | 0.5627 | — |
| {47A) | fR2/(−fR3) | 1.5111 | — |
| (48A) | fR1/fR2 | 0.3724 | — |
| (47B) | fR2/(−fR3) | — | — |
| (48B) | fR1/fR2 | — | — |
| (44C) | fR1/fR3 | — | — |
| (45C) | fR1/(−fR2) | — | — |
| (48D) | fR1/fR2 | — | — |
| (49D) | fR2/fR3 | — | — |
| (50D) | fR3/(−fR4) | — | — |
| | EDf | 54.0 | 51.4 |
| | EDr | 31.5 | 25.0 |

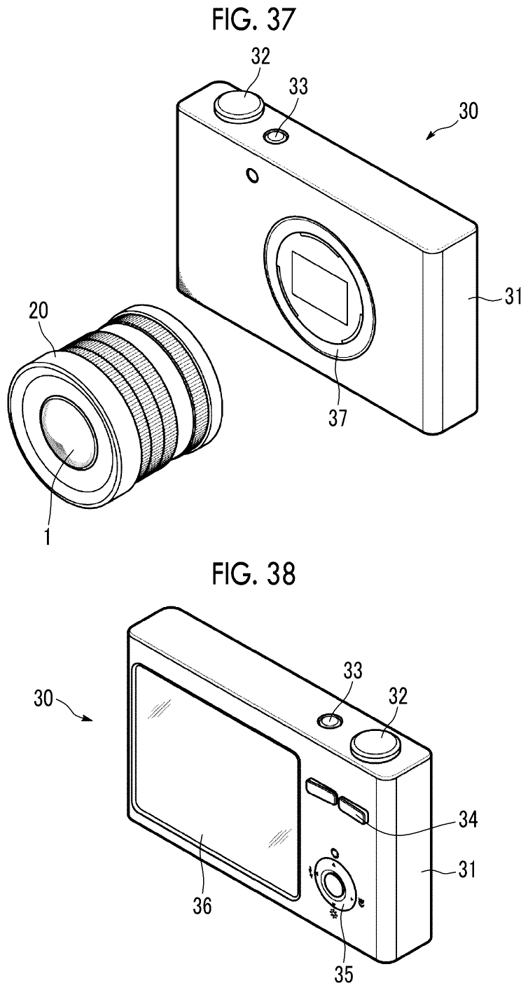

Hereinafter, an imaging apparatus according to the embodiment of the present disclosure will be described. FIGS. 37 and 38 are external views of a camera 30 that is the imaging apparatus according to the embodiment of the present disclosure. FIG. 37 is a perspective view of the camera 30, which is viewed from a front side, and FIG. 38 is a perspective view of the camera 30, which is viewed from a rear side. The camera 30 is a so-called mirrorless type digital camera in which an interchangeable lens 20 can be attachably and detachably mounted. The interchangeable lens 20 includes a variable magnification optical system 1 according to the embodiment of the present disclosure accommodated in a lens barrel.

The camera 30 comprises a camera body 31, in which a shutter button 32 and a power button 33 are provided on an upper surface of the camera body 31. Arear surface of the camera body 31 is provided with an operation unit 34, an operation unit 35, and a display unit 36. The display unit 36 can display the captured image and an image within an angle of view before capturing.

An imaging aperture on which light from an imaging target is incident is provided in a center portion of a front surface of the camera body 31, a mount 37 is provided at a position corresponding to the imaging aperture, and the interchangeable lens 20 is mounted on the camera body 31 through the mount 37.

An imaging element, such as a charge coupled device (CCD) or a complementary metal oxide semiconductor (CMOS), that outputs an imaging signal corresponding to a subject image formed by the interchangeable lens 20, a signal processing circuit that processes the imaging signal output from the imaging element to generate an image, a recording medium for recording the generated image, and the like are provided in the camera body 31. In the camera 30, a still image or a moving image can be captured by pressing the shutter button 32, and the image data obtained by this capturing is recorded on the recording medium.

While the technology of the present disclosure has been described above using the embodiment and the examples, the technology of the present disclosure is not limited to the embodiment and the examples, and can be subjected to various modifications. For example, the curvature radius, the surface spacing, the refractive index, the Abbe number, the aspherical coefficient, and the like of each lens are not limited to the values shown in the examples, and different values may be used.

In addition, the imaging apparatus according to the embodiment of the present disclosure is not limited to the above-described example and can have various aspects of, for example, a camera of a type other than a mirrorless type, a film camera, a video camera, and a security camera.

The following supplementary notes are further disclosed regarding the embodiment and the examples described above.

### [Supplementary Note 1]

A variable magnification optical system consisting of, in order from an object side to an image side, a front group, an intermediate group, and a subsequent group, in which the front group consists of two or fewer lens groups having a positive refractive power, the intermediate group consists of two or fewer lens groups having a negative refractive power, the subsequent group consists of a plurality of lens groups, a lens group of the subsequent group closest to the object side is a first subsequent lens group having a positive refractive power, two or fewer focusing groups that move along an optical axis during focusing are disposed in the subsequent group, during magnification change, all spacings between adjacent lens groups are changed and a lens group of the front group closest to the object side is fixed with respect to an image plane, and in a case in which a focal length of an entire system in a state in which an infinite distance object is in focus at a telephoto end is denoted by ft, a focal length of the entire system in a state in which the infinite distance object is in focus at a wide angle end is denoted by fw, a maximum half angle of view in a state in which the infinite distance object is in focus at the wide angle end is denoted by ωw, and a back focus of the entire system at an air conversion distance in a state in which the infinite distance object is in focus at the wide angle end is denoted by Bfw, Conditional Expressions (1) and (2) are satisfied, which are represented by 5<ft/(fw×tan ωw)<20 (1), and 0.5<Bfw/(fw×tan ωw)<2.5 (2).

### [Supplementary Note 2]

The variable magnification optical system according to supplementary note 1, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3) is satisfied, which is represented by 5<TLw/(fw×tan ωw)<10.5 (3).

### [Supplementary Note 3]

The variable magnification optical system according to supplementary note 1 or 2, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the telephoto end, is denoted by TLt, Conditional Expression (4) is satisfied, which is represented by 0.5<TLt/ft<1.3 (4).

### [Supplementary Note 4]

The variable magnification optical system according to any one of supplementary notes 1 to 3, in which in a case in which an open F-number in a state in which the infinite distance object is in focus at the telephoto end is denoted by FNot, Conditional Expression (5) is satisfied, which is represented by 0.9<FNot/(ft/fw)<2.1 (5).

### [Supplementary Note 5]

The variable magnification optical system according to any one of supplementary notes 1 to 4, in which in a case in which a maximum half angle of view in a state in which the infinite distance object is in focus at the telephoto end is denoted by ωt, Conditional Expression (6) is satisfied, which is represented by 5<ft/(fw×tan ωw)<20 (6).

### [Supplementary Note 6]

The variable magnification optical system according to any one of supplementary notes 1 to 5, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (7) is satisfied, which is represented by 0.1<(fw×TLw)/ft²<0.55 (7).

### [Supplementary Note 7]

The variable magnification optical system according to any one of supplementary notes 1 to 6, in which Conditional Expression (8) is satisfied, which is represented by 1.5<ft/fw<4.3 (8).

### [Supplementary Note 8]

The variable magnification optical system according to any one of supplementary notes 1 to 7, in which during magnification change, three or more lens groups in the subsequent group move by changing spacings with adjacent lens groups.

### [Supplementary Note 9]

The variable magnification optical system according to any one of supplementary notes 1 to 8, in which at least one lens group of the lens groups that move during magnification change, in the subsequent group, has a negative refractive power.

### [Supplementary Note 10]

The variable magnification optical system according to any one of supplementary notes 1 to 9, in which in a case in which a focal length of the lens group of the front group closest to the object side is denoted by fF1, Conditional Expression (9) is satisfied, which is represented by 0.5<fF1/fw<3.4 (9).

### [Supplementary Note 11]

The variable magnification optical system according to any one of supplementary notes 1 to 10, in which in a case in which a focal length of the lens group of the front group closest to the object side is denoted by fF1, and a focal length of the intermediate group at the wide angle end is denoted by fM, Conditional Expression (10) is satisfied, which is represented by 1<fF1/(−fM)<8 (10).

### [Supplementary Note 12]

The variable magnification optical system according to any one of supplementary notes 1 to 11, in which in a case in which a focal length of the lens group of the front group closest to the object side is denoted by fF1, Conditional Expression (11) is satisfied, which is represented by 0.4<fF1/(fw×ft)^{1/2<}1.4 (11).

### [Supplementary Note 13]

The variable magnification optical system according to any one of supplementary notes 1 to 12, in which in a case in which a focal length of the intermediate group at the wide angle end is denoted by fM, Conditional Expression (12) is satisfied, which is represented by 0.1<(−fM)/(fw×ft)^{1/2}<0.7 (12).

### [Supplementary Note 14]

The variable magnification optical system according to any one of supplementary notes 1 to 13, in which in a case in which a focal length of the lens group of the front group closest to the object side is denoted by fF1, and an open F-number in a state in which the infinite distance object is in focus at the telephoto end is denoted by FNot, Conditional Expression (13) is satisfied, which is represented by 1<fF1/(ft/FNot)<5 (13).

### [Supplementary Note 15]

The variable magnification optical system according to any one of supplementary notes 1 to 14, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (14) is satisfied, which is represented by 1.7<TLw/fw<3.5 (14).

### [Supplementary Note 16]

The variable magnification optical system according to any one of supplementary notes 1 to 15, in which in a case in which an open F-number in a state in which the infinite distance object is in focus at the wide angle end is denoted by FNow, Conditional Expression (15) is satisfied, which is represented by 0.06<tan ωw/FNow<0.12 (15).

### [Supplementary Note 17]

The variable magnification optical system according to any one of supplementary notes 1 to 16, in which the variable magnification optical system includes an aperture stop closer to the image side than a lens surface of the intermediate group closest to the image side, and in a case in which a distance, on the optical axis, from a lens surface of the front group closest to the object side to the aperture stop in a state in which the infinite distance object is in focus at the wide angle end is denoted by DDL1STw, and a focal length of the lens group of the front group closest to the object side is denoted by fF1, Conditional Expression (16) is satisfied, which is represented by 0.4<DDL1STw/fF1<1.4 (16).

### [Supplementary Note 18]

The variable magnification optical system according to any one of supplementary notes 1 to 17, in which in a case in which a distance, on the optical axis, from a lens surface of the front group closest to the object side to a paraxial entrance pupil position in a state in which the infinite distance object is in focus at the wide angle end is denoted by Denw, Conditional Expression (17) is satisfied, which is represented by 4<Denw/{(fw×tan ωw)×log(ft/fw)}<9.5 (17).

### [Supplementary Note 19]

The variable magnification optical system according to any one of supplementary notes 1 to 18, in which in a case in which a distance, on the optical axis, from a lens surface of the front group closest to the object side to a paraxial entrance pupil position in a state in which the infinite distance object is in focus at the wide angle end is denoted by Denw, Conditional Expression (18) is satisfied, which is represented by 0.3<Denw/(fw×ft)^{1/2}<0.8 (18).

### [Supplementary Note 20]

The variable magnification optical system according to any one of supplementary notes 1 to 19, in which the variable magnification optical system includes an aperture stop, and in a case in which a distance, on the optical axis, from a lens surface of the front group closest to the object side to the aperture stop in a state in which the infinite distance object is in focus at the wide angle end is denoted by DDL1STw, and a sum of a distance, on the optical axis, from the lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (19) is satisfied, which is represented by 0.2<DDL1STw/TLw<0.65 (19).

### [Supplementary Note 21]

The variable magnification optical system according to any one of supplementary notes 1 to 20, in which in a case in which a distance, on the optical axis, from a paraxial exit pupil position to the image plane in a state in which the infinite distance object is in focus at the wide angle end is denoted by Dexw, a sign of Dexw is defined such that, with the paraxial exit pupil position as a reference, a distance on the image side is positive and a distance on the object side is negative, and Dexw is calculated by using, in a case which an optical member having no refractive power is disposed between the paraxial exit pupil position and the image plane, the air conversion distance for the optical member, Conditional Expression (20) is satisfied, which is represented by 0.6<fw/Dexw<1.7 (20).

### [Supplementary Note 22]

The variable magnification optical system according to any one of supplementary notes 1 to 21, in which in a case in which a spacing, on the optical axis, between the front group and the intermediate group in a state in which the infinite distance object is in focus at the telephoto end is denoted by DDFMt, a spacing, on the optical axis, between the front group and the intermediate group in a state in which the infinite distance object is in focus at the wide angle end is denoted by DDFMw, and a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (21) is satisfied, which is represented by 0.01<|DDFMt−DDFMw|/TLw<0.35 (21).

### [Supplementary Note 23]

The variable magnification optical system according to any one of supplementary notes 1 to 22, in which in a case in which a focal length of the subsequent group in a state in which the infinite distance object is in focus at the wide angle end is denoted by fRw, Conditional Expression (22) is satisfied, which is represented by 1<fw/fRw<3 (22).

### [Supplementary Note 24]

The variable magnification optical system according to any one of supplementary notes 1 to 23, in which in a case in which focal length of the subsequent group in a state in which the infinite distance object is in focus at the telephoto end is denoted by fRt, Conditional Expression (23) is satisfied, which is represented by 2<ft/fRt<8 (23).

### [Supplementary Note 25]

The variable magnification optical system according to any one of supplementary notes 1 to 24, in which in a case in which a sum of central thicknesses of all lenses in the front group is denoted by dFsum, and an open F-number in a state in which the infinite distance object is in focus at the telephoto end is denoted by FNot, Conditional Expression (24) is satisfied, which is represented by 0.2<dFsum/(ft/FNot)<0.6 (24).

### [Supplementary Note 26]

The variable magnification optical system according to any one of supplementary notes 1 to 25, in which the variable magnification optical system includes an aperture stop, and in a case in which a focal length of the lens group of the front group closest to the object side is denoted by fF1, and a composite focal length from a lens of the front group closest to the object side to the aperture stop in a state in which the infinite distance object is in focus at the wide angle end is denoted by fL1STw, Conditional Expression (25) is satisfied, which is represented by 0.2<fF1/fL1STw<5 (25).

### [Supplementary Note 27]

The variable magnification optical system according to any one of supplementary notes 1 to 26, in which the variable magnification optical system includes an aperture stop, and in a case in which a composite focal length from a lens of the front group closest to the object side to the aperture stop in a state in which the infinite distance object is in focus at the wide angle end is denoted by fL1STw, Conditional Expression (26) is satisfied, which is represented by 0.2<fw/fL1STw<2.8 (26).

### [Supplementary Note 28]

The variable magnification optical system according to any one of supplementary notes 1 to 27, in which in a case in which a lateral magnification of the intermediate group in a state in which the infinite distance object is in focus at the telephoto end is denoted by βMt, and a lateral magnification of the intermediate group in a state in which the infinite distance object is in focus at the wide angle end is denoted by βMw, Conditional Expression (27) is satisfied, which is represented by 1.4<βMt/βMw<4.5 (27).

### [Supplementary Note 29]

The variable magnification optical system according to any one of supplementary notes 1 to 28, in which in a case in which a focal length of the first subsequent lens group is denoted by fR1, Conditional Expression (28) is satisfied, which is represented by 0.2<fR1/(fw×ft)^{1/2}<1.4 (28).

### [Supplementary Note 30]

The variable magnification optical system according to any one of supplementary notes 1 to 29, in which in a case in which an effective diameter of a lens surface of the front group closest to the object side is denoted by EDf, and an effective diameter of a lens surface of the subsequent group closest to the image side is denoted by EDr, Conditional Expression (29) is satisfied, which is represented by 1.2<EDf/EDr<2.4 (29).

### [Supplementary Note 31]

The variable magnification optical system according to any one of supplementary notes 1 to 30, in which in a case in which a focal length of the first subsequent lens group is denoted by fR1, Conditional Expression (30) is satisfied, which is represented by 0.4<fw/fR1<4 (30).

### [Supplementary Note 32]

The variable magnification optical system according to any one of supplementary notes 1 to 31, in which at least one lens group that is fixed with respect to the image plane during magnification change is disposed between the front group and a lens group of the subsequent group closest to the image side.

### [Supplementary Note 33]

The variable magnification optical system according to any one of supplementary notes 1 to 32, in which an anti-vibration group that moves in a direction intersecting with the optical axis during image shake correction is disposed closer to the image side than the front group, and in a case in which a focal length of the anti-vibration group is denoted by fIS, Conditional Expression (31) is satisfied, which is represented by 0.2<fIS/ft|<2 (31).

### [Supplementary Note 34]

The variable magnification optical system according to supplementary note 33, in which the anti-vibration group is disposed closer to the object side than the focusing group.

### [Supplementary Note 35]

The variable magnification optical system according to supplementary note 33 or 34, in which the anti-vibration group is disposed in the intermediate group.

### [Supplementary Note 36]

The variable magnification optical system according to supplementary note 33 or 34, in which the anti-vibration group is disposed in the subsequent group.

### [Supplementary Note 37]

The variable magnification optical system according to any one of supplementary notes 1 to 36, in which the front group includes a cemented lens in which a negative meniscus lens having a convex surface facing the object side and a positive lens having a convex surface facing the object side are cemented in order from the object side, and in a case in which a refractive index of the negative meniscus lens at a d line is denoted by Ndn, an Abbe number of the negative meniscus lens based on the d line is denoted by vdn, Conditional Expression (32) is satisfied, which is represented by 1.6<Ndn+0.01×vdn<3 (32).

### [Supplementary Note 38]

The variable magnification optical system according to supplementary note 37, in which in a case in which a refractive index of the positive lens at the d line is denoted by Ndp, and an Abbe number of the positive lens based on the d line is denoted by vdp, Conditional Expression (33) is satisfied, which is represented by 1.8<Ndp+0.01×vdp<2.6 (33).

### [Supplementary Note 39]

The variable magnification optical system according to any one of supplementary notes 1 to 38, in which the subsequent group includes an aspherical lens that has a negative refractive power and that has a concave surface facing the object side, and in a case in which a paraxial curvature radius of a surface of the aspherical lens on the object side is denoted by Rcnf, a paraxial curvature radius of a surface of the aspherical lens on the image side is denoted by Rcnr, a curvature radius of the surface of the aspherical lens on the object side at a position of a maximum effective diameter is denoted by Rynf, and a curvature radius of the surface of the aspherical lens on the image side at the position of the maximum effective diameter is denoted by Rynr, Conditional Expression (34) is satisfied, which is represented by 0.1<(1/Rcnf−1/Rcnr)/(1/Rynf−1/Rynr)<4.5 (34).

### [Supplementary Note 40]

The variable magnification optical system according to any one of supplementary notes 1 to 39, in which in a case in which an average value of Abbe numbers of all positive lenses in the front group based on a d line is denoted by vdFp_ave, Conditional Expression (35) is satisfied, which is represented by 20<vdFp_ave<95 (35).

### [Supplementary Note 41]

The variable magnification optical system according to any one of supplementary notes 1 to 40, in which in a case in which a thickness, on the optical axis, of the lens group of the front group closest to the object side is denoted by dF1, and an effective diameter of a lens surface of the front group closest to the object side is denoted by EDf, Conditional Expression (36) is satisfied, which is represented by 0.1<dF1/EDf<0.6 (36).

### [Supplementary Note 42]

The variable magnification optical system according to any one of supplementary notes 1 to 41, in which in a case in which a thickness, on the optical axis, of the lens group of the front group closest to the object side is denoted by dF1, and a distance, on the optical axis, from a lens surface of the front group closest to the object side to a paraxial entrance pupil position in a state in which the infinite distance object is in focus at the wide angle end is denoted by Denw, Conditional Expression (37) is satisfied, which is represented by 0.3<dF1/(Denw×tan ωw)<1.6 (37).

### [Supplementary Note 43]

The variable magnification optical system according to any one of supplementary notes 1 to 42, in which in a case in which a thickness, on the optical axis, of the lens group of the front group closest to the object side is denoted by dF1, and a focal length of the lens group of the front group closest to the object side is denoted by fF1, Conditional Expression (38) is satisfied, which is represented by 0.03<dF1/fF1<0.4 (38).

### [Supplementary Note 44]

The variable magnification optical system according to any one of supplementary notes 1 to 43, in which in a case in which an average value of specific gravities of all lenses in the front group is denoted by GFave, Conditional Expression (39) is satisfied, which is represented by 2<GFave<5 (39).

### [Supplementary Note 45]

The variable magnification optical system according to any one of supplementary notes 1 to 44, in which a lens group of the subsequent group closest to the image side is fixed with respect to the image plane during magnification change.

### [Supplementary Note 46]

The variable magnification optical system according to any one of supplementary notes 1 to 45, in which the variable magnification optical system includes an Lp lens that is a positive lens, and in a case in which a refractive index of the Lp lens at a d line is denoted by NLp, an Abbe number of the Lp lens based on the d line is denoted by vLp, and a partial dispersion ratio of the Lp lens between a g line and an F line is denoted by θLp, Conditional Expressions (40), (41), (42), and (43) are satisfied, which are represented by 0.005<NLp−(2.015−0.0068×vLp)<0.15 (40), 49.8<vLp<65 (41), 0.543<θLp<0.58 (42), and −0.011<θLp−(0.6418−0.00168×vLp)<0 (43).

### [Supplementary Note 47]

The variable magnification optical system according to any one of supplementary notes 1 to 46, in which the subsequent group consists of, in order from the object side to the image side, the first subsequent lens group, a second subsequent lens group having a negative refractive power, and a third subsequent lens group.

### [Supplementary Note 48]

The variable magnification optical system according to supplementary note 47, in which in a case in which a focal length of the first subsequent lens group is denoted by fR1, and a focal length of the third subsequent lens group is denoted by fR3, Conditional Expression (44) is satisfied, which is represented by −1<fR1/fR3<0.7 (44).

### [Supplementary Note 49]

The variable magnification optical system according to supplementary note 47 or 48, in which in a case in which a focal length of the first subsequent lens group is denoted by fR1, and a focal length of the second subsequent lens group is denoted by fR2, Conditional Expression (45) is satisfied, which is represented by 0.4<fR1/(−fR2)<1.8 (45).

### [Supplementary Note 50]

The variable magnification optical system according to any one of supplementary notes 1 to 46, in which the subsequent group consists of, in order from the object side to the image side, the first subsequent lens group, a second subsequent lens group having a positive refractive power, and a third subsequent lens group having a negative refractive power.

### [Supplementary Note 51]

The variable magnification optical system according to supplementary note 50, in which in a case in which a focal length of the first subsequent lens group is denoted by fR1, and a focal length of the third subsequent lens group is denoted by fR3, Conditional Expression (46) is satisfied, which is represented by 0.6<fR1/(−fR3)<1.9 (46).

### [Supplementary Note 52]

The variable magnification optical system according to supplementary note 50 or 51, in which in a case in which a focal length of the second subsequent lens group is denoted by fR2, and a focal length of the third subsequent lens group is denoted by fR3, Conditional Expression (47) is satisfied, which is represented by 1.6<fR2/(−fR3)<3 (47).

### [Supplementary Note 53]

The variable magnification optical system according to any one of supplementary notes 1 to 46, in which the subsequent group consists of, in order from the object side to the image side, the first subsequent lens group, a second subsequent lens group having a positive refractive power, a third subsequent lens group having a negative refractive power, and a fourth subsequent lens group.

### [Supplementary Note 54]

The variable magnification optical system according to supplementary note 53, in which in a case in which a focal length of the first subsequent lens group is denoted by fR1, and a focal length of the third subsequent lens group is denoted by fR3, Conditional Expression (46A) is satisfied, which is represented by 0.3<fR1/(−fR3)<2 (46A).

### [Supplementary Note 55]

The variable magnification optical system according to supplementary note 53 or 54, in which in a case in which a focal length of the second subsequent lens group is denoted by fR2, and a focal length of the third subsequent lens group is denoted by fR3, Conditional Expression (47A) is satisfied, which is represented by 0.4<fR2/(−fR3)<1.8 (47A).

### [Supplementary Note 56]

The variable magnification optical system according to any one of supplementary notes 53 to 55, in which in a case in which a focal length of the first subsequent lens group is denoted by fR1, and a focal length of the second subsequent lens group is denoted by fR2, Conditional Expression (48A) is satisfied, which is represented by 0.25<fR1/fR2<2.5 (48A).

### [Supplementary Note 57]

The variable magnification optical system according to any one of supplementary notes 1 to 46, in which the subsequent group consists of, in order from the object side to the image side, the first subsequent lens group, a second subsequent lens group having a positive refractive power, a third subsequent lens group having a negative refractive power, a fourth subsequent lens group, and a fifth subsequent lens group.

### [Supplementary Note 58]

The variable magnification optical system according to supplementary note 57, in which in a case in which a focal length of the first subsequent lens group is denoted by fR1, and a focal length of the second subsequent lens group is denoted by fR2, Conditional Expression (48B) is satisfied, which is represented by 0.4<fR1/fR2<1.3 (48B).

### [Supplementary Note 59]

The variable magnification optical system according to supplementary note 57 or 58, in which in a case in which a focal length of the second subsequent lens group is denoted by fR2, and a focal length of the third subsequent lens group is denoted by fR3, Conditional Expression (47B) is satisfied, which is represented by 0.3<fR2/(−fR3)<1.7 (47B).

### [Supplementary Note 60]

The variable magnification optical system according to any one of supplementary notes 1 to 46, in which the subsequent group consists of, in order from the object side to the image side, the first subsequent lens group, a second subsequent lens group having a negative refractive power, a third subsequent lens group having a positive refractive power, and a fourth subsequent lens group.

### [Supplementary Note 61]

The variable magnification optical system according to supplementary note 60, in which in a case in which a focal length of the first subsequent lens group is denoted by fR1, and a focal length of the third subsequent lens group is denoted by fR3, Conditional Expression (44C) is satisfied, which is represented by 0.19<fR1/fR3<1.5 (44C).

### [Supplementary Note 62]

The variable magnification optical system according to supplementary note 60 or 61, in which in a case in which a focal length of the first subsequent lens group is denoted by fR1, and a focal length of the second subsequent lens group is denoted by fR2, Conditional Expression (45C) is satisfied, which is represented by 0.2<fR1/(−fR2)<1.6 (45C).

### [Supplementary Note 63]

The variable magnification optical system according to any one of supplementary notes 1 to 46, in which the subsequent group consists of, in order from the object side to the image side, the first subsequent lens group, a second subsequent lens group having a positive refractive power, a third subsequent lens group having a positive refractive power, a fourth subsequent lens group having a negative refractive power, a fifth subsequent lens group, and a sixth subsequent lens group.

### [Supplementary Note 64]

The variable magnification optical system according to supplementary note 63, in which in a case in which a focal length of the first subsequent lens group is denoted by fR1, and a focal length of the second subsequent lens group is denoted by fR2, Conditional Expression (48D) is satisfied, which is represented by 1.2<fR1/fR2<2.5 (48D).

### [Supplementary Note 65]

The variable magnification optical system according to supplementary note 63 or 64, in which in a case in which a focal length of the second subsequent lens group is denoted by fR2, and a focal length of the third subsequent lens group is denoted by fR3, Conditional Expression (49D) is satisfied, which is represented by 0.3<fR2/fR3<1 (49D).

### [Supplementary Note 66]

The variable magnification optical system according to any one of supplementary notes 63 to 65, in which in a case in which a focal length of the third subsequent lens group is denoted by fR3, and a focal length of the fourth subsequent lens group is denoted by fR4, Conditional Expression (50D) is satisfied, which is represented by 1.2<fR3/(−fR4)<2.5 (50D).

### [Supplementary Note 67]

The variable magnification optical system according to any one of supplementary notes 1 to 66, in which in a case in which a sum of a distance, on the optical axis, from a lens surface of the front group closest to the object side to a lens surface of the subsequent group closest to the image side and the back focus of the entire system at the air conversion distance, in a state in which the infinite distance object is in focus at the wide angle end, is denoted by TLw, Conditional Expression (3-1) is satisfied, which is represented by 5.6<TLw/(fw×tan ωw)<9.5 (3-1).

### [Supplementary Note 68]

The variable magnification optical system according to supplementary note 67, in which Conditional Expression (3-2) is satisfied, which is represented by 5.8<TLw/(fw×tan ωw)<9.3 (3-2).

### [Supplementary Note 69]

The variable magnification optical system according to supplementary note 67, in which Conditional Expression (3-3) is satisfied, which is represented by 6<TLw/(fw×tan ωw)<9.1 (3-3).

### [Supplementary Note 70]

The variable magnification optical system according to supplementary note 67, in which Conditional Expression (3-4) is satisfied, which is represented by 6.2<TLw/(fw×tan ωw)<8.45 (3-4).

### [Supplementary Note 71]

The variable magnification optical system according to any one of supplementary notes 1 to 70, in which in a case in which an open F-number in a state in which the infinite distance object is in focus at the telephoto end is denoted by FNot, Conditional Expression (5-1) is satisfied, which is represented by 1.25<FNot/(ft/fw)<1.75 (5-1).

### [Supplementary Note 72]

An imaging apparatus comprising: the variable magnification optical system according to any one of supplementary notes 1 to 71.

All of the documents, the patent applications, and the technical standards described in the present specification are incorporated in the present specification by reference to the same extent as in a case in which each of the documents, the patent applications, and the technical standards are specifically and individually described to be incorporated by reference.

What is claimed is:

1. A variable magnification optical system consisting of, in order from an object side to an image side, a front group, an intermediate group, and a subsequent group,
wherein the front group consists of two or fewer lens groups having a positive refractive power,
the intermediate group consists of two or fewer lens groups having a negative refractive power,
the subsequent group consists of a plurality of lens groups,
a lens group of the subsequent group closest to the object side is a first subsequent lens group having a positive refractive power,
two or fewer focusing groups that move along an optical axis during focusing are disposed in the subsequent group,
during magnification change, all spacings between adjacent lens groups are changed and a lens group of the front group closest to the object side is fixed with respect to an image plane, and
in a case in which
a focal length of the variable magnification optical system in a state in which an infinite distance object is in focus at a telephoto end is denoted by ft,
a focal length of the variable magnification optical system in a state in which the infinite distance object is in focus at a wide angle end is denoted by fw,
a maximum half angle of view in a state in which the infinite distance object is in focus at the wide angle end is denoted by ow, and
a back focus of the variable magnification optical system at an air conversion distance in a state in which the infinite distance object is in focus at the wide angle end is denoted by Bfw,
Conditional Expressions (1) and (2) are satisfied, which are represented by
$$5 < ft / ( fw \times tan ω w ) < 20 , and \qquad ( 1 )$$
$$0.5 < Bfw / ( fw \times tan ω w ) < 2.5 . \qquad ( 2 )$$

2. The variable magnification optical system according to claim 1,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (3) is satisfied, which is represented by
$$5 < TLw / ( fw \times tan ω w ) < 10.5 . \qquad ( 3 )$$

3. The variable magnification optical system according to claim 1,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the telephoto end, is denoted by TLt,
Conditional Expression (4) is satisfied, which is represented by
$$0.5 < TLt / ft < 1.3 . \qquad ( 4 )$$

4. The variable magnification optical system according to claim 1,
wherein in a case in which an open F-number in a state in which the infinite distance object is in focus at the telephoto end is denoted by FNot,
Conditional Expression (5) is satisfied, which is represented by
$$0.9 < FNot / ( ft / fw ) < 2.1 . \qquad ( 5 )$$

5. The variable magnification optical system according to claim 1,
wherein in a case in which a maximum half angle of view in a state in which the infinite distance object is in focus at the telephoto end is denoted by ωt,
Conditional Expression (6) is satisfied, which is represented by
$$5 < ft / ( fw \times tan ω w ) < 20. \qquad ( 6 )$$

6. The variable magnification optical system according to claim 1,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (7) is satisfied, which is represented by
$$0.1 < ( fw \times TLw ) / {ft}^{2} < 0.55 . \qquad ( 7 )$$

7. The variable magnification optical system according to claim 1,
wherein Conditional Expression (8) is satisfied, which is represented by
$$1.5 < ft / fw < 4.3 . \qquad ( 8 )$$

8. The variable magnification optical system according to claim 7,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (3-4) is satisfied, which is represented by
$$6.2 < TLw / ( fw \times tan ω w ) < 8.45 . \qquad ( 3 - 4 )$$

9. The variable magnification optical system according to claim 8,
wherein in a case in which an open F-number in a state in which the infinite distance object is in focus at the telephoto end is denoted by FNot,
Conditional Expression (5-1) is satisfied, which is represented by
$$1.25 < FNot / ( ft / fw ) < 1.75 . \qquad ( 5 - 1 )$$

10. The variable magnification optical system according to claim 7,
wherein during magnification change, three or more lens groups in the subsequent group move by changing spacings with adjacent lens groups.

11. The variable magnification optical system according to claim 10,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (3-3) is satisfied, which is represented by
$$6 < TLw / ( fw \times tan ω w ) < 9.1 . \qquad ( 3 - 3 )$$

12. The variable magnification optical system according to claim 11,
wherein in a case in which an open F-number in a state in which the infinite distance object is in focus at the telephoto end is denoted by FNot,
Conditional Expression (5-1) is satisfied, which is represented by
$$1.25 < FNot / ( ft / fw ) < 1.75 . \qquad ( 5 - 1 )$$

13. The variable magnification optical system according to claim 10,
wherein at least one lens group of the lens groups that move during magnification change, in the subsequent group, has a negative refractive power.

14. The variable magnification optical system according to claim 13,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (3-2) is satisfied, which is represented by
$$5.8 < TLw / ( fw \times tan ω w ) < 9.3 . \qquad ( 3 - 2 )$$

15. The variable magnification optical system according to claim 14,
wherein in a case in which an open F-number in a state in which the infinite distance object is in focus at the telephoto end is denoted by FNot,
Conditional Expression (5-1) is satisfied, which is represented by
$$1.25 < FNot / ( ft / fw ) < 1.75 . \qquad ( 5 - 1 )$$

16. The variable magnification optical system according to claim 1,
wherein in a case in which a focal length of the lens group of the front group closest to the object side is denoted by fF1,
Conditional Expression (9) is satisfied, which is represented by
$$0.5 < fF 1 / fw < 3.4 . \qquad ( 9 )$$

17. The variable magnification optical system according to claim 1,
wherein in a case in which
a focal length of the lens group of the front group closest to the object side is denoted by fF1, and
a focal length of the intermediate group at the wide angle end is denoted by fM,
Conditional Expression (10) is satisfied, which is represented by
$$1 < fF 1 / ( - fM ) < 8. \qquad ( 10 )$$

18. The variable magnification optical system according to claim 1,
wherein in a case in which a focal length of the lens group of the front group closest to the object side is denoted by fF1,
Conditional Expression (11) is satisfied, which is represented by
$$0. 4 < fF 1 / {( fw \times ft )}^{1 / 2} < 1.4 . \qquad ( 11 )$$

19. The variable magnification optical system according to claim 1,
wherein in a case in which a focal length of the intermediate group at the wide angle end is denoted by fM,
Conditional Expression (12) is satisfied, which is represented by
$$0.1 < ( - fM ) / {( fw \times ft )}^{1 / 2} < 0.7 . \qquad ( 12 )$$

20. The variable magnification optical system according to claim 1,
wherein in a case in which
a focal length of the lens group of the front group closest to the object side is denoted by fF1, and
an open F-number in a state in which the infinite distance object is in focus at the telephoto end is denoted by FNot,
Conditional Expression (13) is satisfied, which is represented by
$$1 < fF 1 / ( ft / FNot ) < 5. \qquad ( 13 )$$

21. The variable magnification optical system according to claim 1,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (14) is satisfied, which is represented by
$$1. 7 < TLw / fw < 3.5 . \qquad ( 14 )$$

22. The variable magnification optical system according to claim 1,
wherein in a case in which an open F-number in a state in which the infinite distance object is in focus at the wide angle end is denoted by FNow,
Conditional Expression (15) is satisfied, which is represented by
$$0.06 < tan ω w / FNow < 0.12 . \qquad ( 15 )$$

23. The variable magnification optical system according to claim 1,
wherein an aperture stop is disposed closer to the image side than a lens surface of the intermediate group closest to the image side in the variable magnification optical system, and
in a case in which
a distance, on the optical axis, from a lens surface of the front group closest to the object side to the aperture stop in a state in which the infinite distance object is in focus at the wide angle end is denoted by DDL1STw, and
a focal length of the lens group of the front group closest to the object side is denoted by fF1,
Conditional Expression (16) is satisfied, which is represented by
$$0. 4 < DDL 1 STw / fF 1 < 1.4 . \qquad ( 16 )$$

24. The variable magnification optical system according to claim 1,
wherein an anti-vibration group that moves in a direction intersecting with the optical axis during image shake correction is disposed closer to the image side than the front group, and
in a case in which a focal length of the anti-vibration group is denoted by fIS,
Conditional Expression (31) is satisfied, which is represented by
$$0.2 < \vert fIS / ft \vert < 2. \qquad ( 31 )$$

25. The variable magnification optical system according to claim 24,
wherein the anti-vibration group is disposed closer to the object side than the focusing group.

26. The variable magnification optical system according to claim 25,
wherein the anti-vibration group is disposed in the intermediate group.

27. The variable magnification optical system according to claim 25,
wherein the anti-vibration group is disposed in the subsequent group.

28. The variable magnification optical system according to claim 1,
wherein a lens group of the subsequent group closest to the image side is fixed with respect to the image plane during magnification change.

29. The variable magnification optical system according to claim 1,
wherein Lp lens that is a positive lens is disposed in the variable magnification optical system, and
in a case in which
a refractive index of the Lp lens at a d line is denoted by NLp,
an Abbe number of the Lp lens based on the d line is denoted by vLp, and
a partial dispersion ratio of the Lp lens between a g line and an F line is denoted by θLp,
Conditional Expressions (40), (41), (42), and (43) are satisfied, which are represented by
$$0.005 < NLp - ( 2.015 - 0.0068 \times vLp ) < 0.15 , \qquad ( 40 )$$
$$49.8 < vLp < 65 , \qquad ( 41 )$$
$$0.543 < θ Lp < 0.58 , and \qquad ( 42 )$$
$$- 0. 11 < θ Lp - ( 0.6 \; 418 - 0.00168 \times vLp ) < 0. \qquad ( 43 )$$

30. The variable magnification optical system according to claim 29,
wherein in a case in which a sum of a distance, on the optical axis, from a lens surface of the front group closest to the object side to a lens surface of the subsequent group closest to the image side and the back focus of the variable magnification optical system at the air conversion distance, in a state in which the infinite distance object is in focus at the wide angle end, is denoted by TLw,
Conditional Expression (3-1) is satisfied, which is represented by
$$5. 6 < TLw / ( fw \times tan ω w ) < 9.5 . \qquad ( 3 - 1 )$$

31. An imaging apparatus comprising:
the variable magnification optical system according to claim 1.
